(19) United States
(12) Patent Application Publication
(10) Pub. No.: US 2025/0214733 A1
(43) Pub. Date: Jul. 3, 2025

(54) HOLDING JIG, SEALING DEVICE, AND SEALING METHOD

(71) Applicant: KY7 INC., Tokyo (JP)

(72) Inventor: Hiroyoshi HAYASHI, Tokyo (JP)

(73) Assignee: KY7 INC., Tokyo (JP)

(21) Appl. No.: 18/844,235

(22) PCT Filed: Dec. 21, 2022
(86) PCT No.: PCT/JP2022/047185

§ 371 Date: Oct. 11, 2024

Related U.S. Application Data
(60) Provisional application No. 63/427,218, filed on Nov. 22, 2022.
(60) Provisional application No. 63/416,735, filed on Oct. 17, 2022.
(60) Provisional application No. 63/414,147, filed on Oct. 7, 2022.
(60) Provisional application No. 63/404,011, filed on Sep. 6, 2022.
(60) Provisional application No. 63/403,474, filed on Sep. 2, 2022.
(60) Provisional application No. 63/398,729, filed on Aug. 17, 2022.

(30) Foreign Application Priority Data
Dec. 21, 2021 (JP) 2021-207626
Jan. 13, 2022 (JP) 2022-004024
Apr. 3, 2022 (JP) 2022-062193
Apr. 28, 2022 (JP) 2022-075520

(51) Int. Cl. B65B 51/14; B25B 11/02

(52) U.S. Cl. CPC B65B 51/14; B25B 11/02

(57) ABSTRACT

A holding jig, sealing device, and sealing method capable of bringing a container into contact with an upper end edge of a through hole. A holding jig includes a holder having a through hole formed in a vertical direction, through which a holding target is to be inserted, the holder being formed to bring the target into contact with an upper end edge portion of the through hole, wherein the holder includes a plurality of displacement elements forming at least part of the through hole, in at least some of the displacement elements, an exposed region of each exposed on a circumferential surface portion of the through hole varies as the element is displaced in a defined displacement direction, and when the element moves to make the exposed region larger, stress is applied to the element for positioning the element at a position at which the exposed region is smaller.

### TECHNICAL FIELD

The present invention relates to a holding jig, a sealing device, and a sealing method.

### BACKGROUND ART

A sealing device that seals a container or the like as a holding target with a lid is known. In the sealing device, as disclosed in Patent Literature 1, a holding target is inserted into a through hole of a holding jig, a lid is placed to cover a portion of the holding target located on the upper surface of the holding jig, and a presser is pressed against the lid and the holding target from the upper side of the lid to join the lid and the holding target.

### CITATION LIST

### Patent Literature

Patent Literature 1: JP 2006-056585 A

### SUMMARY OF INVENTION

### Technical Problem

However, in the sealing device disclosed in Patent Literature 1 described above, the holding jig is mounted in size according to the holding target, and thus, when there are a plurality of sizes of the holding target to be sealed, it is required to individually prepare the holding jig according to the size.

The present invention has been made in view of such a problem, and an object of the present invention is to provide a holding jig, a sealing device, and a sealing method capable of bringing a container into contact with an upper end edge portion of a through hole even when holding targets have different circumferential lengths due to a size change.

### Solution to Problem

The present invention has as its gist (1) to (35) below.

(1) A holding jig including a holder having a through hole formed in a vertical direction, through which a holding target is to be inserted, the holder being formed to bring the holding target into contact with an upper end edge portion of the through hole, wherein the holder includes a plurality of displacement elements forming at least a part of the through hole, in at least some of the displacement elements, an exposed region of each of the displacement elements exposed on a circumferential surface portion of the through hole varies as the displacement element is displaced in a displacement direction defined for the displacement element, and when the displacement element moves to make the exposed region larger, stress is applied to the displacement element for positioning the displacement element at a position at which the exposed region is smaller.

(2) The holding jig according to (1) above, in which the displacement elements being adjacent to each other slide against each other along the displacement direction defined for each of the displacement elements.

(3) The holding jig according to (1) above, in which the plurality of displacement elements form the through hole.

(4) The holding jig according to (1) above, in which the plurality of displacement elements are arranged in an annular shape.

(5) The holding jig according to (1) above, in which the holder includes a regulating structure that regulates the displacement direction of each of at least some of the displacement elements, the regulating structure includes a guide that is provided corresponding to each of the displacement elements for guiding the displacement elements in a predetermined direction, and the displacement direction of the displacement element is a direction along the guide corresponding to the displacement element.

(6) The holding jig according to (5) above, in which when one of the displacement elements adjacent to each other moves along the guide corresponding to the one of the displacement elements, a pressing force is applied to the other of the displacement elements, and the other of the displacement elements moves along the guide corresponding to the other of the displacement elements based on the pressing force.

(7) The holding jig according to (1) above, in which the holder includes a regulating wall portion that regulates a displacement distance of at least one of the displacement elements, and the regulating wall portion contacts the displacement element when the displacement element is displaced to a predetermined position.

(8) The holding jig according to (7) above, in which the holder has a first groove portion in the regulating wall portion, a second groove portion is formed at a position corresponding to the first groove portion in the displacement element in contact with the regulating wall portion, and the holing jig is provided with a regulating rod that is common to the first groove portion and the second groove portion and is embedded in the first groove portion and the second groove portion.

(9) The holding jig according to (1) above, in which the displacement elements adjacent to each other are in contact with each other on side surfaces of the displacement elements.

(10) The holding jig according to (1) above, in which the displacement elements adjacent to each other are prevented from overlapping each other in the vertical direction.

(11) The holding jig according to (1) above, in which positions of upper surfaces of the displacement elements adjacent to each other are aligned at the upper end edge portion of the through hole.

(12) The holding jig according to (1) above, further including a base plate, in which the displacement elements are disposed on a plate upper surface of the base plate, and the displacement elements move and rub on the plate upper surface of the base plate.

(13) The holding jig according to (1) above, in which an extension extending along the circumferential surface portion of the through hole is formed on a lower surface of the displacement element.

(14) The holding jig according to (1) above, in which at least a portion of the displacement element corresponding to the exposed region forms an inclined surface that is inclined downward toward an inside of the through hole as it goes downward from the upper end edge portion of the through hole.

(15) The holding jig according to (1) above, further including a protective plate, in which the protective plate covers at least a part of the displacement element.

(16) The holding jig according to (15) above, in which a fixing member for fixing a position of the protective plate is removably attached to the protective plate, and the protective plate is configured to be displaceable in a planar direction normal to a thickness direction of the protective plate when the fixing member is removed.

(17) The holding jig according to (1) above, in which the holding target includes a first holding target to be in contact with the through hole and a second holding target to be mounted on the first holding target, and wherein a plane direction of a plane normal to the vertical direction is a planar direction, a positioning structure that defines at least a position of the second holding target in the planar direction relative to the first holding target is provided on an upper surface side of the holder.

(18) The holding jig according to (17) above, in which the positioning structure includes a plurality of pins erected on the upper surface side of the holder, and the plurality of pins define the position of the second holding target in the planar direction, and each of the pins is configured to be displaceable in the vertical direction.

(19) The holding jig according to (1) above, in which the holding target includes at least a container having a body and a flange extending outward from an upper end of the body, and the flange is configured to contact the upper end edge portion of the through hole.

(20) The holding jig according to (1) above, in which the holder includes an elastic member that biases at least one of the displacement elements, and in a state where the displacement element has moved to make the exposed region larger, the elastic member applies stress to the displacement element for positioning the displacement element at a position at which the exposed region is smaller.

(21) The holding jig according to (1) above, further including an outer peripheral portion, in which a covering material with cushioning properties is provided to surround the outer peripheral portion.

(22) The holding jig according to (1) above, in which a displacement guide structure that regulates the displacement direction of the displacement element is provided on a lower surface side of the displacement element.

(23) The holding jig according to (1) above, in which a groove is formed on an upper surface of the displacement element.

(24) The holding jig according to (23) above, in which the groove on the upper surface of the displacement element extends along the displacement direction of the displacement element.

(25) The holding jig according to (1) above, in which a groove is formed in at least one of side surfaces of the displacement element excluding a surface that forms the through hole.

(26) The holding jig according to (1) above, in which a step is formed on an upper surface of the displacement element.

(27) A sealing device including: the holding jig according to any one of (1) to (26) above; and a presser for applying a pressing force to the holding target from an upper side of the holding target, wherein in a case where the pressing force is applied to the holding target while the holding target is placed on the holding jig, at least one of the presser and the holding jig moves from an initial position where the presser and the holding jig are separated by a predetermined distance to a position where the holding target is pressed, the presser exists above the holding target, and the pressing force is applied to the holding target from an upper side of the holding target.

(28) The sealing device according to (27) above, in which the holding jig moves toward the presser.

(29) The sealing device according to (27) above, in which the presser moves toward the holding jig.

(30) The sealing device according to (27) above, in which the presser has a pressing surface, and the pressing surface is an uneven surface.

(31) The sealing device according to (27) above, further including a heating mechanism capable of heating the presser.

(32) The sealing device according to (27) above, in which a fluoroplastic sheet is provided between the presser and the holding jig.

(33) The sealing device according to (27) above, in which the holding target includes at least a container having a body with an opening formed on an upper side and a flange extending outward at an upper end of the body.

(34) The sealing device according to (33) above, in which a lid is joined to the container at a position of the flange of the container in a state where the lid is disposed on the container to cover the opening on the upper side of the body and the flange and the container and the lid are interposed between the presser and the holding jig.

(35) A sealing method using the sealing device according to (33) above, the sealing method including joining a lid to the container at a position of the flange of the container in a state where the container and the lid are interposed between the presser and the holding jig.

### Advantageous Effects of Invention

According to the present invention, the exposed region of the displacement element forming the circumferential surface portion of the through hole changes with the displacement of the displacement element, and the size of the through hole can be changed. Therefore, for example, when a container having a flange at an upper edge portion (upper end portion) of a body with an upper end opened is set as a holding target, even as for a plurality of types of containers each having a different size (circumferential length; the length of the outer circumferential surface of the body of the container) (a plurality of types of containers each having a different circumferential length), the container and the upper end edge portion of the through hole can contact each other by the same holding jig, and the container can be supported by the upper end edge portion of the through hole.

According to the sealing device using the holding jig of the present invention, the holding jig can firmly hold each of containers that may have different sizes, and a state where the flange is in contact with the upper end edge portion of the through hole of the holding jig can be formed. Therefore, the container and the lid can be sandwiched by the presser and the holding jig while the lid is placed to cover the flange of the container and the opening of the body of the container. Further, a sealing method using such a sealing device is provided.

### BRIEF DESCRIPTION OF DRAWINGS

FIG. 1 is a perspective view schematically illustrating one example of a holding jig according to a first embodiment.

FIG. 2 is a plan view schematically illustrating one example of the holding jig according to the first embodiment.

FIG. 3 is a cross-sectional view schematically illustrating a state of a longitudinal cross section taken along line A-A in FIG. 2.

FIG. 4A is a plan view schematically illustrating one example of a holding jig according to Modification 1 of the first embodiment. FIG. 4B is a cross-sectional view schematically illustrating a state of a vertical cross section taken along line B-B in FIG. 4A.

FIG. 5A is a plan view schematically illustrating one example of a holding jig according to Modification 3 of the first embodiment. FIG. 5B is a cross-sectional view schematically illustrating a state of a longitudinal cross section taken along line C-C in FIG. 5A.

FIG. 6 is a cross-sectional view schematically illustrating one example of a holding jig according to Modification 4 of the first embodiment.

FIG. 7 is a cross-sectional view schematically illustrating one example of a holding jig according to Modification 5 of the first embodiment.

FIGS. 8A and 8B are cross-sectional views schematically illustrating one example of a holding jig according to Modification 6 of the first embodiment.

FIG. 9A is a plan view schematically illustrating one example of a holding jig according to Modification 7 of the first embodiment. FIG. 9B is a side view schematically illustrating one example of the holding jig according to Modification 7 of the first embodiment.

FIG. 10 is a side view schematically illustrating one example of a sealing device according to a second embodiment.

FIG. 11 is a view for explaining the sealing function of the sealing device according to the second embodiment.

FIG. 12A is a view schematically illustrating a presser used in a sealing device according to Modification 3 of the second embodiment. FIG. 12B is a cross-sectional view schematically illustrating a state of a vertical cross section taken along line D-D in FIG. 12A.

FIG. 13A is a view for explaining a sealing device according to Modification 4 of the second embodiment. FIG. 13B is a cross-sectional view schematically illustrating an example of a longitudinal cross section passing through the center of a suction cup for one example of the suction cup used in the sealing device according to Modification 4 of the second embodiment.

FIG. 14 is a perspective view schematically illustrating one example of a holding jig according to Modification 8 of the first embodiment.

FIG. 15A is a plan view schematically illustrating one example of the holding jig according to Modification 8 of the first embodiment. FIG. 15B is a side view schematically illustrating one example of the holding jig according to Modification 8 of the first embodiment.

FIG. 16 is a side view schematically illustrating one example of a sealing device according to Modification 5 of the second embodiment.

FIG. 17 is a view for explaining the sealing function of the sealing device according to Modification 5 of the second embodiment.

FIG. 18 is a side view schematically illustrating one example of a sealing device according to Modification 7 of the second embodiment.

FIGS. 19A and 19B are views schematically illustrating one example of a sealing device according to Modification 6 of the second embodiment.

FIG. 20A is a plan view illustrating one example of the holding jig 10 according to Modification 8 of the first embodiment. FIG. 20B is a longitudinal sectional view schematically illustrating a state of a longitudinal section taken along line E-E in FIG. 20A.

FIG. 21 is a plan view illustrating one example of the holding jig according to Modification 8 of the first embodiment.

FIG. 22 is a plan view for explaining one example of the holding jig according to Modification 7 of the first embodiment.

FIG. 23 is a side view illustrating one example of the sealing device according to Modification 6 of the second embodiment.

FIG. 24 is a front view illustrating one example of the sealing device according to Modification 6 of the second embodiment.

FIG. 25 is a view for explaining the state of use of one example of the sealing device according to Modification 6 of the second embodiment.

FIG. 26 is a side view illustrating one example of the sealing device according to Modification 6 of the second embodiment.

FIG. 27 is a front view illustrating one example of the sealing device according to Modification 6 of the second embodiment.

FIGS. 28A and 28B are views illustrating main parts in one example of a movement control structure.

FIG. 29 is a front view illustrating one example of a sealing device according to Modification 9 of the second embodiment.

FIG. 30A is a plan view illustrating one example of the holding jig 10 according to Modification 8 of the first embodiment. FIG. 30B is a longitudinal sectional view schematically illustrating a state of a longitudinal section taken along line E-E in FIG. 30A.

FIG. 31 is a plan view illustrating one example of the holding jig 10 according to Modification 8 of the first embodiment.

FIG. 32A is a plan view illustrating one example of the holding jig 10 according to Modification 8 of the first embodiment. FIG. 32B is a longitudinal sectional view schematically illustrating a state of a longitudinal section taken along line G-G in FIG. 32A.

FIG. 33 is a side view illustrating one example of a sealing device according to Modification 10 of the second embodiment.

FIG. 34 is a front view illustrating one example of the sealing device according to Modification 10 of the second embodiment.

FIG. 35 is a view for explaining a state where a holding jig of one example of the sealing device according to Modification 10 of the second embodiment has been moved in a front-rear direction.

FIG. 36 is a plan view schematically illustrating one example of the holding jig according to the first embodiment.

FIG. 37 is a plan view schematically illustrating one example of the holding jig according to the first embodiment.

FIG. 38 is a plan view schematically illustrating one example of the holding jig according to the first embodiment.

FIG. 39 is a plan view schematically illustrating one example of the holding jig according to the first embodiment.

FIG. 40A is a plan view schematically illustrating one example of the holding jig according to Modification 8 of the first embodiment. FIG. 40B is a plan view schematically illustrating a state of a vertical cross section taken along line H-H in FIG. 40A. FIG. 40C is a cross-sectional view schematically illustrating an example of a state at the time of use in one example of the holding jig according to Modification 8 of the first embodiment.

FIG. 41A is a plan view schematically illustrating one example of the holding jig according to Modification 8 of the first embodiment. FIG. 41B is a cross-sectional view schematically illustrating a state of a longitudinal cross section taken along line I-I in FIG. 41A. FIG. 41C is a cross-sectional view schematically illustrating a state of a longitudinal cross section taken along line J-J in FIG. 41A.

FIGS. 42A and 42B are cross-sectional views schematically illustrating one example of the holding jig according to Modification 8 of the first embodiment.

FIG. 43A is a plan view schematically illustrating one example of a holding jig according to Modification 9 of the first embodiment. FIG. 43B is a view schematically illustrating one example of a holding jig according to Modification 9 of the first embodiment.

FIG. 44 is a plan view schematically illustrating one example of a holding jig according to Modification 10 of the first embodiment.

FIG. 45A is a plan view schematically illustrating one example of a holding jig according to Modification 11 of the first embodiment. FIG. 45B is a cross-sectional view schematically illustrating a state of a vertical cross section taken along line K-K in FIG. 45A.

FIG. 46A is a plan view schematically illustrating one example of a holding jig according to Modification 12 of the first embodiment. FIG. 46B is a cross-sectional view schematically illustrating a state of a longitudinal cross section taken along line L-L in FIG. 46A. FIG. 46C is a horizontal cross-sectional view schematically illustrating a state of a vertical cross section taken along line M-M in FIG. 46A.

FIG. 47A is a plan view schematically illustrating one example of a holding jig according to Modification 13 of the first embodiment. FIG. 47B is a side view schematically illustrating one example of the holding jig according to Modification 13 of the first embodiment.

FIG. 48A is a plan view schematically illustrating one example of a holding jig according to Modification 14 of the first embodiment. FIG. 48B is a view schematically illustrating one example of the holding jig according to Modification 14 of the first embodiment.

FIG. 49A is a plan view schematically illustrating a position example of a holding jig according to Modification 15 of the first embodiment. FIG. 49B is a cross-sectional view schematically illustrating a state of a longitudinal cross section taken along line N-N in FIG. 49A.

### DESCRIPTION OF EMBODIMENTS

Hereinafter, one example and the like according to the present invention will be described with reference to the drawings. Note that the description will be given in the order of “1. First Embodiment (holding jig)” and “2. Second Embodiment (sealing device)”. In the present specification and the drawings, components having substantially the same functional configuration are denoted by the same reference numerals, and a repeated description will be omitted.

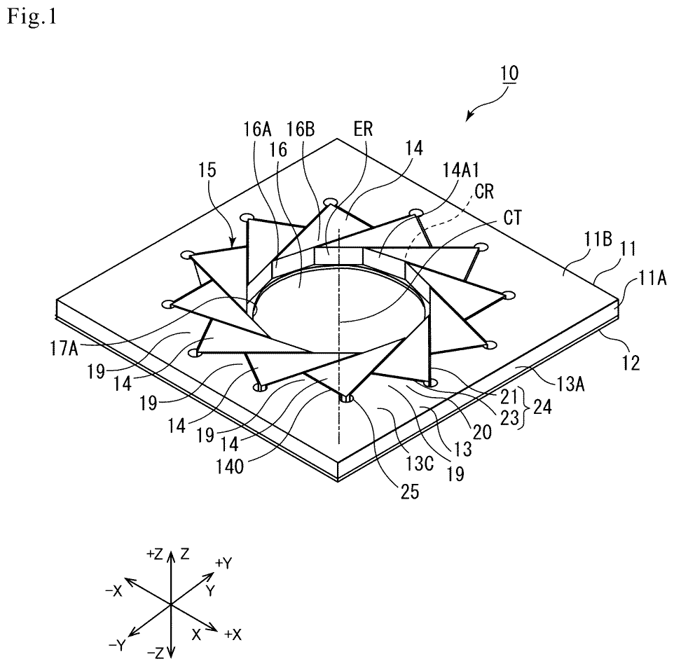

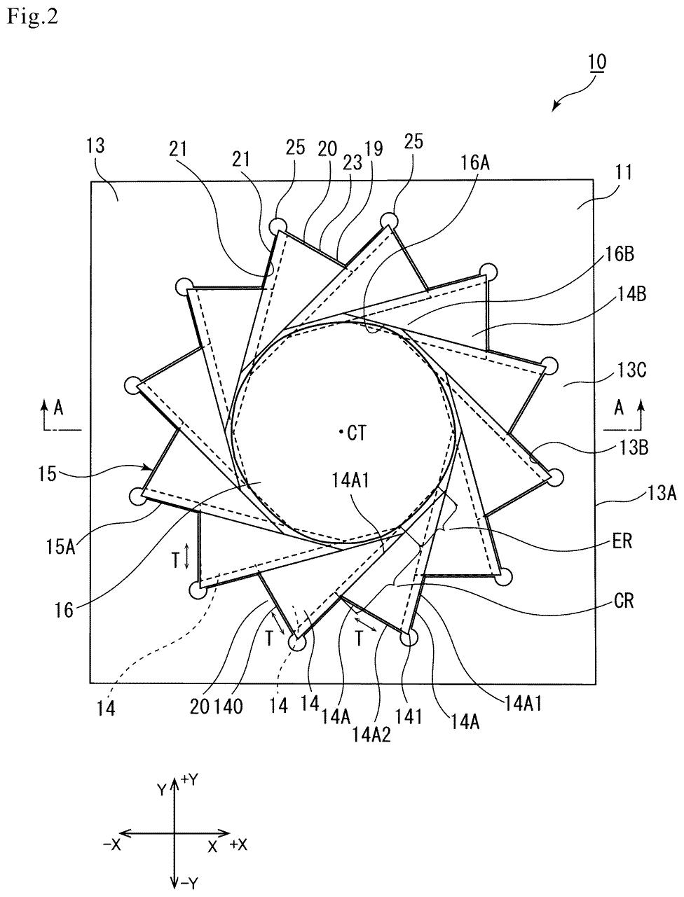

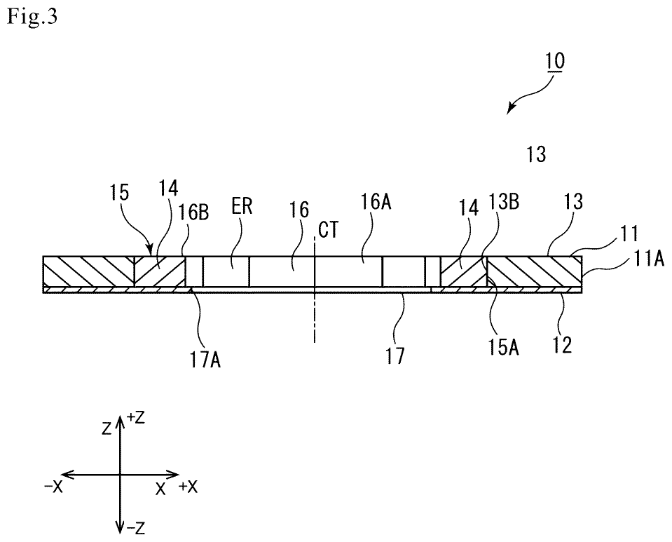

The following description is a preferred specific example of the present invention, and the content of the present invention is not limited to the embodiments or the like to be described. In the following description, directions such as front and rear, left and right, and up and down are indicated in consideration of convenience of description, but the content of the present invention is not limited to these directions. In the example of FIGS. 1 and 2, the Z-axis direction is defined as a vertical direction (+Z direction for the upper side and −Z direction for the lower side), the X-axis direction is defined as a front-rear direction (+X direction for the front side and −X direction for the rear side), and the Y-axis direction is defined as a left-right direction (+Y direction for the right side and −Y direction for the left side), and the description will be given based on these. The same applies to FIGS. 3 to 49.

The relative magnitude ratios of the sizes and thicknesses of respective layers illustrated in each of the drawings such as FIG. 1 are described for convenience and do not limit actual magnitude ratios. The same applies to the definitions and the magnitude ratios regarding these directions in each of the drawings of FIGS. 2 to 49.

### 1. First Embodiment

### 1-1. Configuration of Holding Jig

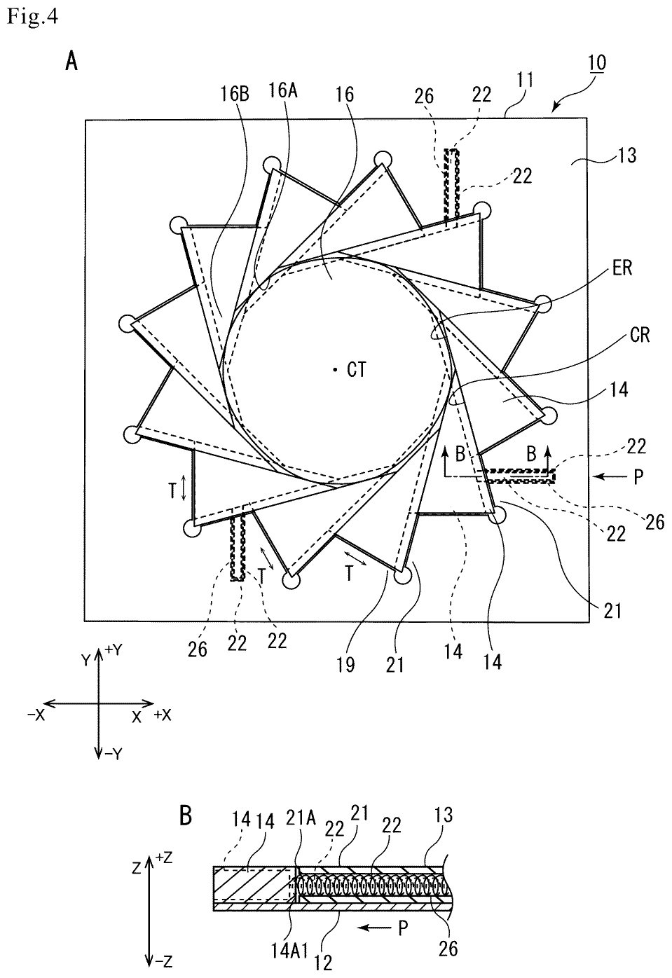

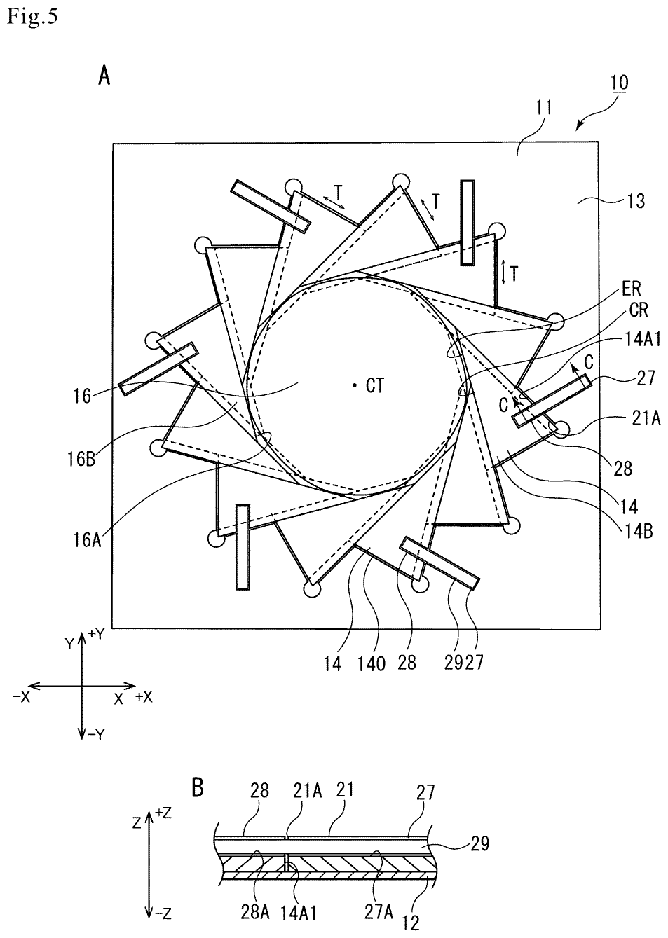

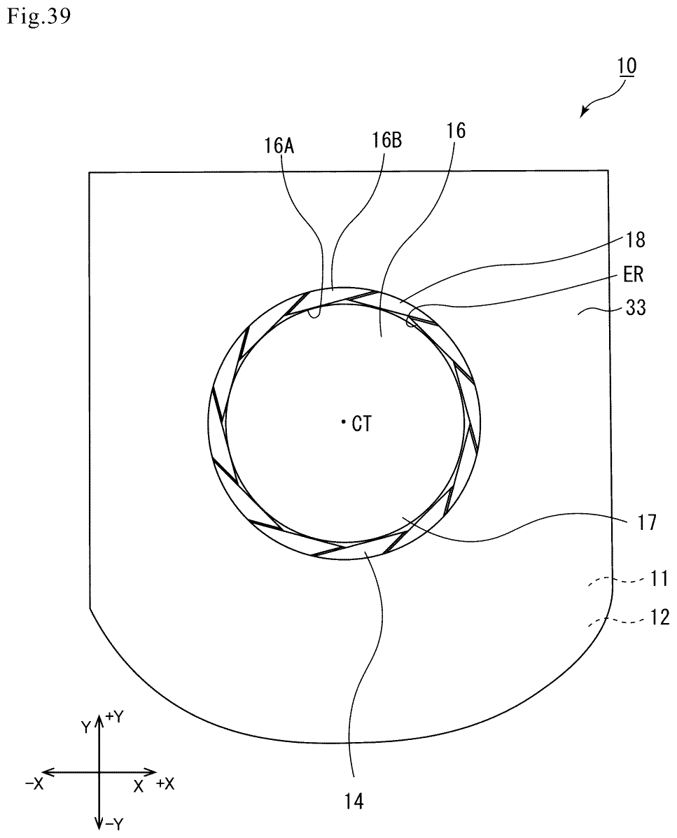

A holding jig 10 according to a first embodiment includes a holder 11 as illustrated in FIGS. 1, 2, 3, and the like. The holding jig 10 is formed in a rectangular shape in its plan view, but this is an example and does not prohibit other shapes. The outer peripheral shape of the holding jig 10 may be any of a circular shape, a tongue-like shape, an elliptical shape, a polygonal shape, and the like in addition to the rectangular shape in the plan view. For example, in the example illustrated in FIG. 39, the outer peripheral shape of the holding jig 10 is formed in a tongue-like shape in the plan view. In FIGS. 1 and 2, for convenience of description, it is described as if a gap has been generated between a receiving material 13 and a displacement element 14 to be described later. However, either a case of formation of a state where a gap has been generated with the displacement of the displacement element 14 or a case of formation of a state where the receiving material 13 and the displacement element 14 are in contact with each other (a case where there is no gap) can occur. The same applies to FIGS. 4 and 5 and some other drawings.

### (Holding Target)

The holding jig 10 can be used for holding a holding target. Therefore, the holding jig 10 is a concept including a structural body that can be used as a so-called container holding jig or a container supporting jig. The holding target is an object to be held by the holding jig 10, and examples of the holding target include a container, a superimposed object of a container and lid, an integrated object of a container and a lid, and the like. The holding target includes an object to be held by the upper end edge portion of the through hole of the holding jig and an object to be held by the circumferential surface portion of the through hole of the holding jig.

### (Base Plate)

In the example of FIG. 1, the holding jig 10 includes the holder 11 on a base plate 12. In this example, in the holder 11, a plurality of displacement elements 14 and a receiving material 13 to be described later are disposed on the upper surface (plate upper surface) of the base plate 12. However, this is not limited to the case where the holding jig 10 includes the base plate 12. The base plate 12 may be omitted as long as the holder 11 is not disassembled, that is, a combination of a plurality of displacement elements 14 to be described later is not individually disassembled and the displacement elements 14 can be prevented from being removed from the holder 11. The material of the base plate 12 is not particularly limited and can be metal, plastic, wood, glass, ceramic, or the like and is not particularly limited. However, the base plate 12 is preferably made of metal from the viewpoint of excellent strength. In the base plate 12, an auxiliary hole 17 is formed at a position corresponding to a through hole 16 to be described later. In the example of FIG. 1, with the size of the through hole 16 enlarged, the auxiliary hole 17 is formed in a shape that is substantially inscribed in the shape of a circumferential surface portion 16A of the through hole 16 in the plan view of the holding jig 10. As the size of the through hole 16 varies so that the size of the through hole 16 decreases, an edge 17A of the auxiliary hole 17 is located outside the through hole 16 in the plan view of the holding jig 10.

### (Holder)

The holder 11 has the through hole 16 and has a plurality of displacement elements 14 forming at least a part of the through hole 16. In the example of FIG. 1, the plurality of displacement elements 14 form the through hole 16. In the example of FIG. 1, the holder 11 includes the receiving material 13 outside of the displacement element 14 when the direction toward the through hole 16 is the inner side. More specifically, in the example of FIG. 1, the holder 11 includes an annular structural body 15 made up of the plurality of displacement elements 14, and further includes the receiving material 13 outside the annular structural body 15. In FIG. 1, in the holding jig 10, the displacement elements 14 may be arranged in an acyclic shape. Further, for example, as an example of the holding jig 10, the through hole 16 may be configured by a combination of the displacement element 14 and a non-displacement member that is not displaced. In this example, the displacement elements 14 are arranged in an acyclic shape.

### (Through Hole)

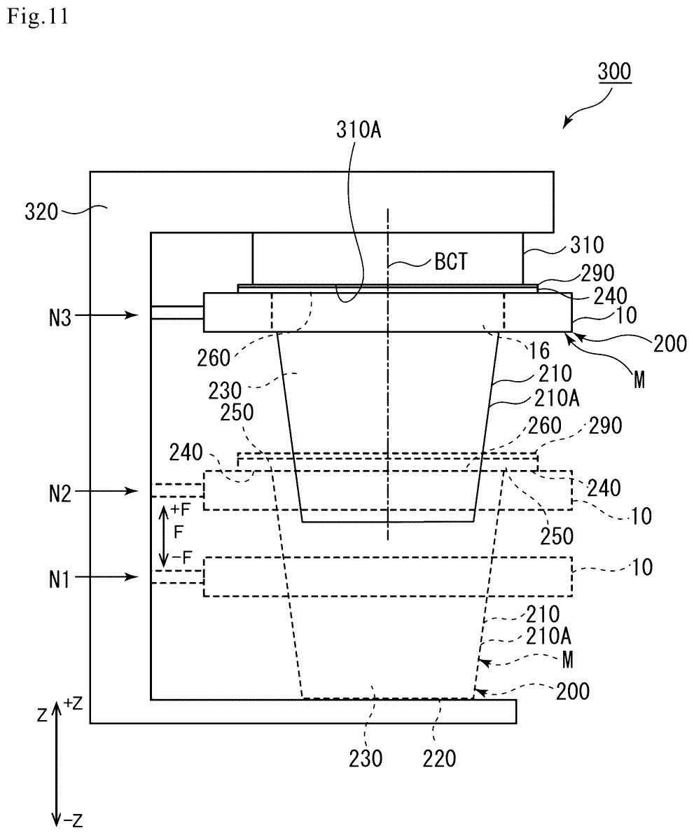

The through hole 16 of the holder 11 is formed so that the size can be changed in accordance with the displacement of the displacement element 14 as described later. The through hole 16 has a diameter large enough to have a function of allowing a holding target M to pass therethrough. The through hole 16 has the circumferential surface portion 16A and an upper end edge portion 16B. When the holding target M is a container 200 having a body 210 with the upper side opened and a bottom portion 220, forming a space 230 inside surrounded by the body 210 and the bottom portion 220, and having a flange 240 extending outward toward the upper end (upper edge portion 250) of the body 210, as described later with reference to FIG. 11 in the description of a sealing device, the circumferential surface portion 16A faces an outer circumferential surface 210A of the body 210 (the outer circumferential surface of the container 200), and the upper end edge portion 16B faces the flange 240. Note that the flange 240 may have a flat shape or a curled shape. In the following description, when the holding target is described using a container, the description will be continued using a case where the holding target is the container 200 as described above, the shape of the body 210 is a shape tapered from the upper end toward the lower end, and the body of the container 200 is opened on the upper surface side. Note that the upper end edge portion 16B indicates a portion forming the upper end edge of the through hole 16 when it is assumed that the container 200 is allowed to pass through the holding jig 10 in a substantially vertical direction. When the container 200 is inserted into the holding jig 10, the container 200 is preferably inserted so as to penetrate the through hole 16 from an upper end edge portion 18B side.

The size of the through hole 16 is changed within a predetermined range in accordance with the displacement of the displacement elements 14. When the size of the through hole 16 is in the enlarged state, the size is determined in advance. The enlarged state is a state where the size of the through hole 16 has been increased as a state determined in accordance with conditions such as the size of the holding target M and the arrangement of the displacement elements 14. For example, in the example of FIG. 1, the size of the through hole 16 is obtained when the displacement element 14 is displaced to a position in contact with a regulating wall portion 21. A case where the size of the through hole 16 is a reduced state is also determined in advance. The reduced state is a state where the size of the through hole 16 has been reduced as a state determined in accordance with conditions such as the size of the holding target M and the arrangement of the displacement elements 14. For example, in an example of FIG. 4 referred to in Modification 1 to be described later, the size of the through hole 16 is obtained when the displacement element 14 is displaced until an elastic member 22 to be described later has a natural length. Further, for example, when the holding target M is the container 200 having a shape tapered downward, regarding the relationship between the holding target M and the reduced state, a size slightly larger than the size of the lower end of the container 200 may be determined as the size of the through hole 16 corresponding to the reduced state of the through hole 16. Regarding the relationship between the size of the holding target M and the enlarged state, a size slightly larger than the size of the upper end (excluding the flange 240) of the container 200 may be determined as the size of the through hole 16 corresponding to the enlarged state of the through hole 16. In a case where the size of the through hole 16 is changed, the size of the through hole 16 may be changed so as to have shapes similar to each other before and after the change, or the size of the through hole 16 may be changed so as to have shapes dissimilar to each other. Note that the case where the size of the through hole 16 comes into the reduced state includes a case where the size of the through hole 16 is substantially zero.

### (Identification of Size of Through Hole)

The size of the through hole 16 is determined as follows: in the case of assuming a case where a center CT (indicated by a single dotted line in FIGS. 1 and 3, and a point in FIG. 2) of the through hole 16 is aligned with the positions of the displacement elements 14, and one through hole 16 is disposed on the front side while the other through hole 16 is disposed on the rear side, the other through hole 16 is smaller than the one through hole 16 when the other through hole 16 is exposed, the one through hole 16 and the other through hole 16 have the same size when the one through hole coincides with the other through hole 16, and the other through hole 16 is larger than the one through hole 16 when the other through hole 16 is not exposed and the other through hole 16 is not the same as the one through hole 16. The sizes of the through hole 16 and the auxiliary holes 17, 18 are determined by the diameter of the largest inscribed circle of the through hole 16 and the diameters of the auxiliary holes 17, 18.

### (Displacement Element)

In the example of FIGS. 1, 2, and the like, the plurality of displacement elements 14 are arranged in an annular shape in the holding jig 10. Here, being “arranged in an annular shape” indicates the state of being arranged to surround a reference position when a predetermined position is set as the reference position (in the example of FIG. 2, the center CT of the through hole 16). The case of being arranged in an annular shape includes a case where a plurality of adjacent displacement elements 14 overlap each other when a direction away from the reference position (a direction extending outward from the reference position along a plane normal to the thickness direction of the holding jig 10) is a line-of-sight direction. The displacement element 14 indicates an object that performs movement such as positional movement or rotation by receiving action of a pressing force, electricity, magnetism, or the like from the outside (a displaceable element piece). Examples of the displacement element 14 include a mover, a rotor, and the like. The mover is a tangible object that performs positional movement. The rotor is a tangible object that performs rotational movement. It is sufficient that there is a case where the displacement elements 14 are arranged so that at least some of the displacement elements 14 can be recognized from the through hole 16, and it is not prohibited that some of the plurality of displacement elements 14 are not exposed to the through hole 16 when the size of the through hole 16 is a predetermined size.

### (Layout of Displacement Element)

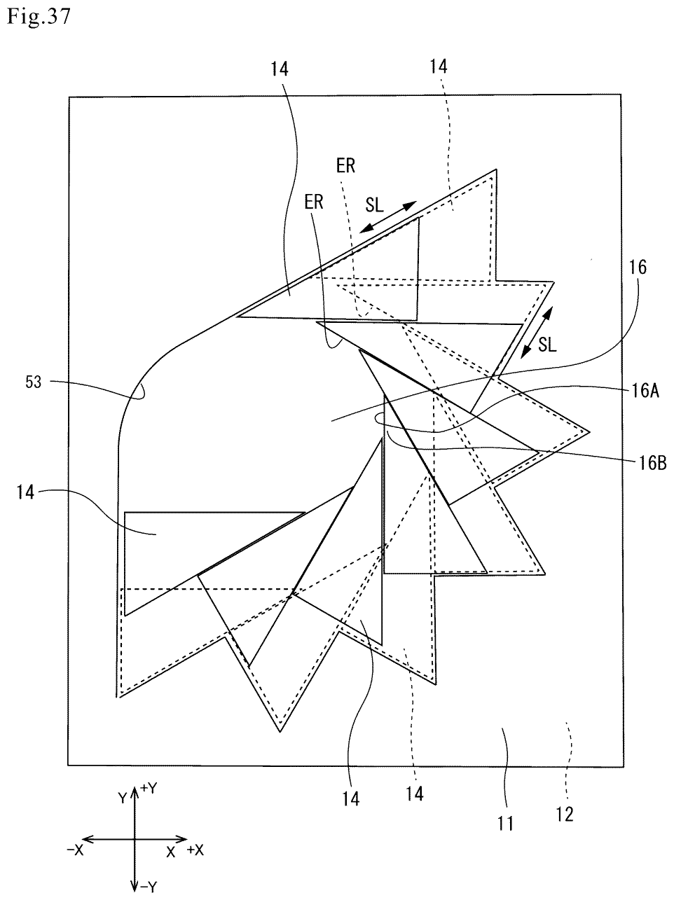

Regarding the layout of the displacement elements 14, in the example of FIGS. 1, 2, and the like, when the direction away from the reference position is the line-of-sight direction, the plurality of adjacent displacement elements 14 overlap each other, and the adjacent displacement elements 14 are in contact with each other. The displacement elements 14 arranged in the annular shape form the annular structural body 15 as a whole. A penetration portion (a portion penetrating in the direction along the Z-axis direction) is formed inside the annular structural body 15, and the penetration portion is a through hole 16. Therefore, the plurality of displacement elements 14 form the through hole 16. However, this is not limited to a case where the penetration portion formed by arranging the displacement element 14 in the annular shape forms the through hole 16. For example, as illustrated in FIG. 37, a case where the displacement elements 14 and the wall portion 53 form the through hole 16 is not excluded. FIG. 37 is a plan view illustrating one example of the holding jig 10 according to the first embodiment. In FIG. 37, as indicated by a broken line, the size of an exposed region ER varies as the displacement element 14 slides in the direction of arrow SL, and the size of the through hole 16 varies in accordance with the variation in the size of the exposed region ER.

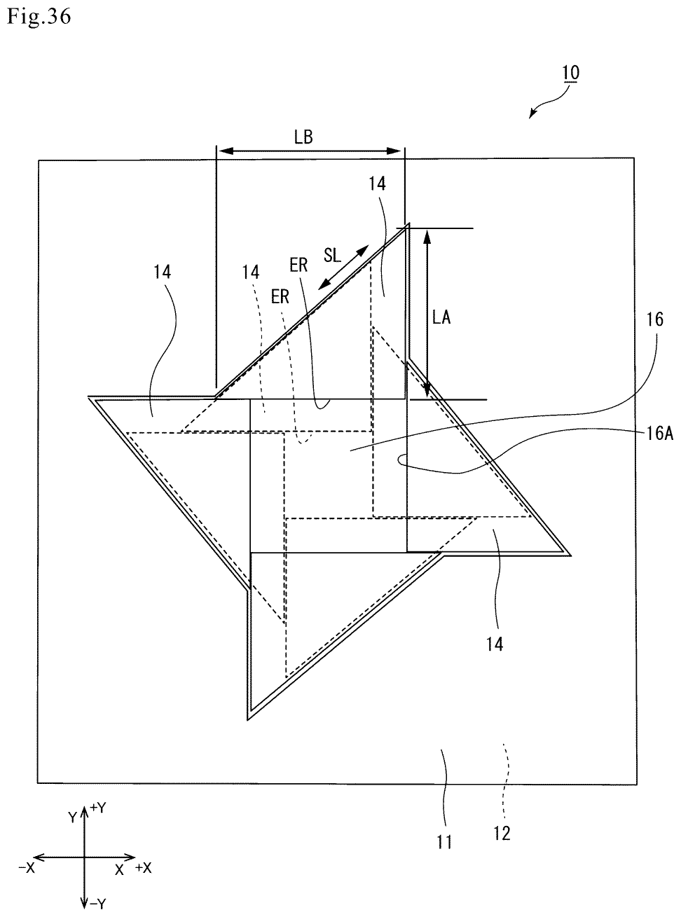

In the example of FIGS. 1 and 2, the plurality of displacement elements 14 are arranged in the annular shape so that the shape of the through hole 16 is substantially a regular polygonal shape (in FIG. 2, a regular dodecagon) in the plan view of the holder 11 (in the plan view of the holding jig 10), but the arrangement (layout) of the plurality of displacement elements 14 is not limited to this example. For example, as illustrated in FIG. 36, the plurality of displacement elements 14 may be arranged so that the shape of the through hole 16 is a shape close to a rectangle, or the plurality of displacement elements 14 may be arranged so that the shape of the through hole 16 is a polygon other than a regular polygon. In the example of FIG. 36, four displacement elements 14 are arranged, and a through hole 16 is formed in a rectangular shape. In this example, the displacement element 14 is formed in a substantially right triangle shape in the plan view of the holding jig 10, and a length LB of one side on the end surface side facing the through hole 16 is longer than a length LA of one side extending substantially at a right angle to the one side. As the displacement element 14 slides in the direction of arrow SL, the size of the exposed region ER varies as indicated by a broken line, and the size of the through hole 16 varies in accordance with the variation of the size of the exposed region ER. As will be described later, when the side surface of the displacement element 14 has a curved shape, the plurality of displacement elements 14 may be arranged so that the through hole 16 is circular with the plurality of displacement elements 14.

### (Exposed Region of Displacement Element)

On the surface of the displacement element 14 (a first side surface 14A1 of a side surface 14A in the example of FIG. 1), a region forming the circumferential surface portion 16A of the through hole 16 is the exposed region ER exposed toward the through hole 16. The size of the exposed region ER is determined in accordance with the size of the through hole 16. In at least some of the displacement elements 14, the exposed region ER of the displacement element 14 exposed to the circumferential surface portion 16A of the through hole 16 varies as the displacement element 14 is displaced in a displacement direction T. In the example of FIG. 1, as the size of the through hole 16 decreases, the exposed region ER of the displacement element 14 forming the through hole 16 decreases. As the exposed region ER of the displacement element 14 decreases, a region (covered region CR) that comes into contact with the adjacent displacement element 14 and is covered with the adjacent displacement element 14 on the surface of the displacement element 14 increases. As the size of the through hole 16 increases, the exposed region ER of the displacement element 14 increases. As the exposed region ER of the displacement element 14 increases, the region (covered region CR) covered with the adjacent displacement element 14 on the surface of the displacement element 14 decreases. As described above, in the holding jig 10, as each of the displacement elements 14 is displaced in the displacement direction T, the exposed region ER of each of the displacement elements 14 exposed to the circumferential surface portion 16A of the through hole 16 varies. Note that FIG. 1 is an example, and as long as the size of the through hole 16 can be changed, it is not prohibited that the size of the exposed region ER does not vary for some of the displacement elements 14.

### (Shape of Displacement Element)

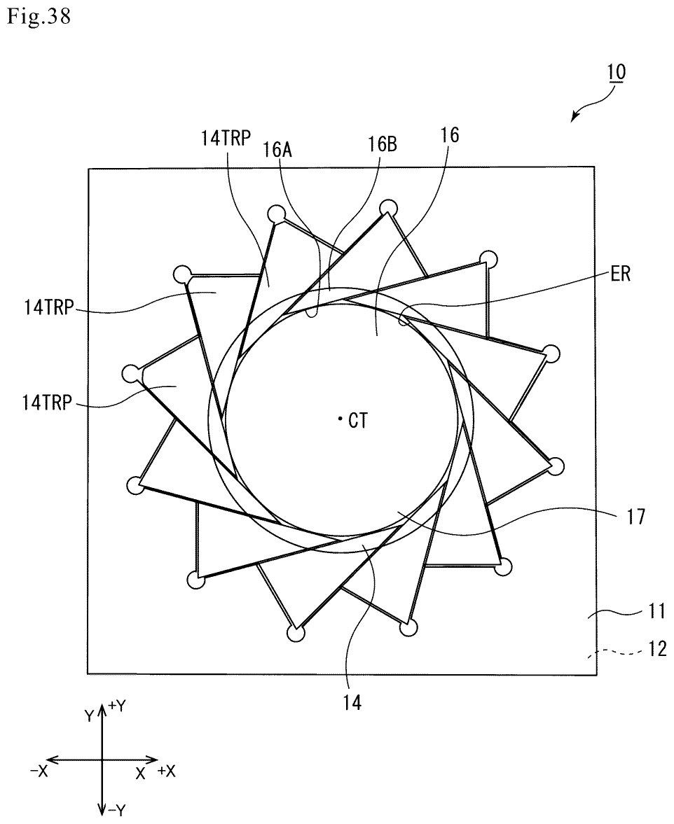

In the example of FIGS. 1, 2, and the like, the shape of each of the displacement elements 14 has a triangular shape in a plan view and is formed in a triangular plate shape with a predetermined thickness. The plurality of displacement elements 14 are formed substantially uniformly. However, this does not limit the shape of the displacement element 14 to the example of FIGS. 1, 2, and the like. The example of FIGS. 1, 2, and the like do not prohibit at least some of the plurality of displacement elements 14 from having different shapes from other displacement elements 14. For example, as illustrated in FIG. 38, a triangular shape, a trapezoidal shape, or a shape having a curved portion may be present as the shape of the plurality of displacement elements 14 forming the through hole 16. In FIG. 38, a displacement element 14TRP is trapezoidal in the plan view of the holder 11, and the other displacement elements 14 except the displacement element 14TRP are triangular in the plan view of the holder 11.

### (Size of Displacement Element)

In the example of FIGS. 1, 2, and the like, the plurality of displacement elements 14 are formed to be substantially uniform in size. However, this does not prohibit a case where the sizes of at least some of the plurality of displacement elements 14 are different from each other.

### (Material of Displacement Element)

The material of the displacement element 14 is not particularly limited and can be metal, plastic, wood, glass, ceramic, or the like and is not particularly limited. However, from the viewpoint of excellent rubbing movement and excellent ease of molding, the material of the displacement element 14 is preferably plastic. When the displacement element 14 is made of plastic, the displacement element 14 preferably has cushioning properties, and from this viewpoint, the displacement element 14 is preferably made of a porous polymer material. The porous polymer material can be exemplified by a foaming polymer material or the like. Note that the plastic may have elasticity or poor elasticity. In a case where the displacement element 14 is easily elastically deformed, the size of the through hole 16 can be smoothly changed even when the side surface of the displacement element 14 is formed in a curved shape, or even when the plurality of displacement elements 14 are arranged so that the through hole 16 is circular in the plurality of displacement elements 14. The material of the displacement element 14 is preferably metal (including an alloy) from the viewpoint of excellence in the strength of the displacement element 14 and the small wear due to friction at the time of rubbing movement. When the material of the displacement element 14 is metal, specific examples of the material of the displacement element 14 may include iron, copper, aluminum, stainless steel, and the like. From the viewpoint of reducing the generation of rust, the material of the displacement element 14 is preferably an aluminum alloy or stainless steel.

### (Displacement Direction of Displacement Element)

Each of the displacement elements 14 illustrated in the example of FIG. 1 slides on the upper surface (plate upper surface) of the base plate 12. Hence the displacement element 14 is displaced in the planar direction (XY plane direction) of the base plate 12. At this time, in the plan view of the holder 11, the displacement direction T of the displacement element 14 is defined in advance for each of the displacement elements 14. The displacement direction T of the displacement element 14 is defined in accordance with the shape and arrangement of the displacement element 14. In the example of FIGS. 1 and 2, the displacement direction T of each displacement element 14 is defined in accordance with the orientation of a base 140 of the displacement element 14. In this example, with a direction along the extending direction of the base 140 of the triangle forming the displacement element 14 as the displacement direction T, the displacement element 14 is linearly displaced along the displacement direction T. At this time, with such a direction being set as the displacement direction T, the adjacent displacement elements 14 can be interlocked as described later. In the example of FIG. 1, the displacement element 14 is linearly displaced along the displacement direction T, but the displacement direction T is not limited to the case of being linear. For example, the displacement element 14 may be configured to be displaced in an arc shape or the like. When the displacement element 14 has a triangular shape in the plan view, the base 140 is defined as the shortest side among the three sides in the example of FIGS. 1, 2, and the like, but this is a definition for convenience of description and is not restrictive. In the case of arcuate displacement, it is preferable to use an elastically deformable material such as rubber for the displacement element 14.

### (Interlocking of Adjacent Displacement Elements)

The adjacent displacement elements 14 are interlocked as described above. Interlocking means that the displacement of one displacement element 14 is accompanied by the displacement of the displacement elements 14 adjacent thereto. The interlocking structure is not particularly limited but is realized by the arrangement structure of the adjacent displacement elements 14 in the example of FIG. 1. In the example of FIG. 1, the adjacent displacement elements 14 are in contact with each other on the side surface 14A (first side surface 14A1). Then, one displacement element 14 of the adjacent displacement elements 14 applies a pressing force to the other displacement element 14. The other displacement element 14 is displaced by the action of the pressing force.

In the example illustrated in FIG. 1, when one of the adjacent displacement elements 14 moves along a guide 20 to be described later corresponding to the one displacement element 14, a pressing force is applied to the other displacement element 14, and the other displacement element 14 moves along the guide 20 corresponding to the other displacement element 14 based on the pressing force. In the example of FIG. 1, when one displacement element 14 moves along the displacement direction T, a pressing force can be applied to the other displacement element 14 so as to press the other displacement element 14 in an oblique direction relative to the extending direction of the guide 20 of the other displacement element. Thus, the other displacement element 14 is displaced along the guide 20 by the pressing force received from the one displacement element 14. Note that the case of displacement along the guide 20 is not limited to a case where the guide 20 and the displacement element 14 move while being in contact with each other but may include a case where the guide 20 and the displacement element 14 move while being in partial contact with each other within a range in which the function of the guide 20 is not lost, and a case where the guide 20 and the displacement element 14 temporarily separate from each other.

### (Sliding of Adjacent Displacement Elements)

The adjacent displacement elements 14 slide against each other. At this time, the displacement elements 14 slide against each other along the displacement directions T defined for the respective displacement elements 14. The adjacent displacement elements 14 are in contact with each other on the side surfaces 14A (the first side surface 14A1 in FIG. 1), and the adjacent displacement elements 14 are displaced along the displacement directions T defined for the respective displacement element 14 so that the side surfaces 14A rub against each other. Note that the concept that two objects slide includes a case where the two objects slide smoothly and a case where the two objects move while rubbing. When the adjacent displacement elements 14 slide, a frictional force preferably acts between the adjacent displacement elements 14. In this case, the frictional force in the direction different from the sliding direction of the adjacent displacement elements 14 is preferably larger than the frictional force in the sliding direction of the adjacent displacement elements 14. The case where the adjacent displacement elements 14 slide includes not only a case where the adjacent displacement elements 14 slide in the state of being always in contact with each other, but also a case where there is a moment at which the adjacent displacement elements 14 separate.

As illustrated in FIG. 3, the adjacent displacement elements 14 are all disposed on the base plate 12, and the adjacent displacement elements 14 are prevented from overlapping each other in the vertical direction. Accordingly, by making the thicknesses of the adjacent displacement elements 14 uniform, it is possible to avoid the formation of irregularities along the circumferential direction of the through hole 16 at the upper end edge portion 16B of the through hole 16 as illustrated in FIG. 1. In the example of FIG. 1, at the upper end edge portion 16B of the through hole 16, the positions of upper surfaces 14B of the adjacent displacement elements 14 are aligned. With such a configuration, when the holding jig 10 is used in a sealing device to be described later, the contact position in the vertical direction between the upper end edge portion 16B of the through hole 16 and the flange 240 of the container 200 in the holding jig 10 is made substantially uniform, and the container 200 can be pressed against a presser 310 to be described later at substantially the same timing.

### (Receiving Material)

In the example of FIG. 1, the holder 11 is provided with the receiving material 13 outside the annular structural body 15. The receiving material 13 can function as a structural body having a regulating structure 19 to be described later. The receiving material 13 is formed in an annular shape, and an outer circumferential surface 13A of the receiving material 13 is formed in a shape corresponding to an outer circumferential surface 11A of the holder 11. An inner circumferential surface 13B of the receiving material 13 is formed in a shape corresponding to an outer circumferential surface 15A of the annular structural body 15. The receiving material 13 is fixed on the base plate 12, and the annular structural body 15 is formed to face the inner circumferential surface 13B of the receiving material 13, whereby the annular structural body 15 can be prevented from being displaced relative to the base plate 12, and hence the displacement element 14 can be prevented from being displaced relative to the base plate 12.

### (Material of Receiving Material)

The material of the receiving material 13 is not particularly limited but is preferably the same material as the displacement element 14 from the viewpoint of ease of manufacturing.

In the example of FIGS. 1, 2, and the like, the receiving material 13 is formed of one member, but the receiving material 13 may be formed of a combination structural body in which divided bodies divided into a plurality of parts are combined (not illustrated).

### (Regulating Structure)

The holder 11 includes the regulating structure 19. The regulating structure 19 is a structure that regulates the displacement direction T (displacement direction regulating structure). The regulating structure 19 regulates the displacement directions T of at least some of the displacement elements 14. In the example illustrated in FIGS. 1 and 2, the regulating structure 19 includes the guide 20. In the example of FIGS. 1 and 2, the guide 20 is formed on the receiving material 13. The guide 20 illustrated in this example regulates the displacement direction T so that the displacement element 14 is linearly displaced from a first position to a second position.

### (First Position and Second Position)

As illustrated in FIG. 2, the first position is a position of the displacement element 14 (e.g., the position of the displacement element 14 indicated by a solid line in FIG. 2) determined when the size of the through hole 16 is in a predetermined enlarged state. The second position is a position of the displacement element 14 (e.g., the position of the displacement element 14 indicated by a broken line in FIG. 2) determined when the size of the through hole 16 is in a predetermined reduced state. Note that the case where the regulating structure 19 includes the guide 20 is one example of the regulating structure 19, and the regulating structure 19 is not limited thereto. In the description of the first embodiment, for convenience of description, a case where the regulating structure 19 has a structure including the guide 20 will be described as an example.

### (Guide)

The guides 20 only need to be provided for at least some of the displacement elements 14, and the guide 20 is provided for each of the displacement elements 14 in the example of FIG. 1. The guide 20 regulates the movement of the displacement element 14 so as to limit the displacement direction of the displacement element 14. In the example of FIGS. 1 and 2, the guides 20 are provided corresponding to the respective displacement elements 14 and guide the displacement elements 14 in predetermined directions. The guide 20 is formed of a guide wall portion 23 facing one side surface (a second side surface 14A2 formed at the position of the base 140) of the displacement element 14 in the receiving material 13. The guide 20 guides the movement of the displacement element 14 so that the displacement direction T of the displacement element 14 is a direction along the wall surface of the guide wall portion 23 of the guide 20 corresponding to the displacement element 14. In the example of FIGS. 1 and 2, the wall surface direction of the guide wall portion 23 forming the guide 20 is aligned with the extending direction of the base of the triangle (the plane direction of the second side surface 14A2) forming the shape of the displacement element 14. In this example, since the orientations of the bases of the adjacent displacement elements 14 (the plane direction of the second side surfaces 14A2) are different, the wall surface directions of the guide wall portions 23 corresponding to the respective displacement elements 14 are also different from each other. It is preferable that the length of the guide 20 be substantially aligned with a displacement range of the displacement element 14 (the moving range of the displacement element 14 when the position of displacement element 14 moves from the first position to the second position) or be larger than the displacement range. Note that the example of FIG. 1 is an example of the guide 20, and the configuration of the guide 20 is not limited as long as the displacement direction T of the displacement element 14 can be regulated.

### (Regulating Wall Portion)

As illustrated in the example of FIGS. 1 and 2, the holder 11 preferably includes a regulating wall portion 21 that regulates the displacement distance of at least one displacement element 14. The regulating wall portion 21 has a wall surface 21A that contacts the displacement element 14 when the displacement element 14 is displaced to a predetermined position. For example, in the regulating wall portion 21, when the displacement element 14 moves to the first position in the displacement direction T, the first side surface 14A1 of the displacement element 14 contacts the wall surface 21A of the regulating wall portion 21, and is regulated from further moving in the displacement direction T from the first position in a direction opposite to the direction toward the second position. Thus, the regulating wall portion 21 regulates the displacement distance of the displacement element 14.

In the example of FIGS. 1 and 2, the regulating wall portion 21 is formed on the receiving material 13, and the end edge of the regulating wall portion 21 is shared with the end edge of the guide 20. An angle formed by the wall surface 21A of the regulating wall portion 21 and the wall surface of the guide wall portion 23 of the guide 20 is an acute angle. In this example, in the plan view of the holding member, the receiving material 13 forms a substantially V-shaped wall portion 24 forming the regulating wall portion 21 and the guide wall portion 23 for each of the displacement elements 14. The V-shaped wall portions 24 are formed to be arranged in an annular shape to correspond to the arrangement of the displacement elements 14. In the example of FIGS. 1 and 2, a curved wall surface portion 25 curved in a C shape in the plan view of the receiving material 13 is formed at the position of the end edge of the regulating wall portion 21 and the end edge of the guide 20. The curved wall surface portion 25 can prevent the corner (vertex 141) of the displacement element 14 from contacting the position of the end edge of the regulating wall portion 21 and the end edge of the guide 20.

### 1-2. Actions and Effects

According to the first embodiment, the exposed region ER of the displacement element 14 forming the circumferential surface portion 16A of the through hole 16 changes with the displacement of the displacement element 14, and the size of the through hole 16 can be changed. Even as for a plurality of types of containers 200 having different sizes as the holding target M, the container 200 and the upper end edge portion 16B of the through hole 16 can contact each other by the same holding jig 10, and the container 200 can be supported by the upper end edge portion 16B of the through hole 16.

According to the holding jig 10 of the first embodiment, the size of the through hole 16 can be varied with the displacement of the displacement element 14, so that it is possible to cope with a case where the size itself of the body 210 of the container 200 varies.

For example, in a case where the holding target M is the container 200, and the container 200 has the body 210 with the upper side opened and the bottom portion 220, forms the space 230 inside, and has the flange 240 extending outward toward the upper end side of the body 210, when the holding jig 10 holds the holding target M in the through hole 16, the circumferential surface portion 16A faces the outer circumferential surface 210A of the body 210 (the outer circumferential surface of the container 200), and the upper end edge portion 16B faces the flange 240. When the shape of the outer circumferential surface 210A of the body 210 is a tapered shape tapered downward, the size of the lower portion (a portion close to the bottom portion 220) of the body 210 is smaller than the size of the vicinity of the flange 240 in the cross section of the body 210. When the container 200 is placed inside the through hole 16 of the holding jig 10, and the holding jig 10 is moved upward, only the holding jig 10 is pulled upward as long as the size of the outer circumferential surface 210A of the body 210 is smaller than the size of the through hole 16 when the through hole 16 of the holding jig 10 is in a reduced state. Eventually, when the size of the outer circumferential surface 210A of the body 210 coincides with the size of the through hole 16 when the through hole 16 of the holding jig 10 is in a reduced state, the through hole 16 of the holding jig 10 and the outer circumferential surface 210A of the body 210 contact each other. When the weight of the container 200 is equal to or more than a predetermined weight, the holding jig 10 slides upward relative to the body 210 of the container 200 while being in contact with the body 210 of the container 200. At this time, the container 200 may or may not move upward together with the holding jig 10. The size of the through hole 16 is changed (enlarged) due to the displacement of the displacement element 14 corresponding to the size of the body 210 of the container 200 while the holding jig is in contact with the body 210 of the container 200 and moves and rubs on the body 210 upward. When the upper end edge portion 16B of the through hole 16 of the holding jig 10 contacts the flange 240 of the container 200 while the holding jig 10 moves upward, the holding jig 10 holds the container 200 and moves upward together with the container 200. As described above, according to the holding jig 10, the size of the through hole 16 can be varied to bring the upper end edge portion 16B of the holding jig 10 into contact with the flange 240 even when the size of the body 210 of the container 200 itself varies.

Next, modifications of the first embodiment will be described. Note that the modifications described below may be combined with each other as long as there is no contradiction. For example, Modification 1 and Modification 3 may be combined.

### 1-3. Modifications

### (Modification 1)

In the holding jig 10 according to the first embodiment, as illustrated in FIGS. 4A and 4B, the holder 11 may include an elastic member 22 that biases at least one displacement element 14. The present embodiment is referred to as Modification 1 of the first embodiment. FIG. 4A is a plan view illustrating one example of the holding jig 10 according to Modification 1 of the first embodiment. FIG. 4B is a cross-sectional view illustrating a state of a vertical cross section taken along line B-B in FIG. 4A.

### (Elastic Member)

In the holding member illustrated in FIG. 4A, for each of the plurality of displacement elements 14 (three displacement elements 14 in FIG. 4A) selected from the displacement elements 14 arranged in the annular shape, a hole portion 26 drilled from a predetermined position toward the back of the inner region of the wall surface 21A of the regulating wall portion 21 corresponding to the displacement element 14 is formed. The elastic member 22 is disposed in the hole portion 26.

In the example of FIG. 4A, three elastic members 22 are disposed in the holding member, but this is an example, and it is sufficient if at least one elastic member is disposed. Further, the arrangement position of the elastic member 22 is not particularly limited.

### (Material of Elastic Member)

As illustrated in FIG. 4B, a winding spring is employed as the elastic member 22. However, this is an example of the elastic member 22, and rubber, urethane, or the like may be employed as the elastic member 22 in addition to the spring. The elastic member 22 may be a combination of those. The use of a combination of magnets instead of the elastic member 22 is not prohibited.

### (Actions and Effects)

In Modification 1 of the first embodiment, when the displacement element 14 is disposed at the first position, the elastic member 22 biases the displacement element 14 in the direction of arrow P so as to displace the displacement element 14 toward the second position (pushes out the displacement element 14 in a direction away from the regulating wall portion 21). Thus, when the exposed region ER is in an increased state (a state where the size of the through hole 16 increases), the elastic member 22 biases the displacement element 14 so as to bring the exposed region ER into a decreased state (a state where the size of the through hole 16 decreases). When the displacement element 14 is disposed at the second position, the length of the elastic member 22 is a natural length, and the displacement element 14 is in a state where the pressing force from the elastic member 22 is released. Therefore, when the exposed region ER is in the decreased state, the displacement element 14 is released from the biasing force received from the elastic member 22. That is, the displacement element 14 is released from the state of receiving the pushing force in the direction away from the regulating wall portion 21. As described above, the elastic member 22 biases the displacement element 14 so that the exposed region ER decreases when the exposed region ER of each of the displacement elements 14 exposed to the circumferential surface portion 16A of the through hole 16 increases. Then, the biasing by the elastic member 22 makes it possible for the size of the through hole 16 to follow the size of the container 200.

According to the holding jig 10 of Modification 1 of the first embodiment, at the time of placing the container 200 in the through hole 16, even when the outer circumferential surface 210A of the body 210 of the container 200 displaces the displacement element 14 from the second position, and the container 200 expands the through hole 16, the position of the displacement element 14 can be returned to the second position with the restoring force of the elastic member 22 by removing the container 200 from the through hole 16.

### (Modification 2)

In the holding jig 10 according to the first embodiment, the holder 11 may include a control mechanism that controls the movement of at least one displacement element 14. The control mechanism may have a mechanical structure or an electrical structure. As the mechanical structure, a control structure for the movement of the displacement element 14 by a gear can be exemplified (not illustrated). As the electrical structure, a control structure for the movement of the displacement element 14 by electrical control of magnetic force can be exemplified (not illustrated).

### (Modification 3)

In the holding jig 10 according to the first embodiment, as illustrated in FIGS. 5A and 5B, the holder 11 may have a first groove portion 27 in the regulating wall portion 21, and a second groove portion 28 may be formed at a position corresponding to the first groove portion 27 in the displacement element 14 in contact with the regulating wall portion 21. In this case, as illustrated in FIGS. 5A and 5B, a regulating rod 29 common to the first groove portion 27 and the second groove portion 28 and embedded in the first groove portion 27 and the second groove portion 28 is provided. The present embodiment is referred to as Modification 3 of the first embodiment. FIG. 5A is a plan view illustrating one example of the holding jig 10 according to Modification 3 of the first embodiment. FIG. 5B is a cross-sectional view illustrating a state of a longitudinal cross section taken along line C-C in FIG. 5A.

### (First Groove Portion and Second Groove Portion)

In the holding member illustrated in FIG. 5A, for each of the plurality of displacement elements 14 (in FIG. 5A, every other six displacement elements 14 along the arrangement direction of the displacement elements 14) selected from the displacement elements 14 arranged in the annular shape, the first groove portion 27 extends from a predetermined position of the upper end of the wall surface 21A of the regulating wall portion 21 corresponding to each displacement element 14 toward the inner region of the upper surface 13C along an upper surface 13C of the receiving material 13 in a direction away from the wall surface 21A.

The second groove portion 28 extends from a predetermined position at the upper end of the side surface 14A (first side surface 14A1) of each of the displacement elements 14 toward the inner region of the upper surface 14B of the displacement element 14. The position of the first groove portion 27 on the wall surface 21A and the position of the second groove portion 28 on the side surface 14A are opposite each other, and the positions of the groove bottom 28A of the second groove portion 28 and the groove bottom 27A of the first groove portion 27 substantially coincide with each other.

In the example of FIG. 5A, the extending direction of the first groove portion 27 coincides with the extending direction of the second groove portion 28. Both the extending directions of the first groove portion 27 and the second groove portion 28 coincide with the displacement direction T of the displacement element 14 in which the second groove portion 28 is formed (in the example of FIG. 4, the extending direction of the second groove portion 28 and the extending direction of the base 140 of the displacement element 14 are aligned).

### (Regulating Rod)

The regulating rod 29 is embedded in the first groove portion 27 and the second groove portion 28. The regulating rod 29 is common to the first groove portion 27 and the second groove portion 28. The material of the regulating rod 29 is not particularly limited, but the regulating rod 29 preferably has rigidity in order to stabilize the position of the displacement element 14. From this viewpoint, the regulating rod 29 is preferably made of metal. The regulating rod 29 may be a member different from the rod state as long as being a member common to the first groove portion 27 and the second groove portion 28. For example, a curved member or a plate-shaped member may be used as a member that can be used as the regulating rod 29.

### (Actions and Effects)

In Modification 1 of the first embodiment, since the first groove portion 27, the second groove portion 28, and the regulating rod 29 are provided, the position where the side surface 14A of the displacement element 14 and the wall surface 21A of the regulating wall portion 21 face each other is less likely to be displaced in the plane direction of the wall surface 21A of the regulating wall portion 21.

### (Modification 4)

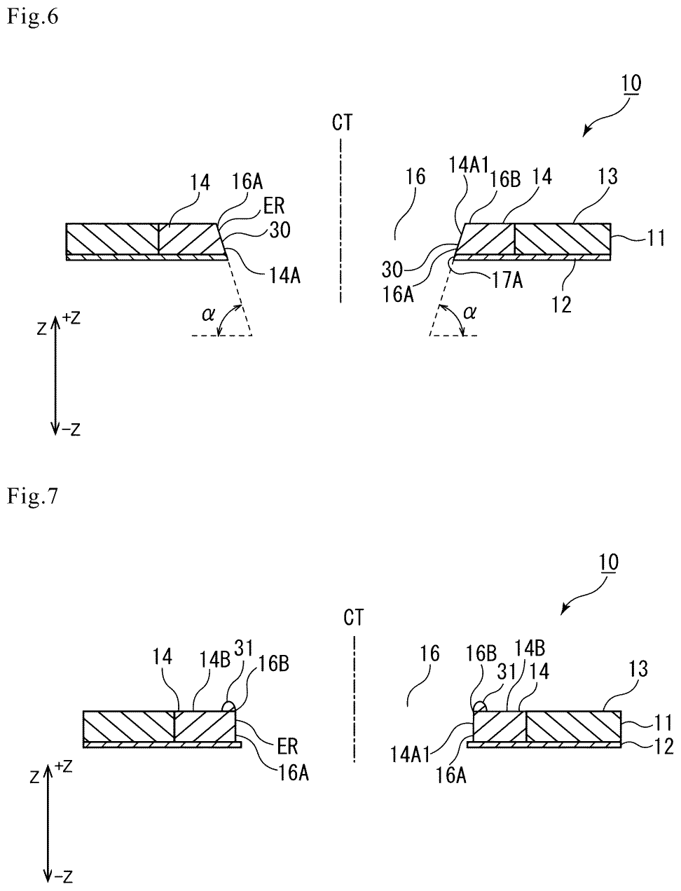

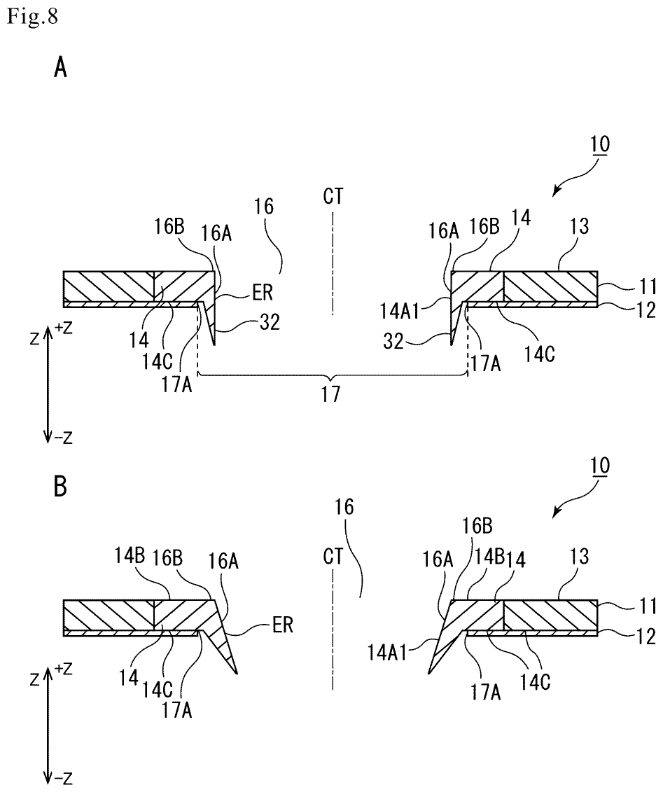

In the holding jig 10 according to the first embodiment, as illustrated in FIG. 6, in the holder 11, the circumferential surface portion 16A of the through hole 16 may form an inclined surface 30. The present embodiment is referred to as Modification 4 of the first embodiment. FIG. 6 is a cross-sectional view for explaining one example of the holding jig 10 according to Modification 4 of the first embodiment. FIG. 6 is a cross-sectional view passing through the center CT of the through hole 16. In FIG. 6, for convenience of description, only a portion appearing at the position of the cross section is illustrated in the cross-sectional view, and the description of other portions that are out of the position of the cross section is omitted. The same applies to FIGS. 7, 8A, and 8B. Since a portion of the displacement element 14 corresponding to the exposed region ER forms the circumferential surface portion 16A of the through hole 16, Modification 4 of the first embodiment can be realized by at least a portion of the displacement element 14 corresponding to the exposed region ER forming an inclined surface (the inclined surface of the exposed region ER is the inclined surface of the circumferential surface portion of the through hole 16).

### (Inclined Surface of Circumferential Surface Portion)

The inclined surface 30 is inclined downward toward the inside of the through hole 16 (toward the center CT in the example of FIG. 6) as it goes downward from the upper end edge portion 16B of the through hole 16. An inclination angle α of the inclined surface 30 of the circumferential surface portion 16A is not particularly limited, but when the holding target M is the container 200 and the body of the container 200 has a shape tapered downward as described above, the inclination angle α of the inclined surface 30 is preferably determined so that the inclination corresponds to the tapered shape of the body.

According to Modification 4 of the first embodiment, due to the formation of the inclined surface 30 having the predetermined inclination angle α on the circumferential surface portion 16A, the outer circumferential surface 210A of the body 210 of the container 200 is easily fitted to the circumferential surface portion 16A of the through hole 16 while the inclination of the container 200 is avoided, and a state where the container 200 is held by the holding jig 10 with the container 200 inclined relative to the holding jig 10 is hardly formed. The inclination of the container 200 indicates that a center BCT of the container 200 illustrated in FIG. 11 (the center BCT of the container 200 is indicated by a single dotted line in FIG. 11) is inclined relative to the vertical direction (Z-axis direction).

### (Modification 5)

In the holding jig 10 according to the first embodiment, as illustrated in FIG. 7, the holder 11 may be provided with a protrusion 31 at the upper end edge portion 16B of the through hole 16. The present embodiment is referred to as Modification 5 of the first embodiment. FIG. 7 is a cross-sectional view for explaining one example of the holding jig 10 according to Modification 5 of the first embodiment. FIG. 7 is a cross-sectional view passing through the center of the through hole 16. With the displacement element 14 forming the through hole 16, Modification 5 of the first embodiment can be realized by forming a protrusion on the upper surface 14B of the displacement element 14.

In the example of FIG. 1 and the like, the portion of the displacement element 14 corresponding to the exposed region ER forms the circumferential surface portion 16A of the through hole 16. Therefore, in Modification 5 of the first embodiment, with the protrusion being formed on the upper surface 14B at the position of the upper end of the portion of the displacement element 14 corresponding to the exposed region ER, the protrusion 31 can be formed at the position of the upper surface 14B of the displacement element 14 corresponding to the upper end edge portion 16B of the through hole 16 (i.e., the protrusion formed at a predetermined position on the upper surface 14B of the displacement element 14 corresponds to the protrusion 31 of the upper end edge portion 16B of the through hole 16).

According to Modification 5 of the first embodiment, the protrusion is formed at the predetermined position on the upper surface of the displacement element 14 to make it possible to form a state where the protrusion 31 is provided on the upper end edge portion 16B of the through hole 16. Due to the holding jig 10 having the protrusion 31 at the upper end edge portion 16B of the through hole 16, when a pressing force is applied to the container 200 and a lid 290 between the holding jig 10 and the presser 310 in a sealing device 300 to be described later, the action of the pressing force can be concentrated at a position between the protrusion 31 and the presser 310 of the holding jig 10, and a strong force can be locally applied to the container 200 and the lid 290.

### (Modification 6)

In the holding jig 10 according to the first embodiment, as illustrated in FIGS. 8A and 8B, in the holder 11, an extension 32 extending along the circumferential surface portion 16A of the through hole 16 may be formed on a lower surface 14C of the displacement element 14. The present embodiment is referred to as Modification 6 of the first embodiment. FIGS. 8A and 8B are cross-sectional views for explaining one example of the holding jig 10 according to Modification 6 of the first embodiment. FIGS. 8A and 8B are cross-sectional views passing through the center CT of the through hole 16.

### (Extension)

The extension 32 is formed of a portion extending downward along the side surface 14A from a predetermined portion of the lower surface 14C including the lower end edge of the side surface 14A of the displacement element 14. The position where the extension 32 is formed at the lower end edge of the side surface 14A of the displacement element 14 is a position where at least the circumferential surface portion 16A of the through hole 16 is formed on the side surface 14A of the displacement element 14, that is, a position where the exposed region ER is formed, and the extension 32 is formed as a portion extending downward from the position.

As illustrated in FIGS. 8A and 8B, the auxiliary hole 17 of the base plate 12 is formed to avoid the portion where the extension 32 is formed, and the size of the auxiliary hole 17 is larger than that of the through hole 16.

According to Modification 6 of the first embodiment, the formation of the extension 32 in the through hole 16 makes it possible to expand the contact area between the container 200 and the circumferential surface portion 16A of the through hole 16 and facilitate the holding jig 10 to stably hold the container 200.

However, in the case of the holding target M being the container 200, when the container 200 has a shape in which the body 210 thereof is tapered downward, it is conceivable that the formation of the extension 32 in the through hole 16 makes it easier to expand the contact area in a state where the container 200 is held by the holding jig 10 while the container 200 is inclined relative to the holding jig 10. Therefore, Modification 6 of the first embodiment is preferably a combination of Modification 4 of the first embodiment described above. In this case, as illustrated in FIG. 8B, the circumferential surface portion 16A of the through hole 16 is the inclined surface 30, and the extension 32 extending along the inclined surface 30 of the circumferential surface portion 16A is formed on the lower surface 14C of the displacement element 14 in the holder 11. In this case, the body 210 of the container 200 can be more easily fitted to the circumferential surface portion 16A of the through hole 16 while the inclination of the container 200 is avoided.

### (Modification 7)

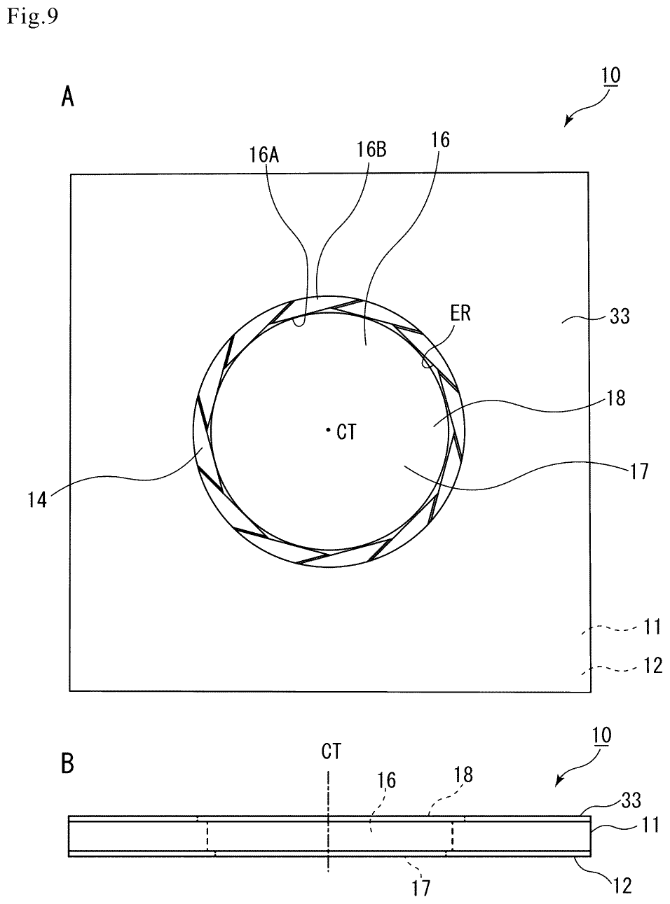

In the holding jig 10 according to the first embodiment, as illustrated in FIGS. 9A and 9B, a protective plate 33 may be provided to cover at least a part of an upper surface 11B of the holder 11. In this case, the protective plate 33 preferably covers at least a part of the upper surface 14B of the displacement element 14. The present embodiment is referred to as Modification 7 of the first embodiment. FIG. 9A is a plan view for explaining one example of the holding jig 10 according to Modification 7 of the first embodiment. FIG. 9B is a side view for explaining one example of the holding jig 10 according to Modification 7 of the first embodiment.

### (Protective Plate)

The protective plate protects the upper surface 11B side of the holder 11. Similarly to the base plate 12, the protective plate 33 is provided with an auxiliary hole 18, and in the example of FIG. 9A, as illustrated in FIG. 9B, a through hole 16 is formed at a position between the auxiliary hole 18 of the protective plate 33 and the auxiliary hole 17 of the base plate 12. The size of the auxiliary hole 18 of the protective plate 33 is preferably larger than the size of the through hole 16 when the size of the through hole 16 is in the enlarged state. Thereby, at least a part of the upper surface 14B of the displacement element 14 is exposed inside the auxiliary hole 18 of the protective plate 33, so that a state where the upper end edge portion 16B of the through hole 16 is exposed is formed, and when the holding target M is the container 200 having the flange 240, the flange 240 of the container 200 can be reliably brought into contact with the upper end edge portion 16B of the through hole 16.

The material of the protective plate 33 is not particularly limited but is preferably metal from the viewpoint of enhancing rigidity.

### (Fixing Member)

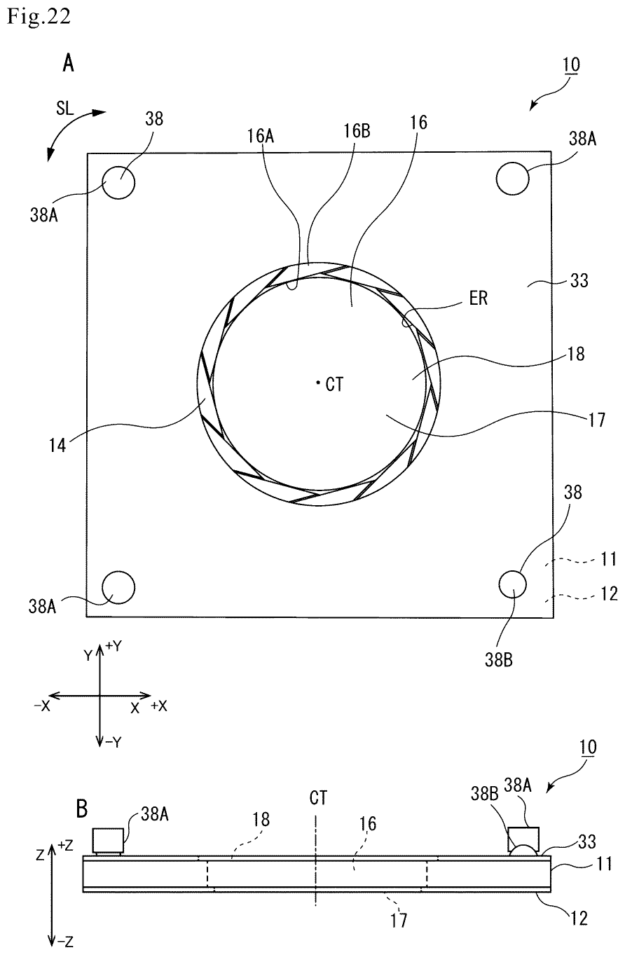

A fixing member 38 for fixing the position of the protective plate 33 is preferably attached to the protective plate 33 removably from the protective plate as illustrated in FIG. 22. In the example of FIG. 22, a first fixing member 38A is provided as the removable fixing member 38. FIG. 22 is a plan view for explaining one example of the holding jig 10 according to Modification 7 of the first embodiment. The first fixing members 38A are provided at three of the four corners. A second fixing member 38B is provided at the remaining one portion. The second fixing member 38B is preferably provided not to be easily attachable and removable as the first fixing member 38A. The first fixing member 38A can be exemplified by a removably attachable screw or the like. The second fixing member 38B can be exemplified by a rivet for performing caulking, or the like.

In this case, the protective plate 33 is preferably not bonded to the holder 11 on the upper surface side of the holder 11. In such a case, with the fixing member 38 removed, the protective plate 33 is configured to be displaceable in a planar direction normal to the thickness direction of the protective plate 33. In the example of FIG. 22, with the first fixing member 38A removed, the protective plate 33 is configured to be rotationally displaceable (in FIG. 22, the rotation direction of the protective plate 33 is indicated by the direction of arrow SL) about the second fixing member 38B in a planar direction normal to the thickness direction of the protective plate 33.

### (Modification 8)

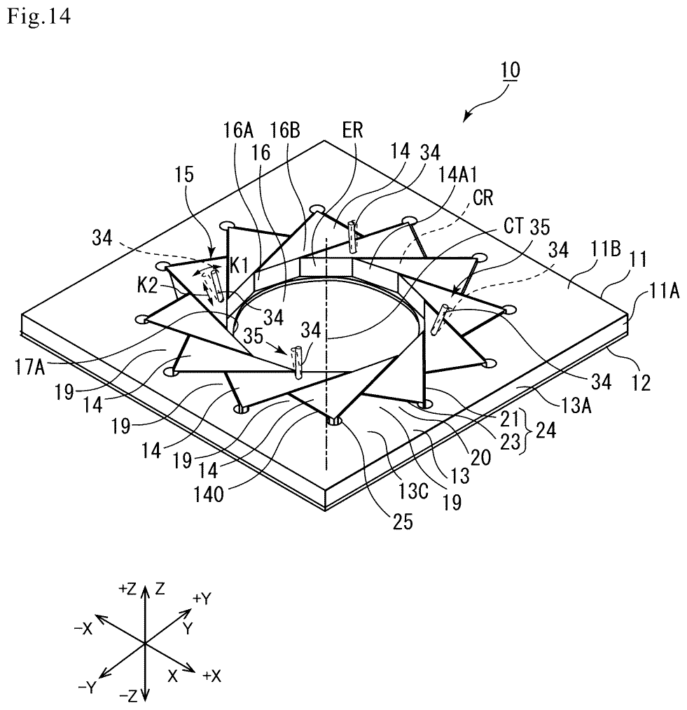

In the holding jig 10 according to the first embodiment, as illustrated in FIG. 14, a positioning structure 35 may be provided. The present embodiment is referred to as Modification 8 of the first embodiment. FIG. 14 is a perspective view for explaining one example of the holding jig 10 according to Modification 8 of the first embodiment.

### (Positioning Structure)

When the holding target in contact with the through hole 16 of the holding jig 10 is a first holding target, a positioning structure 35 is a structure having a function of defining a position (a position in the planar direction) of a second holding target mounted on the upper side (on the +Z direction side in FIG. 14) of the first holding target (including the case of the second holding target overlapping the first holding target). In this case, the holding target M includes the first holding target and the second holding target. Note that the position of the second holding target in the planar direction indicates a plane direction of a plane (XY plane in FIG. 14) normal to the thickness direction (Z-axis direction in FIG. 14) of the holding jig 10.

The position of the positioning structure 35 is not particularly limited, but in the example of FIG. 14, the holder 11 is provided with the positioning structure 35. In the example of FIG. 14, the positioning structure 35 is configured by a combination of a plurality of projecting pieces 34. The projecting piece 34 is provided to rise upward from the upper surface 14B of the displacement element 14. The rising direction of the projecting piece 34 may be a directly upward direction or an obliquely upward direction. In the example of FIG. 14, the rising direction of the projecting piece 34 is a direction rising slightly obliquely upward toward a direction away from the center of the through hole 16 (outward direction).

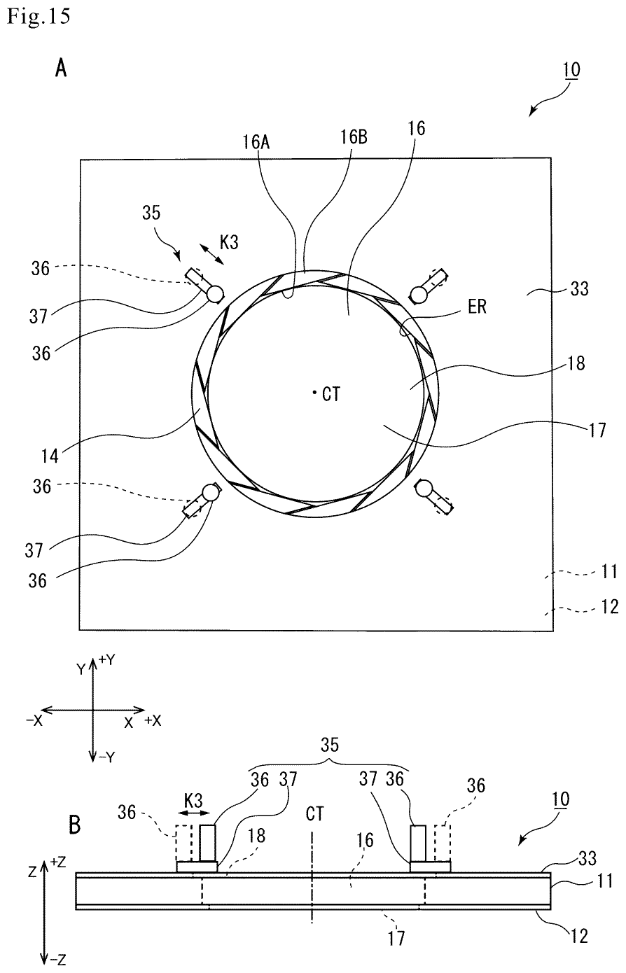

Preferably, the projecting piece 34 can expand in the direction of arrow K1 in accordance with the size of the second holding target when the second holding target is superimposed on the first holding target. In this case, it is easy to define the position of the second holding target relative to the first holding target for the second holding targets having various dimensions. This can be realized, for example, by the projecting piece 34 being made of a flexible material such as metal or plastic. From the viewpoint of heat resistance, the projecting piece 34 is preferably made of metal. The same applies to the slide member 36 to be described later with reference to FIG. 15 and the like. In FIG. 14, the projecting piece 34 is formed of a metal member having a wire shape. However, these are merely examples, and the material or shape of the projecting piece 34 is not limited.

The projecting piece 34 is preferably configured to be able to advance and retract along the rising direction (along the direction of arrow K2 in FIG. 14). Being able to advance and retract means that an advanced state and a retracted state can be formed. The advanced state indicates a state where the projecting piece 34 further extends upward from the upper surface 14B of the displacement element 14. The retracted state indicates a state where the projecting piece 34 sinks further downward from the upper surface 14B of the displacement element 14. This can be specifically realized, for example, by forming a hole in the displacement element 14 at a position on the base end side of the projecting piece 34, disposing an elastic material inside the hole, connecting the elastic material and the projecting piece 34, and forming the advanced state and the retracted state in accordance with the expansion and contraction of the projecting piece 34.

### DIFFERENT EXAMPLES OF POSITIONING STRUCTURE

### Another Example 1

In FIG. 14, the positioning structure 35 has been provided in the displacement element 14, but the position or the structure in which the positioning structure 35 is provided is not limited thereto. For example, as illustrated in Modification 7 of the first embodiment described above, when the holding jig 10 includes the protective plate 33, as illustrated in FIGS. 15A and 15B, the positioning structure 35 may be provided on the upper surface side of the protective plate 33. Such a positioning structure 35 may be referred to as Another Example 1. FIG. 15A is a plan view for explaining one example of the holding jig 10 according to Modification 8 of the first embodiment. FIG. 15B is a side view (side view of the holding jig 10 illustrated in FIG. 15A) for explaining one example of the holding jig 10 according to Modification 8 of the first embodiment. The positioning structure 35 illustrated in FIGS. 15A and 15B is one example of Another Example 1, and the content of Another Example 1 is not limited to FIGS. 15A and 15B.

In the holding jig 10 illustrated in FIGS. 15A and 15B, a plurality of combinations of a slide member 36 and a rail 37 are provided at predetermined positions around the through hole 16 on the upper surface side (+Z direction side) of the protective plate 33. The slide member 36 is formed in a convex shape rising upward from the rail 37 and is attached to the rail 37 on the lower side of the slide member 36. The slide member 36 is configured to be slidable along the rail surface of the rail 37. The rail 37 is fixed on the protective plate 33. Both ends of the rail 37 in the sliding direction (a direction along arrow K3 in FIGS. 15A and 15B) are preferably configured to prevent the slide member 36 from coming off. Specifically, for example, both ends of the rail 37 are preferably closed. In this case, it is easy to regulate the moving range of the slide member 36. With such a configuration as well, it is easy to define the position of the second holding target relative to the first holding target for the second holding targets having various dimensions. The slide member 36 is preferably urged by an elastic member such as a spring or a cushioning material toward the center of the through hole 16. In this case, the plurality of slide members 36 may be connected by the elastic members, or the elastic members may be connected to the individual slide members 36.

### Another Example 2

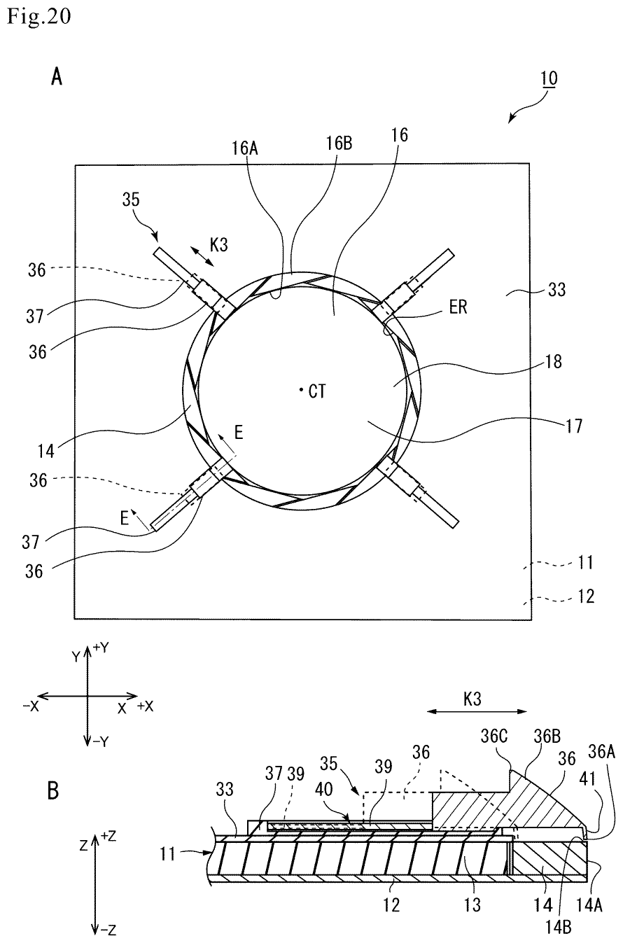

In FIGS. 15A and 15B, the entire positioning structure 35 has been provided in the region above the protective plate 33, but the position or the structure at which the positioning structure 35 is provided is not limited thereto. As illustrated in FIGS. 20A, 20B, and the like, the slide member 36 may be configured to extend from the protective plate 33 to the position of the upper edge portion 16B of the through hole 16. An example of such a positioning structure 35 may be referred to as Another Example 2. FIG. 20A is a plan view illustrating one example of the holding jig 10 according to Modification 8 of the first embodiment. FIG. 20B is a longitudinal sectional view schematically illustrating a state of a longitudinal section taken along line E-E in FIG. 20A. The positioning structure 35 illustrated in FIGS. 20A and 20B is one example of Another Example 2, and the content of Another Example 2 is not limited to FIGS. 20A and 20B.

In the holding jig 10 illustrated in the example of FIGS. 20A and 20B, the positioning structure 35 includes the rail 37 and the slide member 36 similarly to the example illustrated in FIG. 15. The slide member 36 has an inclined surface at an end surface portion (inner end surface portion 36B) closer to the through hole 16 and is inclined downward from an upper end portion 36C of the inner end surface portion 36B toward a lower end portion 36A. Note that a drooping portion 41 that droops toward the displacement element 14 is formed on the lower end portion 36A of the inner end surface portion 36B. The lower end of the drooping portion 41 is the lower end portion 36A. When there is a gap between the lower end portion 36A and the upper surface 14B of the displacement element 14, the size of the gap is preferably smaller than the thickness of the holding target M. The separation distance between the lower end portion 36A and the upper surface 14B of the displacement element 14 (the upper end edge portion 16B of the through hole 16) is preferably as close as possible to zero. However, this does not regulate the generation of a gap between the lower end portion 36A and the upper surface 14B of the displacement element 14. The upper end portion 36C is preferably formed to be located outside either the first holding target or the second holding target in the plan view of the holding jig 10.

The slide member 36 is preferably provided with a biasing structure 40 that biases the slide member 36 inward of the through hole 16 (in the example of FIG. 20A, in a direction toward the center CT). As the biasing structure 40, an elastic member 39 can be exemplified as illustrated in FIG. 20B. In FIG. 20A, the description of the elastic member 39 is omitted for convenience of description. Examples of the elastic member 39 include a spring, a rubber, and the like.

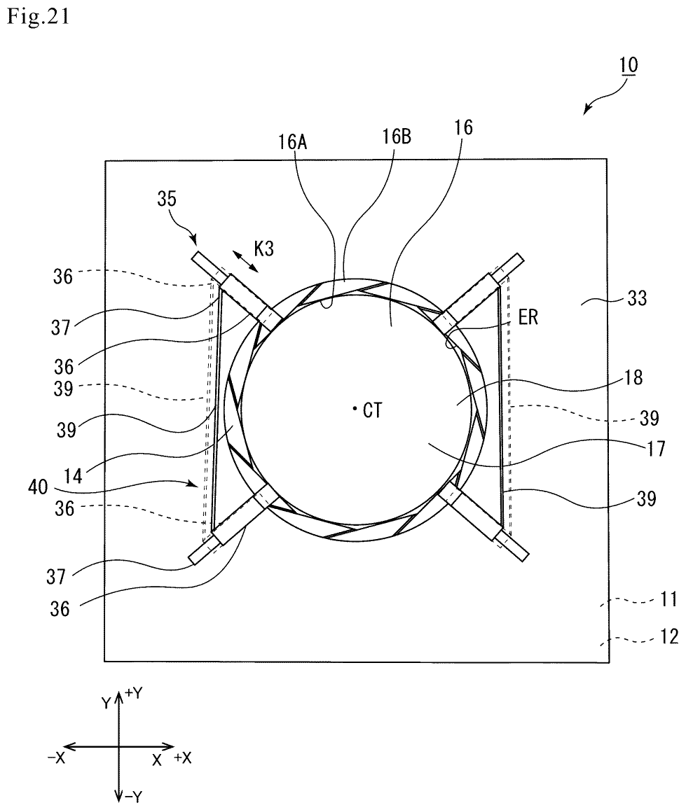

The biasing structure 40 is not limited to the example of FIGS. 20A and 20B. For example, the biasing structure 40 may be configured as illustrated in FIG. 21. FIG. 21 is a plan view illustrating one example of the holding jig 10 according to Modification 8 of the first embodiment. In this example, two slide members 36 adjacent to each other in the circumferential direction of the through hole 16 are connected by the elastic member 39. In this case as well, the slide member 36 can be biased inward of the through hole 16 by the action of the elastic force of the elastic member 39.

### Another Example 3

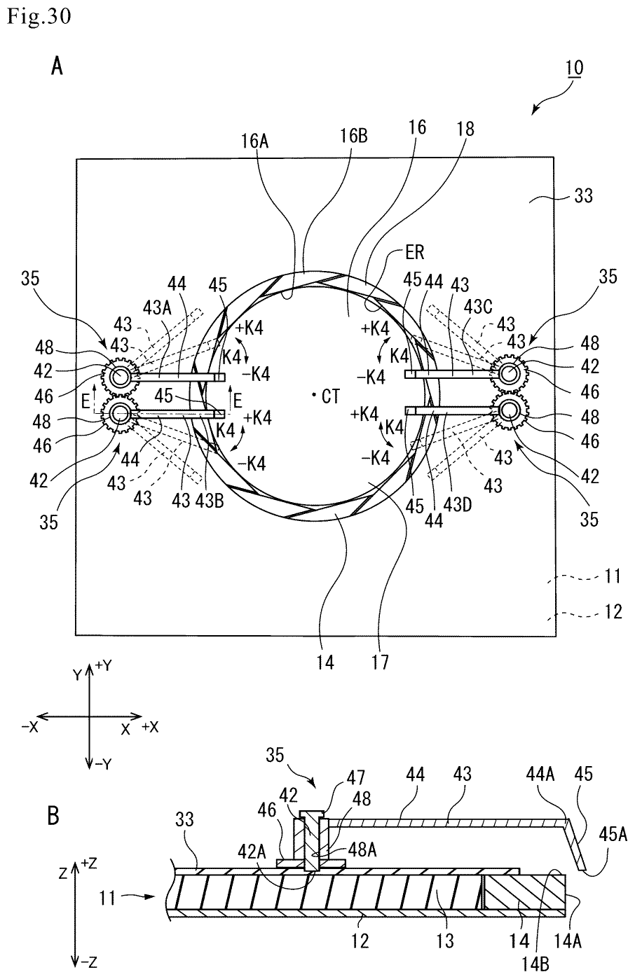

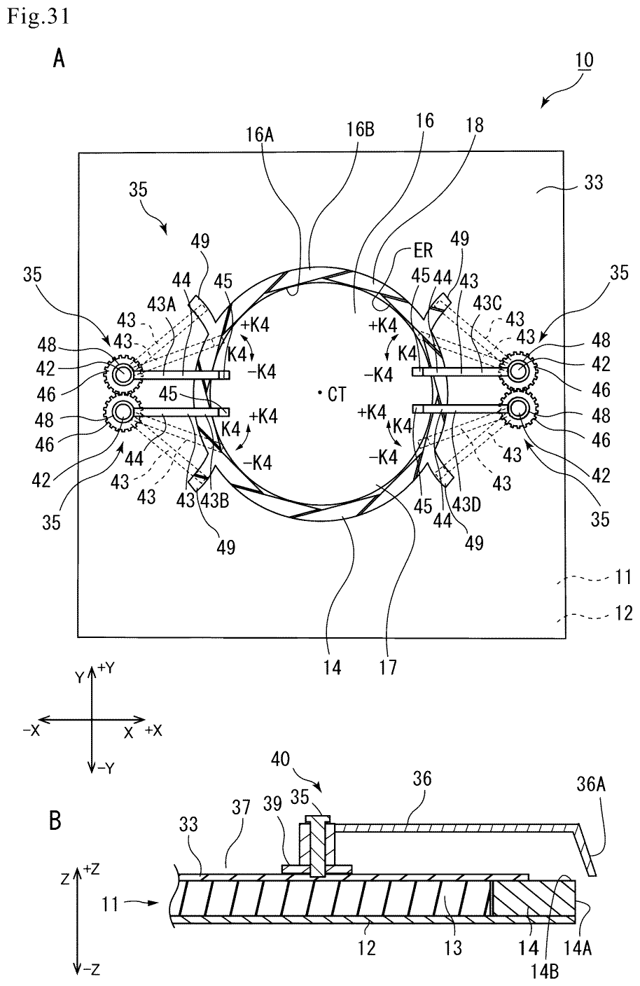

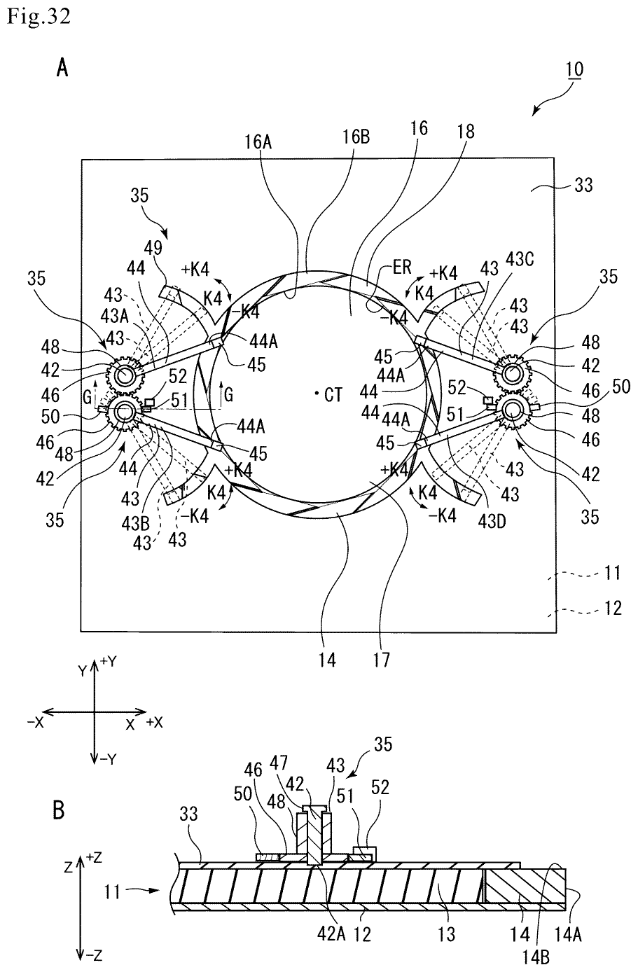

The positioning structure 35 may have a structure as illustrated in FIGS. 30A, 30B, 31, 32A, and 32B. An example of such a positioning structure 35 may be referred to as Another Example 3. FIG. 30A is a plan view illustrating one example of the holding jig 10 according to Modification 8 of the first embodiment. FIG. 30B is a longitudinal sectional view schematically illustrating a state of a longitudinal section taken along line E-E in FIG. 30A. FIGS. 31 and 32A are plan views illustrating another one example of the holding jig 10 according to Modification 8 of the first embodiment. FIG. 30B is a longitudinal sectional view schematically illustrating a state of a longitudinal section taken along line G-G in FIG. 32A. The positioning structure 35 illustrated in FIGS. 30A, 30B, 31, 32A, and 32B is one example of Another Example 3, and the configuration of Another Example 3 is not limited to FIGS. 30A, 30B, 31, 32A, and 32B.

In the holding jig 10 illustrated in the example of FIGS. 30A and 30B, the positioning structure 35 is provided on the upper surface side (+Z direction side) of the protective plate 33. The positioning structure 35 includes a plurality of rotating members 43. In the holding jig 10 illustrated in this example, a support shaft 42 is provided in accordance with the rotating member 43. In the holding jig 10 illustrated in this example, the support shaft 42 is disposed in a region above the protective plate 33. The support shaft 42 supports the rotating member 43. In this example, the support shaft 42 is configured to penetrate a hole portion 48A of a bearing 48 of the rotating member 43 from a head 47 including the upper end side portion of the support shaft 42 and reach the protective plate 33. In the example of FIGS. 30A and 30B, the support shaft 42 is fixed to the protective plate 33. A predetermined portion on a tip 42A side (−Z direction side) of the support shaft 42 has advanced to the protective plate 33, and a portion of the support shaft 42 that advances to the protective plate 33 is fixed to the protective plate 33. At this time, a method for fixing the portion of the support shaft 42 that has advanced to the protective plate 33 to the protective plate 33 is not particularly limited. For example, a thread structure may be formed in a portion of the outer circumferential surface of the support shaft 42 from its tip (lower end) to a predetermined position (a predetermined position toward the upper side) (so-called a half-screw), and a portion of the support shaft 42 that has advanced to the protective plate 33 may be fixed to the protective plate 33 by screwing at least a part of the portion in which the thread structure is formed to the protective plate 33.

### (Rotating Member)

In the example of FIGS. 30A and 30B, the rotating member 43 is rotatable about the support shaft 42. The rotating member 43 includes the bearing 48 with a hole portion 48A penetrating vertically, an arm 44 connected to a predetermined position on the upper end side of the outer circumferential surface of the bearing 48 and extending in a direction away from the bearing 48, and a pin 45 drooping from a tip portion 44A of the arm 44. The arrangement of the rotating member 43 is not particularly limited as long as the function of defining the position of the second holding target described above can be performed. In the example of FIG. 30A, two combinations of two rotating members (a combination of a rotating member 43A and a rotating member 43B, and a combination of a rotating member 43C and a rotating member 43D) (i.e., four rotating members 43) are arranged to be adjacent to each other outside the through hole 16. One combination of the rotating members 43 (the combination of the rotating member 43A and the rotating member 43B) and the other combination of the rotating members 43 (the combination of the rotating member 43C and the rotating member 43D) are disposed at opposite positions (in the example of FIG. 30A, the −X direction side and the +X direction side) with the center CT of the through hole 16 interposed therebetween at positions along the outer circumference of the through hole 16. The combination of the rotating members 43, 43 is configured so that a rotation direction K4 of one rotating member 43 and a rotation direction K4 of the other rotating member 43 are opposite to each other. For example, in an example of the combination of the rotating member 43A and the rotating member 43B, when the rotating member 43A rotates in the +K4 direction, the rotating member 43B rotates in the −K4 direction. When the rotating member 43A rotates in the −K4 direction, the rotating member 43B rotates in the +K4 direction. As a result, the rotating member 43A and the rotating member 43B can rotate so that the respective pins 45 approach each other, and can rotate so that the respective pins 45 move away from each other. The same applies to the combination of the rotating member 43C and the rotating member 43D in that the rotating operation can be performed such that the rotation directions K4 are opposite to each other.

### (Gear)

The structure for performing the rotational operation in which the rotation directions K4 are opposite to each other is not particularly limited. In the example of FIG. 30A, it is realized by a meshing structure of gears 46, 46. For example, when the combination of the rotating members 43A, 43B is taken as an example, the gear 46 is fixed to the lower end side of the bearing 48 of the rotating member 43A, and the gear 46 is also fixed to the lower end side of the bearing 48 of the rotating member 43B. The gears 46, 46 disposed on the rotating members 43A, 43B are engaged with each other to rotate in opposite directions. The configuration of the gear 46 is similar for the combination of the rotating member 43C and the rotating member 43D.

Although the pin 45 is provided in the rotating member 43, the lower end (tip 45A) of the pin 45 is preferably located below the upper surface of the protective plate 33 and slightly above the upper surface 14B of the displacement element 14.

The pin 45 extends obliquely downward toward the center CT from the connection portion with the arm 44 toward the tip 45A, but this is an example. For example, the pin 45 may extend vertically downward. The pin 45 may be partially or entirely bent or curved.

### (Rotation Range of Arm)

The rotation range (the maximum value of the rotation angle along the direction of arrow K3) of the arm 44 in the rotating member 43 is not particularly limited. For example, in the plan view of the holding jig 10, the rotation range of the arm 44 may be determined within a range in which the tip 45A of the pin 45 falls within the formation region of the auxiliary hole 18 of the protective plate 33. The rotation range of the arm 44 may be determined in a range in which the tip 45A of the pin 45 goes out of the formation region of the auxiliary hole 18 of the protective plate 33. The position of the arm 44 when the tip portion 44A of the arm 44 is located closest to the center CT is not particularly limited. In the example of FIGS. 30A, 31, 32A, and the like, positioning is performed for each combination of the rotating members 43, 43. For example, as for the positioning of the arm 44 of the rotating member 43A and the arm 44 of the rotating member 43B, when the second holding target is placed above the first holding target, the arm 44 of the rotating member 43A and the arm 44 of the rotating member 43B are positioned so that the arm 44 of the rotating member 43A and the arm 44 of the rotating member 43B can rotate in the +K4 direction and the −K4 direction, respectively, in accordance with the size of the second holding target. In the example of FIGS. 30A, 31, 32A, and the like, even when the first holding target is held by the upper end edge portion 16B of the through hole 16, the arm 44 of the rotating member 43A and the arm 44 of the rotating member 43B can rotate in the +K4 direction and the −K4 direction, respectively, in accordance with the size of the first holding target. The positioning of the arm 44 is similar for the arm 44 of the rotating member 43C and the arm 44 of the rotating member 43D.

The rotating member 43 is preferably biased so that the tip portion 44A of the arm 44 rotates in a direction approaching the center CT of the through hole 16. In this case, even when the rotating member 43 rotates so that the tip portion 44A of the arm 44 moves away from the center CT of the through hole 16 in the case of holding the first holding target object and the second holding target object by the holding jig 10, the first holding target object and the second holding target object are removed from the holding jig 10, so that the rotating member 43 can rotate in a direction in which the tip portion 44A of the arm 44 approaches the center CT of the through hole 16, and can return to a substantially original position.

### (Escape)

When the rotation range of the arm 44 is determined in a range in which the tip 45A of the pin 45 goes out of the formation region of the auxiliary hole 18 of the protective plate 33, it is preferable to form an escape 49 as illustrated in FIGS. 31, 32A, and the like. In this case, even when the tip 45A of the pin 45 is located below the upper surface of the protective plate 33, it is possible to avoid a possibility that the tip 45A of the pin 45 collides with the protective plate 33 as the rotating member 43 rotates. In the example of FIGS. 31 and 32A, the escape 49 is formed by an arc-shaped cut portion in the plan view of the holding jig 10, but this is an example, and the structure of the escape 49 is not limited to such an example. The size of the escape 49 may be appropriately determined in accordance with conditions such as the sizes of the first holding target and the second holding target.

### (Extension)

As illustrated in the example of FIGS. 32A and 32B, the positioning structure 35 is preferably provided with a first extension 50 and a second extension 51 as extensions extending in a direction away from the support shaft 42 in the rotating member 43. In the example of FIG. 32A and the like, the first extension 50 and the second extension 51 are formed at the outer circumferential end of the gear 46 and are portions protruding outward from the teeth of the gear 46. The first extension 50 is formed at a position where the tip portion 44A of the arm 44 rotates in a direction away from the center CT of the through hole 16 when the first extension 50 contacts a protruding member 410 to be described later. The second extension 51 is formed at a position in contact with a rotation regulating member 52 when the tip portion 44A of the arm 44 rotates in a direction approaching the center CT of the through hole 16. Therefore, the rotation regulating member 52 is disposed at a position where the rotation regulating member 52 can contact the second extension 51. When the tip portion 44A of the arm 44 of the rotating member 43 rotates in a direction approaching the center CT of the through hole 16, the rotation of the rotating member 43 can be stopped at a position where the second extension 51 and the rotation regulating member 52 are in contact with each other. In the example of FIG. 32A, the first extension 50 and the second extension 51 are provided in the rotating members 43B, 43D, and the rotating members 43A, 43C interlock with the rotating operation of the rotating members 43B, 43D via the movement of the gear 46, so that the rotation ranges of the rotating members 43A, 43C are regulated in accordance with the regulation of the rotation of the rotating members 43B, 43D.

### (Actuating Mechanism of Positioning Structure of Another Example 3)

According to the holding jig 10 having the positioning structure 35 described in Another Example 3, when the first holding target is placed in the holding jig 10, the respective rotating members 43 constituting the combination of the rotating members 43, 43 rotate in opposite directions to each other so that the positions of the pins 45 are separated from each other. For example, the pin 45 of the rotating member 43A rotates in the +K4 direction, and the pin 45 of the rotating member 43B rotates in the −K4 direction. Further, the pin 45 of the rotating member 43C rotates in the +K4 direction, and the pin 45 of the rotating member 43D rotates in the −K4 direction. In the example of FIGS. 30A, 31, 32A, and the like, with the rotating members 43 being interlocked by the gear 46 in the combination of the rotating members 43, 43, the rotating members simultaneously stop at positions corresponding to the outer diameter of the first holding target.

When the second holding target is placed above the first holding target, the second holding target is guided to a position substantially immediately above the first holding target by a plurality of pins 45 provided on a plurality of rotating members (in the example of FIGS. 30A, 31, 32A, and the like, the rotating members 43A, 43B, 43C, 43D). Thus, according to the holding jig 10 having the positioning structure 35 described in Another Example 3, the positioning of the second holding target can be realized by the positioning structure 35 having the rotating member.

Note that the positioning structure 35 described in Modification 8 may be applied to a holding jig different from the holding jig 10. For example, unlike the holding jig 10, a holding jig in which the diameter of the through hole is set to a specific diameter (referred to as a constant diameter type) may be prepared, and the positioning structure 35 may be provided for the constant diameter type holding jig.

### Another Example 4

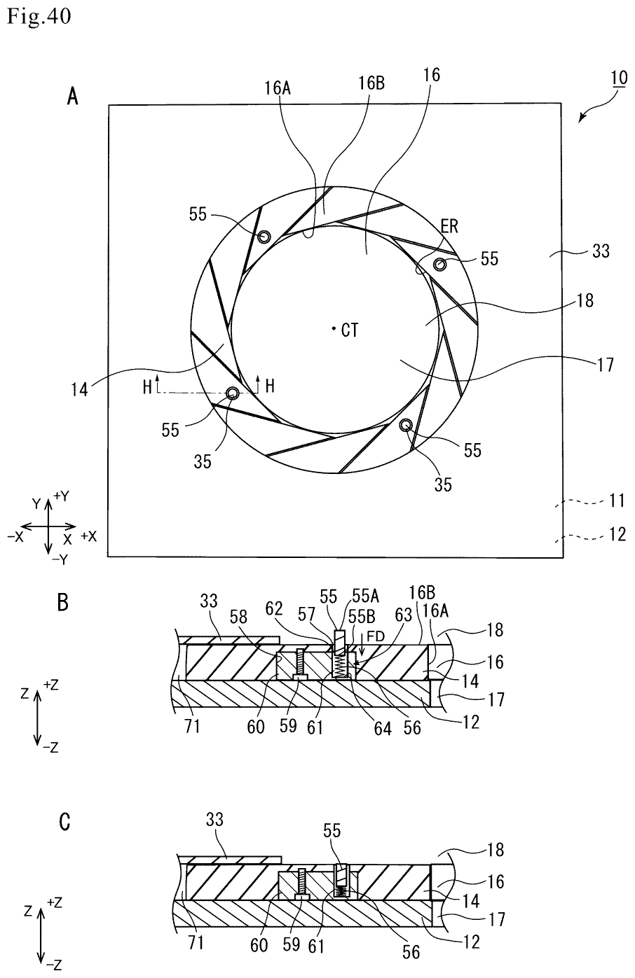

The positioning structure 35 may have a structure as illustrated in FIGS. 40A and 40B. An example of such a positioning structure 35 may be referred to as Another Example 4. FIG. 40A is a plan view illustrating one example of the holding jig 10 according to Modification 8 of the first embodiment. FIG. 40B is a longitudinal sectional view schematically illustrating a state of a longitudinal section taken along line H-H in FIG. 40A. The positioning structure 35 illustrated in FIGS. 40A and 40B is one example of Another Example 4, and the configuration of Another Example 4 is not limited to the example illustrated in FIGS. 40A and 40B. In the example of the holding jig 10 according to Modification 10 illustrated in FIG. 40, the receiving material 13 is omitted, but this is an example. In FIGS. 40B and 40C, reference numeral 71 denotes a gap space generated in response to the omission of the receiving material 13.

### (Pin)

In the holding jig 10 illustrated in the example of FIGS. 40A and 40B, the positioning structure 35 is provided in the holder 11 in the example illustrated here. In the example of FIG. 40A, the positioning structure 35 has a combination of a plurality of pins 55. The pin 55 is preferably formed in a columnar shape, and is preferably disposed so that the longitudinal direction of the pin 55 is substantially along the vertical direction of the holder 11. However, this is an example, and the longitudinal direction of the pin 55 may be a direction along the vertical direction or a direction oblique to the vertical direction. In the plan view of the holder 11, the pin 55 is disposed at a predetermined position within the upper surface 14B of displacement element 14 and is displaced together with the displacement element 14. The pin 55 is disposed so that an upper end 55A can be located above the upper surface 14B of the displacement element 14. Note that the pins 55 may be formed to have the same length or may be formed to have different lengths.

### (In-Out Port)

In the positioning structure 35, the displacement element 14 has an opening serving as an in-out port 57 through which a predetermined portion on the upper end 55A side of the pin 55 is inserted vertically. The size of the in-out port 57 is generally formed to be slightly larger than the size of the outer circumferential surface of the pin 55. The pin 55 is displaced in the vertical direction from the in-out port 57.

### (Attachment Hole)

In the positioning structure 35, the displacement element 14 is provided with an attachment hole 58 for attaching a receiving member 60 to be described later at a predetermined position on the lower surface 14C of the displacement element 14.

### (Receiving Member)

In the positioning structure 35, a receiving member 60 is provided. The receiving member 60 has been fitted into the attachment hole 58. In the example of FIG. 40, the receiving member 60 is fixed to the displacement element 14 with a fixing member 59. The fixing member 59 can be exemplified by a screw or the like. The receiving member 60 is formed in a shape in which an upper surface is opened and a space 61 is formed inside (toward the back) from the opening. In the plan view of the holder 11, an opening 62 of the receiving member 60 is located in the in-out port 57.

### (Vertical Movement Mechanism)

In Another Example 4, a vertical movement mechanism that vertically moves the pin 55 is provided. The vertical movement mechanism is not particularly limited, but from the view point of structural simplicity, it is preferable to employ a biasing structure (sometimes referred to as a pin biasing structure 63) that applies a biasing force to the pin 55 upward. The pin biasing structure 63 is not particularly limited as long as being able to apply a biasing force to the pin 55, but can be exemplified by a structure as illustrated in FIG. 40. The pin biasing structure 63 may be configured so that the pin 55 moves upward when the pressing force is released after the pin 55 is pushed downward by the downward pressing force. In the example illustrated in FIG. 40B, the pin biasing structure 63 includes an elastic member 56. The elastic member 56 is disposed between the lower end 55B of the pin 55 and the bottom surface 64 of the space 61 of the receiving member 60, the lower end of the elastic member 56 is disposed on the bottom surface 64, and the upper end of the elastic member 56 is disposed at the lower end of the pin 55. In the example of FIG. 40B, a spring member such as a winding spring is used as the elastic member 56, but this is an example. The elastic member 56 biases the pin 55 upward in a state where the pin 55 is pushed downward.

According to Another Example 4, when the second holding target is placed, one of the second holding targets is determined by the plurality of pins 55. For example, when the second holding target is a lid, the outer circumferential edge of the lid contacts the pin 55, and the position of the lid is determined in accordance with the position of the pin 55. According to Another Example 4, when a pressing force is applied to the pin 55 pushed downward, the pin can be pushed downward (the direction of arrow FD in FIG. 40B) as illustrated in FIG. 40C. FIG. 40C is a cross-sectional view illustrating an example of a state where the pin 55 has been pushed downward. In a state where the pin 55 has been pushed downward, stress has been applied upward from the elastic member 56 to the pin 55, and when the pressing force applied to the pin 55 downward is removed, the pin 55 is pushed upward by the biasing force applied to the pin 55 from the elastic member 56. Therefore, according to Another Example 4, in a sealing device to be described later that is provided with the holding jig, when the presser tries to bring the distance between the presser and the holding jig close so that the presser presses the second holding target against the first holding target, the pin 55 can be pushed downward, and it is thus possible to reduce the possibility that the pin 55 interferes with the approach of the presser and the holding jig 10.

### (Upper Movement Regulating Structure)

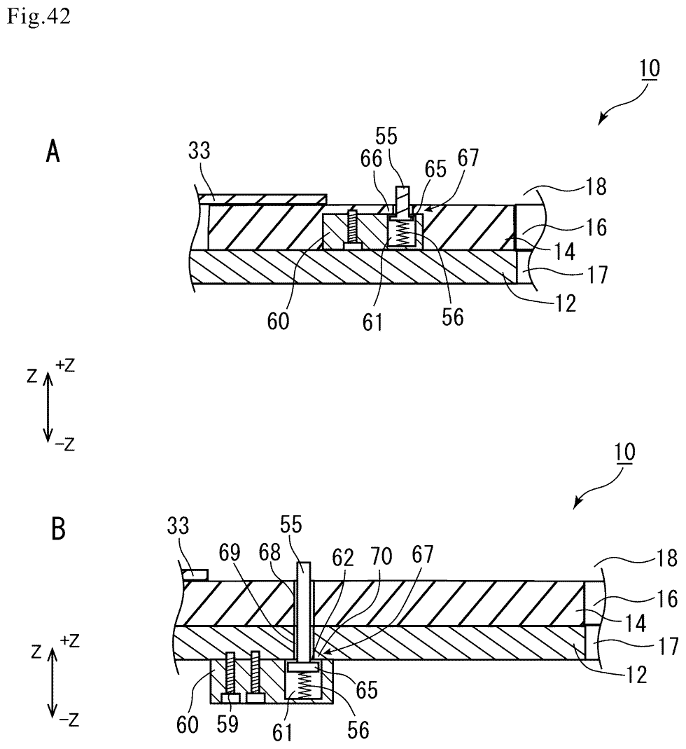

In Another Example 4, when the pin 55 is pushed upward, as illustrated in FIG. 42A, an upper movement regulating structure 67 that defines an upper limit position at which the pin 55 is pushed up may be provided. In FIG. 42, the upper movement regulating structure 67 is configured by forming a flange 65, which extends outward with the longitudinal direction of the pin 55 as the line-of-sight direction, on the lower end side of the pin 55, and forming the eaves portion 66 by making the outer diameter of the flange 65 and the diameter of the opening 62 of the receiving member 60 larger than the diameter of the in-out port 57. According to such an upper movement regulating structure 67, even when the pin 55 is pushed upward, the upward displacement of the pin 55 stops when the flange 65 of the pin 55 contacts the eaves portion 66 of the lower surface 14C of the displacement element 14 on the lower side of the in-out port 57.

### Another Example 5

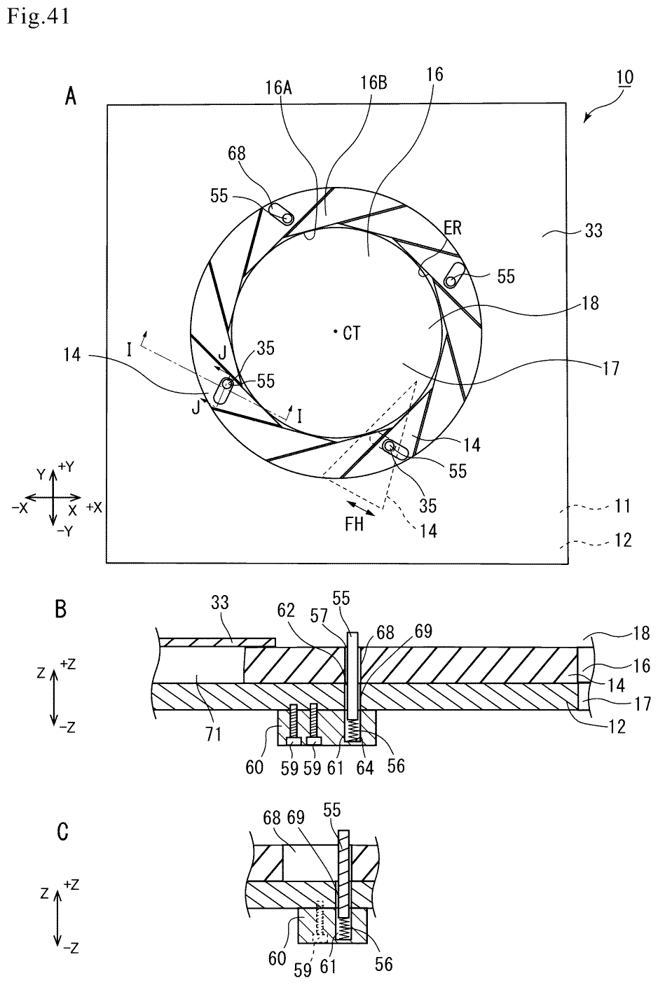

The positioning structure 35 may have a structure as illustrated in FIGS. 41A, 41B, and 41C. An example of such a positioning structure 35 may be referred to as Another Example 5. FIG. 41A is a plan view illustrating one example of the holding jig 10 according to Modification 8 of the first embodiment. FIG. 41B is a longitudinal sectional view schematically illustrating a state of a longitudinal section taken along line I-I in FIG. 41A. FIG. 41C is a longitudinal sectional view schematically illustrating a state of a longitudinal section taken along line J-J in FIG. 41C. The positioning structure 35 illustrated in FIGS. 41A, 41B, and 41C is one example of Another Example 5, and the configuration of Another Example 5 is not limited to the example illustrated in FIGS. 41A, 41B, and 41C. In the example of the holding jig 10 according to Modification 10 illustrated in FIG. 41, the receiving material 13 is omitted, but this is an example. In FIG. 41B, reference numeral 71 denotes a gap space generated in response to the omission of the receiving material 13.

In the holding jig 10 illustrated in the example of FIGS. 41A, 41B, and 41C, the positioning structure 35 is provided in the holder 11. In the example of FIG. 41, the positioning structure 35 includes a combination of a plurality of pins 55, the receiving member 60, and the elastic member 56 as in Another Example 4. The shape of the pin 55 may be similar to that of Another Example 4, and hence the description thereof is omitted. In Another Example 5, as in Another Example 4, in the plan view of the holder 11, the pin 55 is disposed at a predetermined position within the upper surface 14B of the displacement element 14 to be displaceable in the vertical direction.

### (In-Out Through Hole)

In the positioning structure 35, the displacement element 14 is formed with an in-out through hole (first in-out through hole 68) forming an in-out port 57 through which a predetermined portion on the upper end 55A side of the pin 55 is inserted vertically. The first in-out through hole 68 has a so-called long hole shape formed in a long shape in the plan view of the holder 11 and is formed in a chamfered rectangular shape in the example of FIG. 41. The longitudinal direction of the first in-out through hole 68 is preferably aligned with the displacement direction of the displacement element. In this case, even when the displacement of the displacement element 14 occurs, it is possible to prevent the pin 55 from moving in conjunction with the displacement element 14.

Further, in the positioning structure 35, the base plate 12 is also formed with an in-out through hole (second in-out through hole 69) forming an in-out port 57 through which the pin 55 is inserted vertically. In the plan view of the holder 11, a second in-out through hole 69 is aligned to substantially overlap the first in-out through hole 68. The pin 55 is attached to be displaceable in the vertical direction in the state of being inserted through both the first in-out through hole 68 and the second in-out through hole 69.

### (Receiving Member)

In the positioning structure 35, a receiving member 60 is provided. As illustrated in the fourth example, the receiving member 60 is formed in a shape in which an upper surface is opened and the space 61 is formed (toward the back) from the opening 62. The receiving member 60 is aligned so that the opening 62 of the receiving member 60 is at a position substantially overlapping the position of the second in-out through hole 69 in the plan view of the holder 11. The receiving member 60 is attached to the bottom surface of the base plate 12. In the example of FIG. 40, the receiving member 60 is fixed to the base plate 12 with a fixing member 59. The fixing member 59 can be exemplified by a screw or the like.

### (Vertical Movement Mechanism)

In Another Example 5, a vertical movement mechanism that vertically moves the pin 55 is provided. The vertical movement mechanism in Another Example 5 may be configured similarly to Another Example 4. That is, the vertical movement mechanism in Another Example 5 preferably employs the pin biasing structure 63 that applies a biasing force to the pin 55 upward. In the example illustrated in FIGS. 41B and 41C, the pin biasing structure 63 includes an elastic member 56. The elastic member 56 is disposed between a lower end 55B of the pin 55 and a bottom surface 64 of the space 61 of the receiving member 60, the lower end of the elastic member 56 is disposed on the bottom surface 64, and the upper end of the elastic member 56 is disposed at the lower end 55B of the pin 55. In the example of FIG. 40B, a spring member such as a winding spring is used as the elastic member 56, but this is an example. The elastic member 56 biases the pin 55 upward (applies stress upward) in a state where the pin 55 has been pushed downward. Therefore, as illustrated in FIG. 41, the pin biasing structure 63 is configured so that the pin 55 moves upward when the pressing force is released after the pin 55 is pushed downward by the downward pressing force.

According to Another Example 5, when the second holding target is placed, one of the second holding targets is determined by a plurality of pins 55. For example, when the second holding target is a lid, the outer circumferential edge of the lid contacts the pin 55, and the position of the lid is determined in accordance with the position of the pin 55.

### (Upper Movement Regulating Structure)

In Another Example 5, when the pin 55 is pushed upward, as illustrated in FIG. 42B, the upper movement regulating structure 67 that defines an upper limit position at which the pin 55 is pushed up may be provided. In FIG. 42, the upper movement regulating structure 67 is configured by forming the flange 65, expanding outward with the longitudinal direction of the pin 55 as the line-of-sight direction, on the lower end 55B side of the pin 55 and further forming an eaves portion 70. The eaves portion 70 in Another Example 5 is formed on the bottom surface of the base plate 12 by making the outer diameter of the flange 65 and the diameter of the opening 62 of the receiving member 60 larger than the diameter of the second in-out through hole 69 of the in-out port 57. According to such an upper movement regulating structure 67, even when the pin 55 is pushed upward, the upward displacement of the pin 55 stops when the flange 65 of the pin 55 contacts the portion corresponding to the eaves portion 70 of the bottom surface of the base plate 12 on the lower side of the second in-out through hole 69.

### (Modification 9)

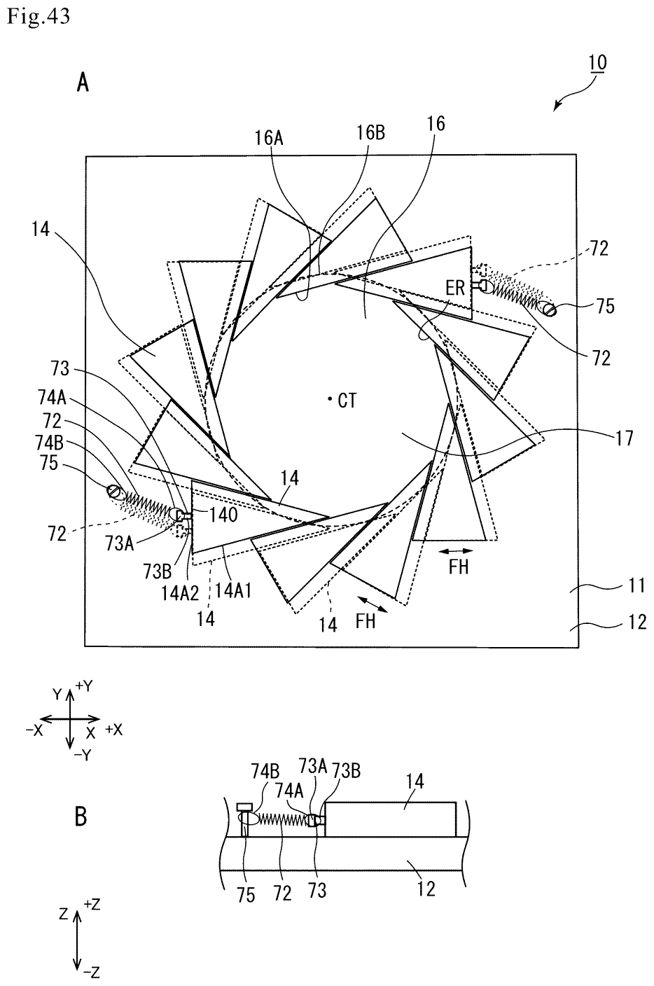

As illustrated in FIGS. 43A and 43B, the holding jig 10 according to the first embodiment may have a configuration in which the elastic member 72 is attached to the displacement element 14. Such a form is referred to as Modification 9 of the first embodiment. FIG. 43A is a plan view illustrating one example of the holding jig 10 according to Modification 9 of the first embodiment. FIG. 43B is a view schematically illustrating the main part of one example of a structure in which the elastic member 72 is attached to the displacement element 14 arranged on an upper surface 12A of the base plate 12.

In the example of the holding jig 10 according to Modification 9 illustrated in FIGS. 43A and 43B, the receiving material 13 is omitted, but this is an example. In the example shown here, a hooking member 73 is provided at a predetermined position on a surface (second side surface 14A2) excluding each of surfaces (first side surface 14A1) of adjacent displacement elements 14 (the surfaces that may be in contact with each other). In the example of FIG. 43, the hooking member 73 is provided on a surface (second side surface 14A2) of a portion of the displacement element 14 corresponding to the base 140. In the example of FIG. 43, the shape of the hooking member 73 is formed in a screw shape having a head 73A and a body portion 73B. The elastic member 72 is provided with, for example, annular portions 74A, 74B as attachment portions at both ends in FIGS. 43A and 43B, and the annular portion 74A on one end side of the elastic member 72 is hooked onto the hooking member 73. The annular portions 74A, 74B are examples, and are not particularly limited as long as having a structure in which the elastic member 72 can be attached to the displacement element. FIGS. 43A and 43B illustrate a spring member such as a winding spring as the elastic member 72. A hooking member 75 is also provided at a predetermined position of the base plate 12, and the annular portion 74B on the other end side of the elastic member 72 is hooked onto the hooking member 75. In the example of FIG. 43, the position of the hooking member 75 on the base plate 12 is determined to a position at which the elastic member 72 is extended when the displacement element 14 is displaced so as to widen the through hole 16 as indicated by a broken line in FIG. 43A. In this case, as the displacement element 14 is displaced (in the example of FIG. 43A, the displacement element 14 moves away from the position of the center CT) so as to widen the through hole 16, the elastic member 72 is extended, a restoring force (a force to return to the original length) is generated in the elastic member 72, and stress is applied to the displacement element 14 from the elastic member 72 so that the through hole 16 narrows relative to the displacement element 14 (so that the displacement element 14 returns to a position corresponding to a state before the through hole 16 expands).

### (Modification 10)

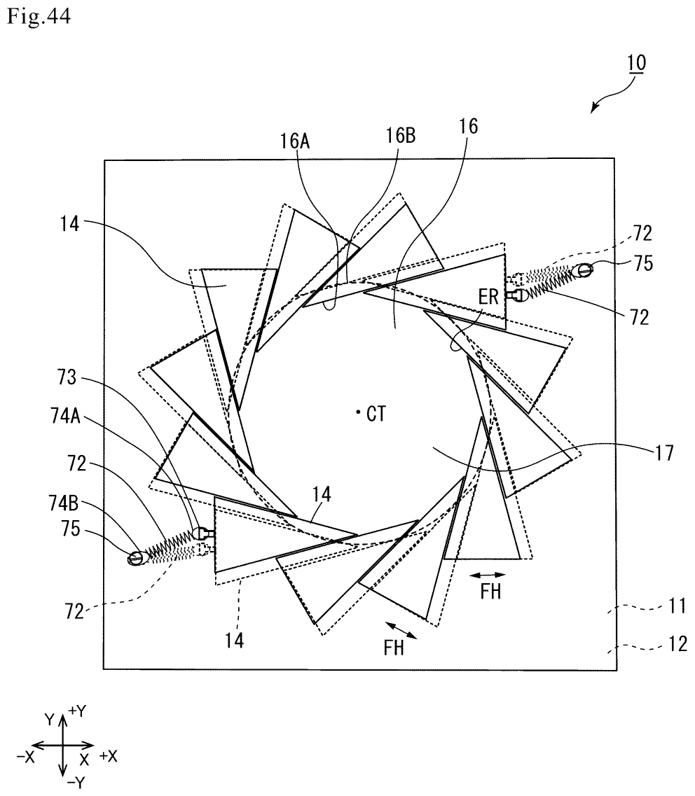

In the holding jig 10 according to Modification 9 of the first embodiment, as illustrated in FIG. 44, the position where the elastic member 72 is attached to the displacement element 14 and the position of the hooking member 75 on the base plate 12 may be determined to a position where the elastic member 72 is contracted when the displacement element 14 is displaced so that the through hole 16 expands. Such a form is referred to as Modification 10 of the first embodiment. FIG. 44 is a plan view illustrating one example of the holding jig 10 according to Modification 10 of the first embodiment. In this case, as indicated by a broken line in FIG. 44, as the displacement element 14 is displaced so as to widen the through hole 16, the elastic member 72 is contracted, and accordingly, the restoring force of the elastic member is generated, and stress is applied from the elastic member 72 to the displacement element 14 so that the through hole 16 narrows relative to the displacement element 14. In the example of the holding jig 10 according to Modification 10 illustrated in FIG. 44, the receiving material 13 is omitted, but this is an example.

### (Modification 11)

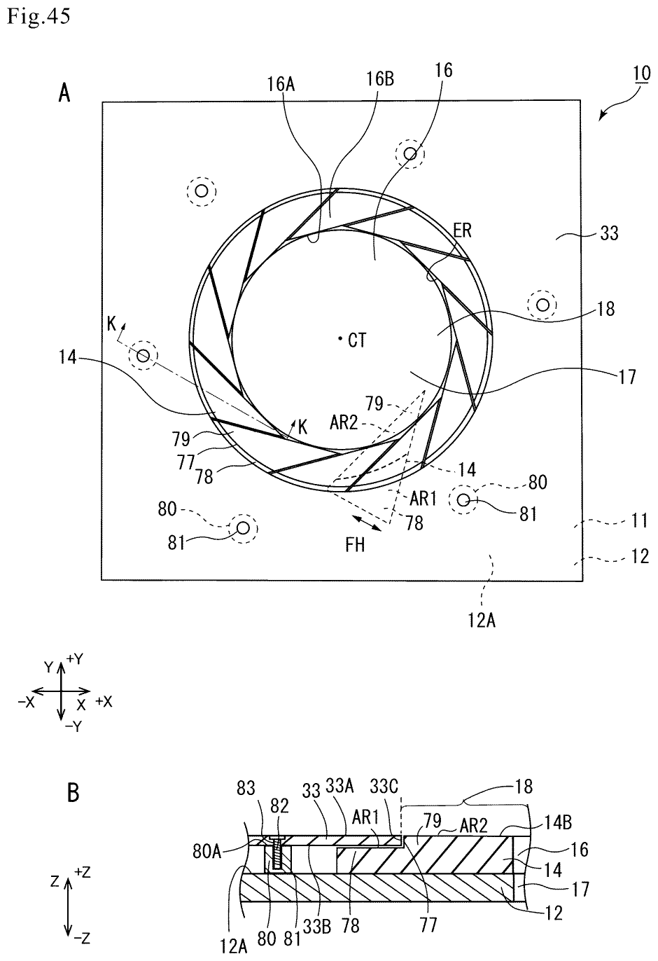

In the holding jig 10 according to Modification 7 of the first embodiment, as illustrated in FIGS. 45A and 45B, a step 77 may be formed in an exposed region exposed to the inside of the auxiliary hole 18 of the protective plate 33 on the upper surface 14B of the displacement element 14. Such a form is referred to as Modification 11 of the first embodiment. FIG. 45A is a plan view schematically illustrating one example of the holding jig 10 according to Modification 11 of the first embodiment. FIG. 45B is a cross-sectional view schematically illustrating a state of a vertical cross section taken along line K-K in FIG. 45A.

In the holding jig 10 according to Modification 7, the step 77 is formed on the upper surface 14B of the displacement element 14, and the upper surface 14B of the displacement element 14 is divided into a region AR1 of a lower portion 78 of the step 77 and a region AR2 of an upper portion 79 of the step 77 with the step 77 as a boundary. The position of the portion of the upper surface 14B (the portion of the region AR1) corresponding to the lower portion 78, which is a portion corresponding to the lower side of the step 77, of the displacement element 14 is a position lower than the position of the lower surface 33B (bottom surface) of the protective plate 33. In the holding jig 10 according to Modification 7, as illustrated in FIGS. 45A and 45B, the position of the portion of the upper surface 14B (the portion of the region AR2) corresponding to the upper portion 79, which is a portion corresponding to the upper side of the step 77, of the displacement element 14 is a position above the position of the lower surface 33B (bottom surface) of the protective plate 33. With such a step 77 being provided, when the displacement element 14 is displaced so as to widen the through hole 16 (in FIG. 45A, for example, when displacement occurs in the direction of arrow FH from the position of displacement element 14 indicated by a broken line to the position of displacement element 14 indicated by a solid line), the displacement of the displacement element 14 can be stopped at a position where the step 77 of the displacement element 14 contacts an inner surface 33C of the protective plate 33, and the upper limit of the size of the through hole 16 can be defined. In addition, it is preferable that the position of the upper surface 14B of the upper portion 79 of the displacement element 14 be substantially aligned with the position of the upper surface 33A of the protective plate 33.

In the plan view of the holding jig 10, the step 77 is preferably formed in a shape that coincides with the edge shape of the auxiliary hole 18.

In the base plate 12, a boss 80 having a boss hole 81 for fixing the protective plate 33 is erected at a predetermined position outside the displacement element 14 on the upper surface 12A side. The protective plate 33 is disposed to be supported by an upper surface 80A of the boss 80. The boss 80 can function as a spacer for ensuring the distance between the protective plate 33 and the base plate 12. The protective plate 33 is provided with a hole portion 83 for inserting a fixing member 82 at a position corresponding to the boss 80. The fixing member 82 such as a screw has been inserted through the hole portion 83 and fitted into the boss hole 81. At least a part of the portion of the displacement element 14 corresponding to the lower portion 78 is sandwiched between the protective plate 33 and the base plate 12 as illustrated in FIG. 45B, and the displacement element 14 is regulated from moving in the vertical direction (wobbling in the vertical direction).

In the example of the holding jig 10 according to Modification 11 illustrated in FIGS. 45A and 45B, the receiving material 13 is omitted, but this is an example.

### (Modification 12)

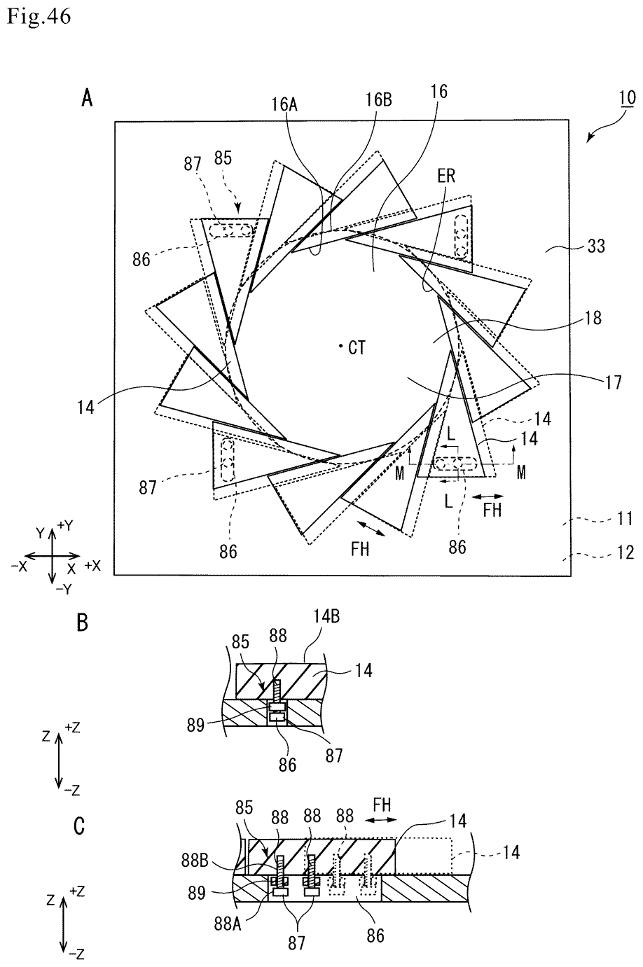

In the holding jig 10 according to Modification 7 of the first embodiment, as illustrated in FIGS. 46A, 46B, and 46C, a displacement guide structure 85 that regulates the displacement direction of the displacement element 14 may be provided on the lower surface 14C side of the displacement element 14. Such a form is referred to as Modification 12 of the first embodiment. FIG. 46A is a plan view schematically illustrating one example of the holding jig 10 according to Modification 12 of the first embodiment. FIG. 46B is a cross-sectional view schematically illustrating a state of a longitudinal cross section taken along line L-L in FIG. 46A. FIG. 46C is a cross-sectional view schematically illustrating a state of a longitudinal cross section taken along line M-M in FIG. 46A. In FIG. 46A, an example of the displacement element 14 when the displacement element 14 is displaced in the outward direction along the direction of arrow FH (in the direction away from the center CT in FIG. 46A) is indicated by a broken line. In FIG. 46C, an example of the displacement element 14 when the displacement element 14 is displaced in the outward direction along the direction of arrow FH (in the direction away from the center CT in FIG. 46A) is indicated by a broken line.

### (Displacement Guide Structure)

The displacement guide structure 85 includes a long hole portion 86 provided in the base plate 12 and a leg 87 provided on the lower surface 14C side of the displacement element 14. It is preferable that the long hole portion 86 be formed so that the longitudinal direction thereof is substantially aligned with the displacement direction of the displacement element 14 (in the example of FIGS. 46A and 46C, the direction of arrow FH (this direction is specified for each displacement element 14)). The leg 87 has a plurality of leg members 88 at positions corresponding to the long hole portion 86, and the plurality of leg members 88 are arranged substantially along the longitudinal direction of the long hole portion 86. In the example of FIG. 46B, two leg members 88 are arranged along the longitudinal direction of the long hole portion 86. The shape of the leg member 88 is not particularly limited as long as the leg member 88 is displaceable along the longitudinal direction of the long hole portion 86, but in the example of FIGS. 46A to 46C, the leg member 88 has a body portion 88B formed in a columnar body, and a flange 88A is formed at the lower end of the body portion 88B. The upper end side of the leg member 88 is fixed to the displacement element 14. In the example of FIGS. 46A to 46C, a thread groove is formed in a predetermined portion from the upper end toward the lower side in the body portion 88B of the leg member 88. At least a part of the thread groove forming portion of the body portion 88B is fitted (screwed) to the lower surface 14C (bottom surface) of the displacement element 14. When the displacement guide structure 85 is provided, the leg 87 can displace the space in the long hole portion 86 in the direction of arrow FH as illustrated in FIG. 46C, and the displacement of the displacement element 14 can be regulated in this direction.

### (Ring Material)

The leg 87 is preferably provided with a ring member 89 disposed to go around the body portion 88B. The ring member 89 is disposed between the flange 88A of the leg member 88 and the lower surface 14C of the displacement element 14. In addition, the ring member 89 is rotatably provided around the body portion 88B. When such a ring member 89 is provided, the leg 87 can more smoothly displace the space in the long hole portion 86 in the direction of arrow FH as illustrated in FIG. 46C.

### (Modification 13)

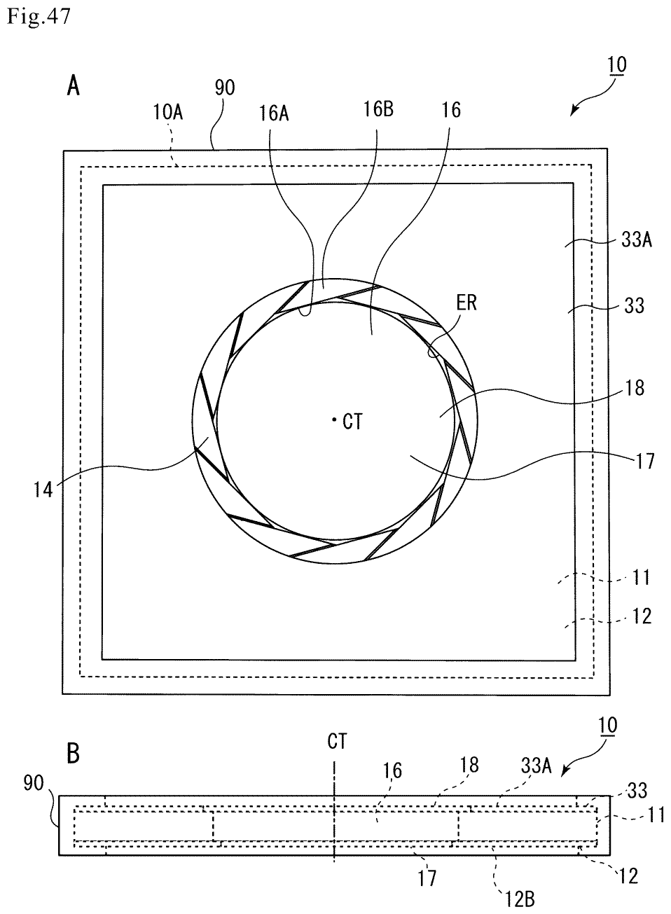

In the holding jig 10 according to Modification 7 of the first embodiment, as illustrated in FIGS. 47A and 47B, a covering material 90 (outer peripheral covering material) having cushioning properties may be provided to surround the outer peripheral portion 10A of the holding jig 10 and cover the outer peripheral portion 10A. Such a form is referred to as Modification 13 of the first embodiment. FIGS. 47A and 47B are a plan view and a side view, respectively, schematically illustrating one example of the holding jig 10 according to Modification 13 of the first embodiment.

In the holding jig 10 according to Modification 13 of the first embodiment, the material of the covering material 90 is not particularly limited as long as having cushioning properties, and examples thereof include a rubber material, a silicon material, a urethane material, and the like. As also illustrated in FIG. 47A and the like, it is preferable that the covering material 90 cover the outer peripheral portion 10A of the holding jig 10 and cover from the end edge on the upper surface side of the holding jig 10 (the upper surface 33A of the protective plate 33 in the example of FIG. 47A) to a predetermined position slightly inside the upper surface (inside the holding jig 10 in the plan view). It is also preferable that the covering material 90 further cover from the end edge on the lower surface side of the holding jig 10 (the lower surface 12B of the base plate 12 in the example of FIG. 47A) to a predetermined position slightly inside the lower surface (inside the holding jig 10 in the plan view). In the holding jig 10, the covering material 90 is provided to be in contact with the protective plate 33 and the base plate 12 and not in contact with the displacement element 14. This reduces the possibility that the covering material 90 interferes with the displacement of the displacement element 14.

According to the holding jig 10 in Modification 13, with the covering material 90 being provided, it is possible to further reduce the possibility of damaging other objects when the holding jig 10 falls and contacts other objects, and it is possible to reduce the possibility of breakage of the holding jig 10. According to the holding jig 10 in Modification 13, it is possible to reduce the possibility of breakage of the holding jig 10 even in a case where the holding jig 10 is transported or some other case.

### (Modification 14)

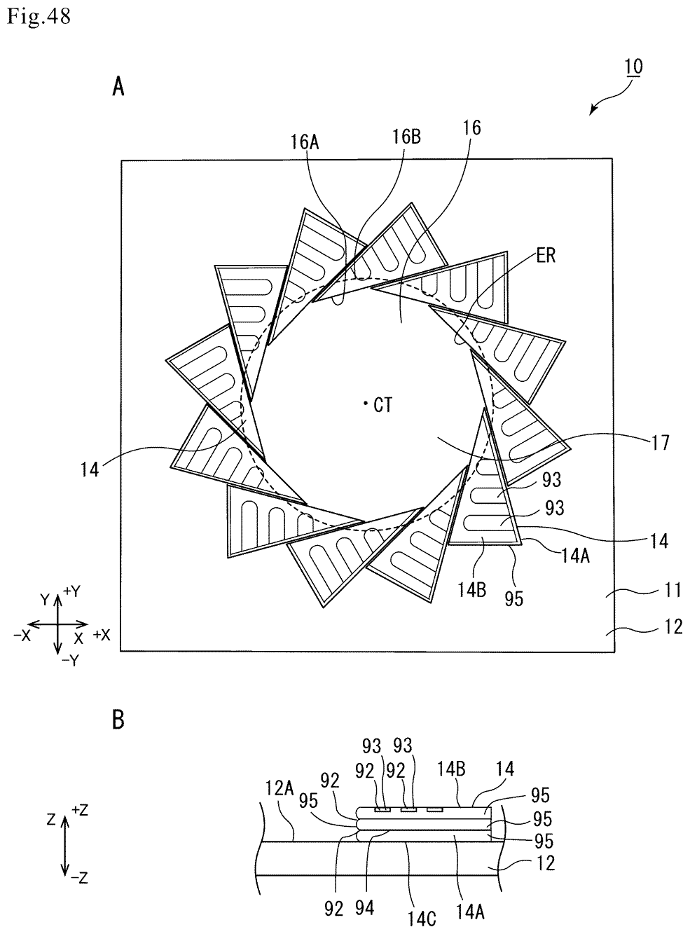

In the holding jig 10 according to the first embodiment, as illustrated in FIGS. 48A and 48B, a groove 92 may be provided in the displacement element 14 for at least a part of the displacement element 14. Such a form is referred to as Modification 14 of the first embodiment. FIG. 48A is a plan view schematically illustrating one example of the holding jig 10 according to Modification 14 of the first embodiment. FIG. 48B is a view schematically illustrating one example of a state where the displacement element 14 is disposed on the upper surface 12A of the base plate 12.

### (Groove)

In the holding jig 10 according to Modification 14 of the first embodiment, the groove 92 is formed in at least a part of at least one of the side surface 14A, the upper surface 14B, and the lower surface 14C of the displacement element 14.

In the example of FIGS. 48A and 48B, a first groove 93 is formed as the groove 92 on the upper surface 14B of the displacement element 14. The first groove 93 is preferably formed in a portion of the upper surface 14B away from a portion corresponding to the upper end edge portion 16B of the through hole 16. The longitudinal direction of the first groove 93 preferably extends along the displacement direction of the displacement element 14 from the viewpoint of facilitating the dirt substance to flow to the outside even if the dirt substance adheres to the upper end edge portion 16B.

In the example of FIGS. 48A and 48B, a second groove 94 is formed as the groove 92 on the side surface 14A of the displacement element 14. It is preferable that, on the side surface 14A of the displacement element 14, a plurality of convex mountainous portions 95 curved in a gently convex shape be formed to be arranged in the vertical direction, and the second groove portion be formed between the adjacent convex mountainous portions 95. In this case, the second groove 94 is formed as a lateral groove extending in the lateral direction on the side surface 14A. The formation of the second groove 94 is preferably avoided on the surface of the side surface 14A where the through hole 16 is formed.

### (Modification 15)

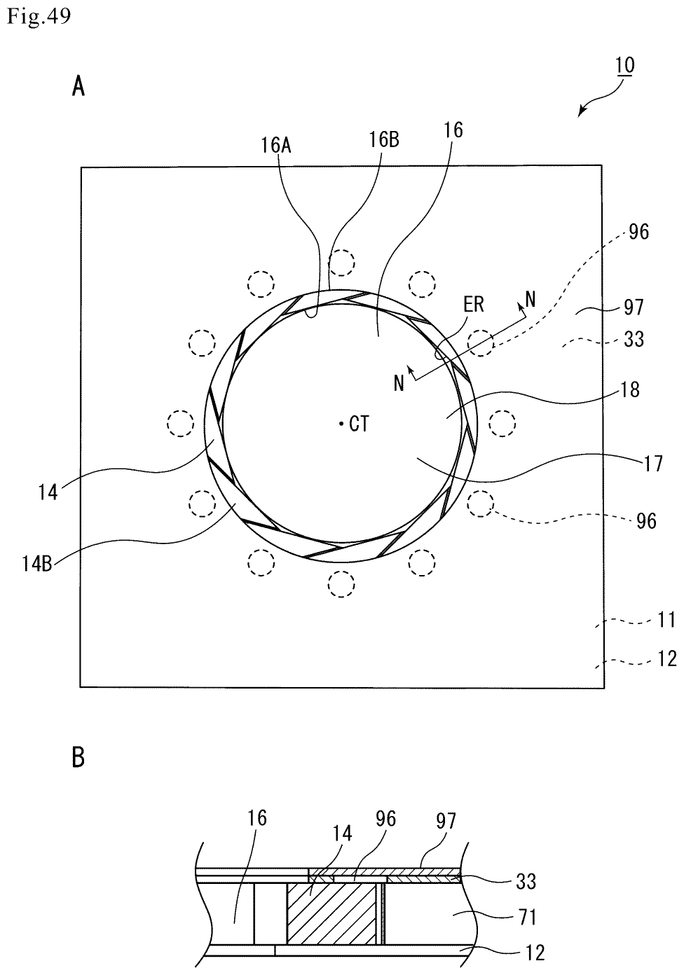

In the holding jig 10 according to Modification 7 of the first embodiment, the protective plate 33 has been provided to cover at least a part of the upper surface 11B of the holder 11. In the holding jig 10 according to Modification 7 of the first embodiment, as illustrated in FIGS. 49A and 49B, a small penetration portion 96 that penetrates the protective plate 33 in the thickness direction (in FIGS. 49A and 49B, the vertical direction) of the protective plate 33 may be provided at a predetermined position of the protective plate 33. Such a form is referred to as Modification 15 of the first embodiment. FIG. 49A is a plan view illustrating one example of the holding jig 10 according to Modification 14 of the first embodiment. FIG. 49B is a plan view illustrating one example of the holding jig 10 according to Modification 14 of the first embodiment. In the example of FIGS. 49A and 49B, the receiving material 13 is omitted, but this is an example. In FIG. 49B, reference numeral 71 denotes a gap space generated in response to the omission of the receiving material 13.

### (Small Penetration Portion)

The small penetration portion 96 is a portion that penetrates the protective plate 33 and has an opening size smaller than that of one displacement element. The small penetration portion 96 having an opening size smaller than that of one displacement element indicates that the size of the small penetration portion 96 is small enough that the upper surface 14B of the displacement element 14 is not completely exposed from the small penetration portion 96 in the plan view of the holding jig 10. At least a part of the small penetration portion 96 is positioned to be able to overlap at least a part of the upper surface 14B of the displacement element 14 in the plan view of the holding jig 10. The layout of the small penetration portion 96 is preferably such that each of all the disposed displacement elements 14 can expose at least a part of the upper surface 14B of the displacement element 14 upward via at least one small penetration portion 96 in the plan view of the holding jig 10. The small penetration portion 96 is formed as a circular hole in the example of FIG. 49A, but this is an example. The small penetration portion 96 may be a non-circular hole or may be formed in a slit shape. Due to the inclusion of the small penetration portion 96 in the holding jig 10, even if dirt adheres to the displacement element 14 inside the holding jig 10, a cleaning liquid such as water is poured from the upper surface side of the holding jig 10, so that the cleaning liquid or the like can be allowed to flow into the upper surface 14B of the displacement element 14 through the small penetration portion 96, thereby effectively cleaning the displacement element 14.

### (Blind Plate)

In the holding jig 10 according to Modification 15 of the first embodiment, it is preferable to provide a blindfold plate 97 that covers the small penetration portion 96 from the upper surface side. It is preferable to provide the blindfold plate 97 removably from the protective plate 33. With such a blindfold plate 97 being provided, it is possible to reduce the possibility that dust or the like falls from the upper surface of the holding jig 10 to the small penetration portion 96. The material of the blindfold plate 97 is not particularly limited, but plastic is preferable from the viewpoint of lightweight, and a metal material is preferable from the viewpoint of strength. The shape of the blindfold plate 97 is not particularly limited as long as the blindfold plate 97 can cover the small penetration portion 96, but from the viewpoint of making movement such as positional deviation relatively less likely to occur in the plane direction of the protective plate 33 relative to the protective plate 33, the shape is preferably substantially similar to the shape of the protective plate 33 as illustrated in FIGS. 49A and 49B.

Next, a second embodiment will be described. A second embodiment is a sealing device 300 using the holding jig 10 described in the first embodiment.

### 2. Second Embodiment

### 2-1. Configuration of Sealing Device

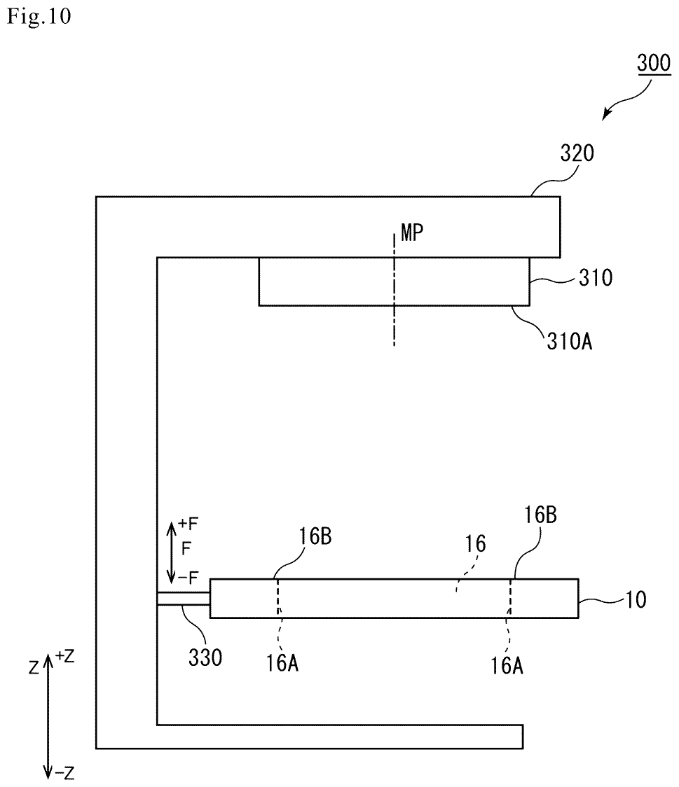

As illustrated in FIG. 10, the sealing device 300 according to the second embodiment includes a presser 310 and the holding jig 10 described in the first embodiment. FIG. 10 is a side view illustrating one example of the sealing device according to the second embodiment. In FIG. 10, for convenience of description, the displacement element 14, the base plate 12, and the like are omitted.

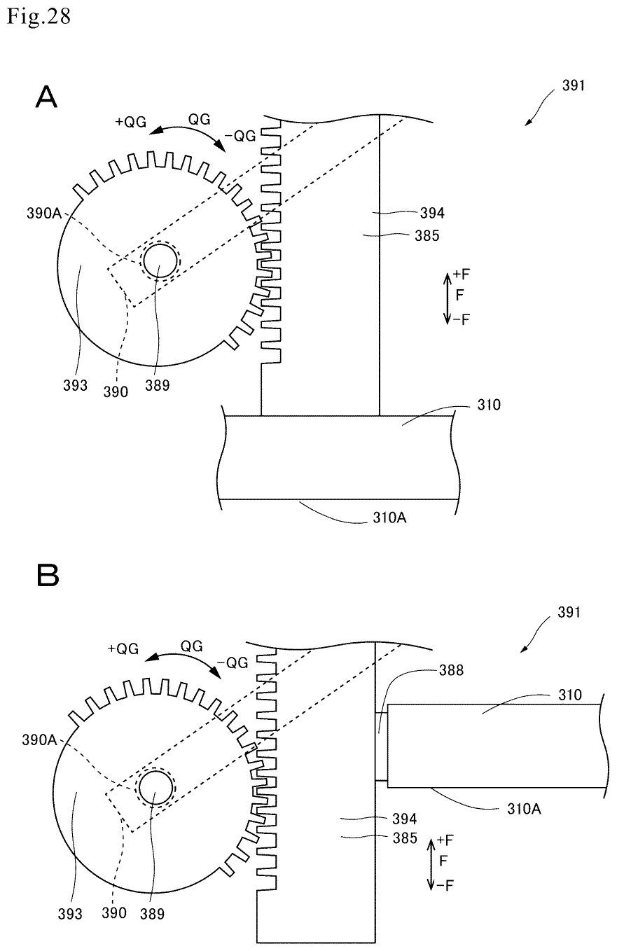

The sealing device 300 includes the presser 310 and a support 320 that supports the holding jig 10, and the support 320 is provided with a vertical movement mechanism for moving the holding jig 10 up and down (a movement mechanism for moving the holding jig 10 in the direction of arrow F in FIG. 10) (not illustrated in FIG. 10). The vertical movement mechanism can be exemplified by, for example, a combination structure of a gear and a rack as illustrated in FIG. 28A and the like, which will be described later with respect to the presser 310. The movement of the gear may be controlled by the movement of a lever as illustrated in FIG. 28A or the like, or may be controlled by a motor or the like. The holding jig 10 is connected to the vertical movement mechanism of the support 320 via a coupling member 330. The material of the coupling member 330 is not particularly limited as long as being able to sufficiently support the holding jig 10, but is preferably one having rigidity such as metal. With a predetermined position (lower position) away from the presser 310 toward the lower side (−F direction side) by a predetermined distance as a position in the initial state, the holding jig 10 moves toward the presser to a predetermined position (upper position) closer to the upper side (+F direction side) relative to the presser. The lower position and the upper position may be determined in advance in accordance with the content of the holding target M or the like.

The presser 310 illustrated in the example of FIG. 10 is located immediately above the holding jig 10 and is fixed to the support 320 on the upper side of the support 320. The presser 310 may be provided with a heating mechanism. In this case, the sealing device 300 functions as a heat-sealing device. The presser 310 has a pressing surface 310A, and the pressing surface 310A faces the holding jig 10. Then, the holding target M receives a pressing force between the pressing surface 310A and the holding jig 10. At this time, when the presser 310 has a heating mechanism, the holding target M can be heated. The heating mechanism may be any mechanism that can heat presser 310. The heating mechanism can be exemplified by, for example, a heater or the like. The shape of the pressing surface 310A is not particularly limited. In the example of FIG. 10, the pressing surface 310A is formed in a planar shape. However, FIG. 10 is an example and does not limit the shape of the presser 310 or the shape of the pressing surface 310A.

### (Sealing Function)

The sealing device 300 can realize a sealing function as described below. Note that the sealing function will be described with reference to FIG. 11, taking as an example a case where the holding target M is the container 200 having the body 210 and the flange 240 that extends outward at the upper edge portion 250 of the body 210. As illustrated in FIG. 11, a case where the container 200 has the body 210 tapered from the upper end to the lower end, and the body 210 of the container 200 has an opening 260 on the upper end side and the space 230 surrounded by the body 210 and the bottom portion 220 is taken as an example. The same applies to the description of actions and effects to be described later.

The body 210 of the container 200 is placed in the through hole 16 of the holding jig 10. At this time, the holding jig 10 is disposed at the lower position (position N1 in FIG. 11). Next, the holding jig 10 moves in the +F direction from the lower position toward the upper position (position N3 in FIG. 11). Even when the outer circumferential surface 210A of the body 210 of the container 200 contacts the through hole 16 of the holding jig 10 during the movement, the size of the through hole 16 can be increased in accordance with the size of the outer circumferential surface 210A of the body 210. When the weight of the container 200 is large, the size of the through hole 16 of the holding jig 10 gradually increases as the holding jig 10 moves upward, and the circumferential surface portion 16A of the through hole 16 slides on the outer circumferential surface 210A of the container 200. When the holding jig 10 reaches the position in contact with the flange 240 of the container 200 (position N2 in FIG. 11), the container 200 and the holding jig 10 integrally move upward while the container 200 is supported by the holding jig 10.

In the container 200, the lid 290 is placed on the container 200 to cover the opening 260 (and the space 230) on the upper surface of the body 210 and the flange 240. The lid 290 may be a paper lid or a plastic lid. The timing at which the lid 290 is placed on the container 200 is not particularly limited. The timing may be a time point when the container 200 is placed in the sealing device 300, or a timing when the container 200 is moved upward together with the holding jig 10. However, at the timing before the holding jig 10 receives the pressing force from the presser 310 at the upper position, the lid 290 is placed on the container 200 to cover the opening 260 on the upper side of the body 210 and the flange 240.

In the sealing device, the holding jig 10 reaches the upper position while the lid 290 is placed on the container 200 to cover the opening 260 on the upper side of the body 210 and the flange 240. Then, the container 200 and the lid 290 are interposed between the presser 310 and the holding jig 10, and the lid 290 and the container 200 are pressed at the position of the flange 240 of the container 200. At this time, the lid and the container 200 are heated as necessary. The lid 290 and the container 200 are thus joined.

### 2-2. Actions and Effects

In the sealing device 300 according to the second embodiment, the holding jig 10 described in the first embodiment is used. Therefore, according to the second embodiment, when the holding target M is the container 200 having the flange 240 at the upper end, the holding jig 10 can hold each of the containers 200 that may have different sizes, and a state where the flange 240 is in contact with the upper end edge portion 16B of the through hole 16 of the holding jig 10 can be formed. Therefore, the container 200 and the lid 290 can be sandwiched by the presser and the holding jig 10 while the lid 290 is placed to cover the flange 240 and the opening 260 of the container 200.

When the sealing device 300 according to the second embodiment is controlled so that the holding jig 10 is disposed on the lower end side of the container 200 and the holding jig 10 is raised toward the upper end side of the container 200 as illustrated in FIGS. 10 and 11, the size of the through hole 16 can be changed in accordance with the size of the outer circumferential surface 210A of the body 210 of the container 200 even when the size of the outer circumferential surface 210A is not uniform, so that the holding jig 10 can be slid along the outer circumferential surface 210A of the body 210 of the container 200.

Next, modifications of the second embodiment will be described.

### 2-3. Modification

### (Modification 1)

In the sealing device 300 according to the second embodiment, the presser 310 has been fixed, but the presser 310 may be configured to be movable vertically. The present embodiment is referred to as Modification 1 of the second embodiment. Modification 1 of the second embodiment can be realized by providing a vertical movement mechanism that vertically moves the presser 310 to the support 320 and connecting the presser 310 to the vertical movement mechanism. In Modification 1 of the second embodiment, the holding jig 10 may be fixed or may be configured to be vertically movable as described above.

### (Vertical Movement Structure)

The vertical movement structure can be exemplified by a combination structure of a gear and a rack or the like. The combination structurer can be exemplified by a structure as illustrated in FIG. 28A to be described later. The gear may be connected to a motor or the like and electrically driven and controlled. The rack moves vertically as the gears rotate. The rack is connected to the presser 310, and the presser 310 is configured to move vertically as the rack moves vertically. When the gear is driven by a motor or the like, the power source for driving the vertical movement structure can be exemplified by electric power, and in this case, the vertical movement structure is controlled electrically.

### (Modification 2)

In the sealing device 300 according to the second embodiment, the holding jig 10 has been configured to be vertically movable, but may be configured to be movable in a direction (plane direction) along a plane normal to the vertical direction (not illustrated).

### (Modification 3)

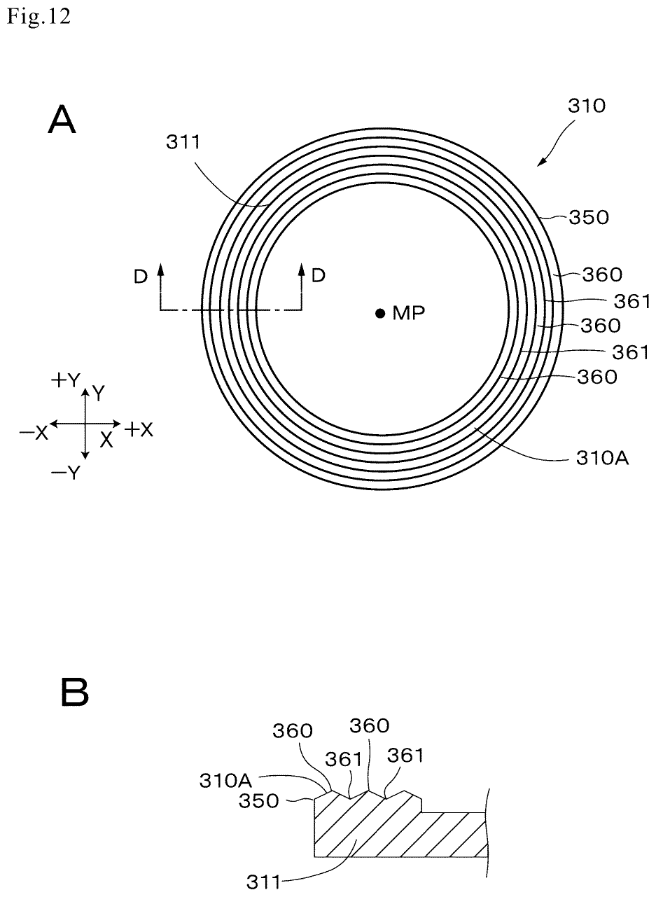

In the sealing device 300 according to the second embodiment, as illustrated in FIGS. 12A and 12B, the pressing surface 310A of the presser 310 may be an uneven surface. The present embodiment is referred to as Modification 3 of the second embodiment. FIG. 12A is a view illustrating one example of the presser 310 used in the sealing device 300 according to Modification 3 of the second embodiment. FIG. 12B is a cross-sectional view schematically illustrating a longitudinal cross section taken along line D-D in FIG. 12A.

In the presser 310, as illustrated in FIGS. 12A and 12B, a plurality of convex portions 360 are concentrically formed from an outer circumferential end 350 of the pressing surface 310A, and a concave portion 361 is formed between the adjacent convex portions 360. Thus, the pressing surface 310A forms an uneven surface. In the example of FIGS. 12A and 12B, three convex portions 360 are formed on the pressing surface, but this is an example, and two or less convex portions or four or more convex portions 360 may be formed. In the example of FIG. 12A, the presser 310 is formed in a circular shape in its plan view, and as illustrated in FIG. 12B, a predetermined portion from the outer circumferential end 350 toward a center MP is a thick portion 311. The thick portion 311 is defined as a portion having a thickness larger than the thickness at the position of the center MP of the presser 310. The convex portion 360 is formed in a region of the pressing surface 310A corresponding to the thick portion 311. When the presser 310 comes into contact with the holding target M, the presser 310 presses the holding target M with the thick portion 311. The formation of the uneven surface on the pressing surface 310A and the formation of the convex portion 360 on the thick portion 311 as illustrated in FIG. 12A enables a pressing force applied from the presser 310 to the holding target M to be concentrated on the convex portion 360 and a stronger force to be applied from the presser 310 to the holding target M.

### (Modification 4)

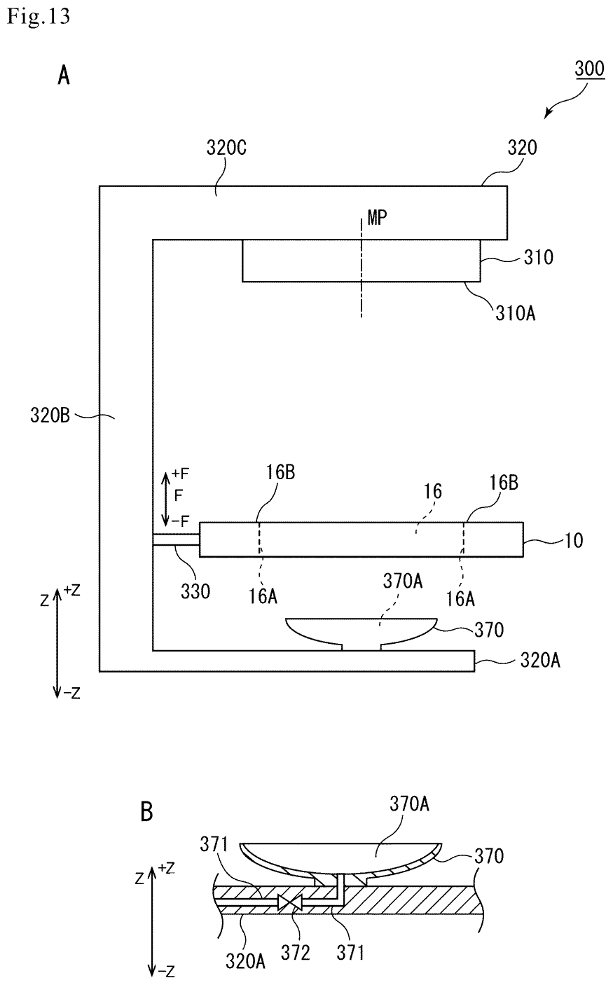

In the sealing device 300 according to the second embodiment, as illustrated in FIGS. 13A and 13B, a vertical movement regulating structure may be provided. The present embodiment is referred to as Modification 4 of the second embodiment. FIG. 13A is a view illustrating one example of the sealing device 300 according to Modification 4 of the second embodiment. FIG. 13B is a cross-sectional view schematically illustrating the main part of one example of the vertical movement regulating structure used in one example of the sealing device 300 according to Modification 4 of the second embodiment.

### (Vertical Movement Regulating Structure)

The vertical movement regulating structure is a structure that regulates the movement in the vertical direction of the holding target to be held by the holding jig 10. The vertical movement regulating structure is not particularly limited, but in the example of FIG. 13A, the vertical movement regulating structure has a suction cup disposed below the holding jig 10. Hereinafter, the description of Modification 4 of the second embodiment will be continued by taking a case where the vertical movement regulating structure has a suction cup as an example.

As illustrated in FIG. 13A, the suction cup is attached to the support 320. The support 320 illustrated in FIG. 13 includes a base portion 320A, a standing wall portion 320B rising upward from the base portion 320A, and an upper surface portion 320C formed to face the base portion 320A from the upper end of the standing wall portion 320B, and the presser 310 is connected by the upper surface portion 320C. The holding jig 10 is vertically movably connected to the standing wall portion 320B. The suction cup 370 is attached to the base portion 320A so that its suction surface 370A faces upward, and in the state illustrated in FIG. 13A, the through hole 16 of the holding jig 10 is located immediately above the suction surface 370A. According to the sealing device 300 in Modification 4 of the second embodiment, when the container 200 is inserted into the through hole 16, the outer surface of the bottom portion 220 of the container 200 is sucked to the suction surface 370A. By the action of the adhesion force, it is easy to move the holding jig 10 upward so as to rub against the outer circumferential surface of the body 210 of the container 200 while the position of the container 200 is fixed regardless of the weight of the container 200.

### (Decompression Control Structure)

The suction cup 370 may be provided with a decompression control structure. The decompression control structure includes a long hole 371 connecting the suction surface 370A of suction cup 370 and the outside and a valve 372 provided in the middle of the long hole 371 to control the ventilation state of the long hole 371. The long hole 371 is connected to the base portion 320A from the center of the suction surface 370A. When the container 200 is placed on the suction surface 370A while the valve 372 blocks the ventilation of the long hole 371 (the valve 372 is closed), the container 200 is fixed by the suction cup 370. When valve 372 is opened, the container 200 and the suction cup 370 are released from the fixed state. According to the sealing device 300 in Modification 4 of the second embodiment, the fixed state of the container 200 can be controlled. Note that the release of the fixed state between the suction cup 370 and the container 200 is not limited to only when the valve 372 is opened. The fixed state between the suction cup 370 and the container 200 may be released by adjusting the adhesion of the suction cup 370 itself in accordance with physical properties, such as softness, of the suction cup 370. For example, when the holding jig 10 moves and rubs on the outer circumferential surface of the body 210 of the container 200, the adhesion force acts to fix the vertical position of the container 200, and when the holding jig 10 contacts the flange 240 of the container 200, the adhesion between the container 200 and the suction cup 370 may be released by the action of the pulling force of the container 200 by the holding jig 10 because the adhesion force by the suction cup 370 is weaker than the pulling force.

### (Modification 5)

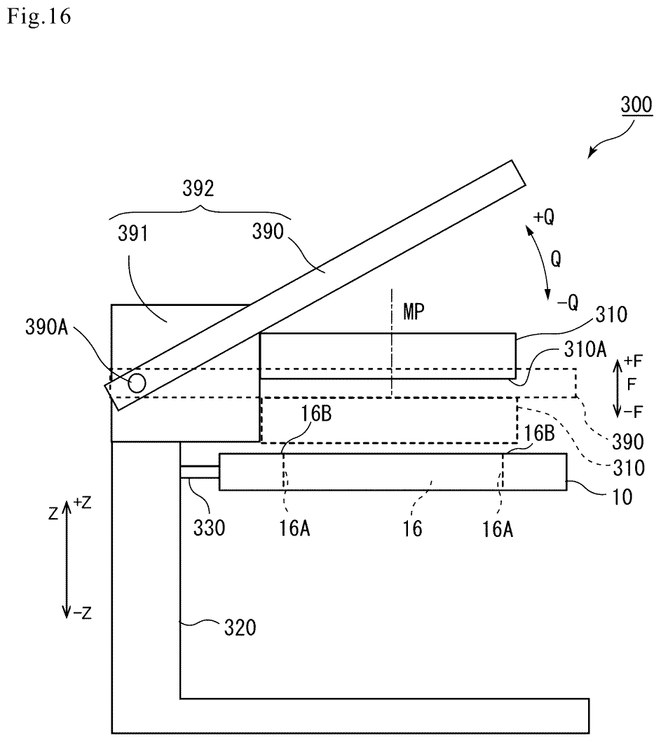

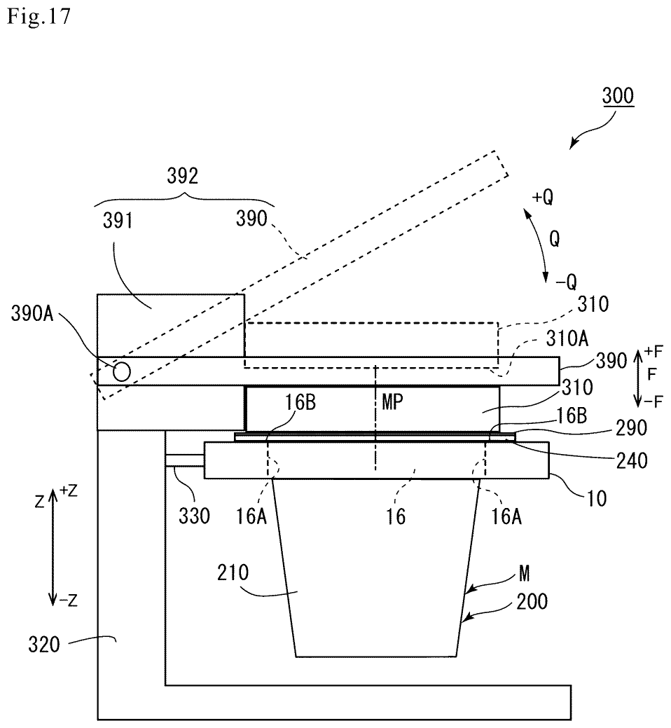

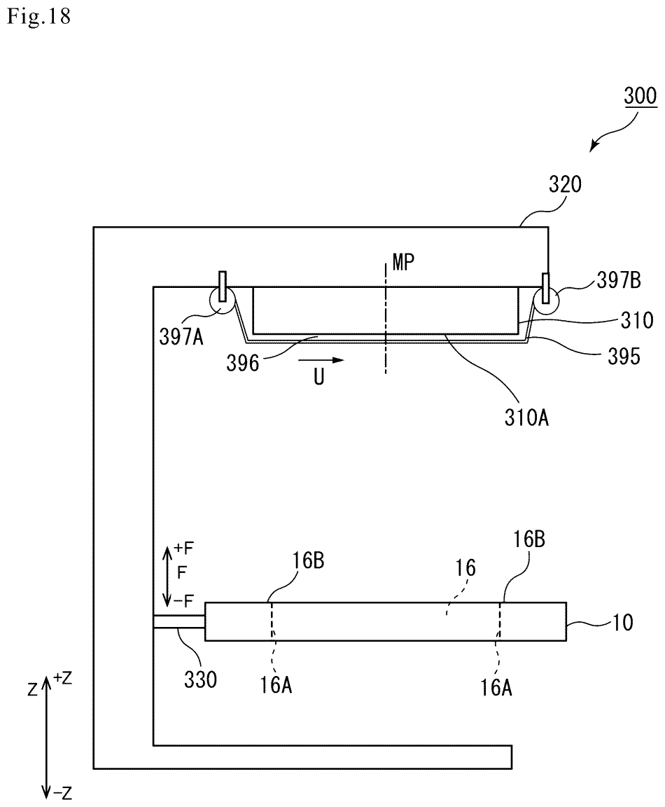

In Modification 1 of the second embodiment, the vertical movement structure that enables the vertical displacement of the presser 310 has been provided. Then, a case where electricity is used as a power source of the vertical movement structure has been exemplified. In Modification 1 of the second embodiment, the power source of the vertical movement structure is not limited to electricity. As illustrated in FIG. 16, a vertical movement structure 392 may be configured to drive a physical force different from electricity as a power source. The present embodiment is referred to as Modification 5 of the second embodiment. FIG. 16 is a side view illustrating one example of the sealing device according to Modification 5 of the second embodiment. In FIG. 16, similarly to FIG. 10, for convenience of description, the displacement element 14, the base plate 12, and the like are omitted. The same applies to FIGS. 17 and 18.

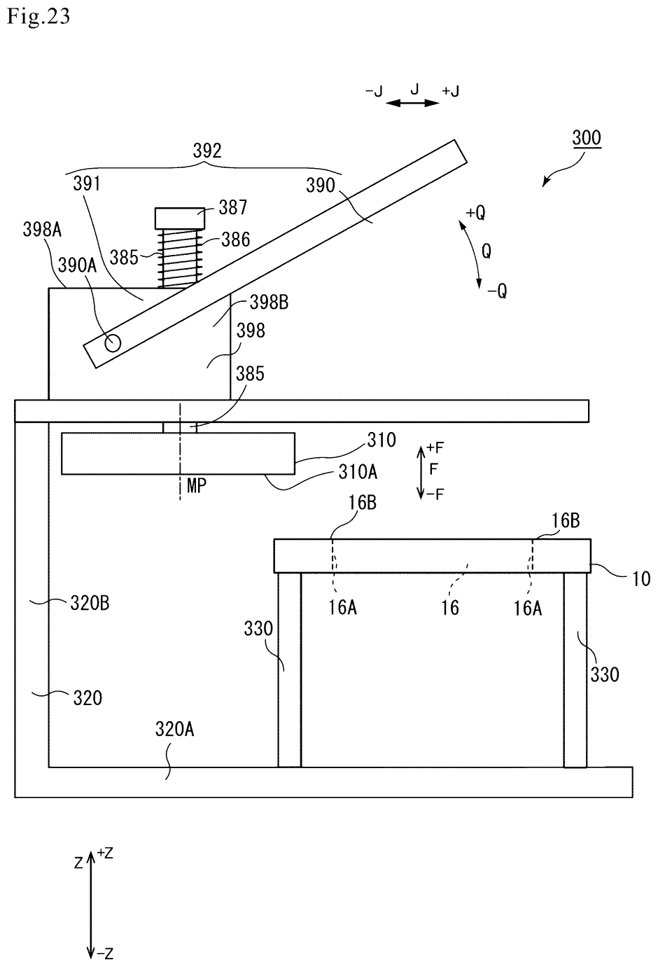

The sealing device 300 includes the support 320 that supports the presser 310 and the holding jig 10. The support 320 illustrated in FIG. 16 includes the base portion 320A and the standing wall portion 320B rising upward from the base portion 320A. The same applies to FIGS. 17, 18, and 23 to 27. In the example of FIG. 16, a vertical movement mechanism for moving the holding jig 10 up and down is omitted from the support 320. The holding jig 10 is connected to the support 320 via the coupling member 330. Therefore, the holding jig 10 does not move substantially in the vertical direction and is fixed in the state of being connected to the support 320 via the coupling member 330. However, this is not limited to the case where the holding jig 10 does not move vertically. Even when the sealing device 300 is a so-called manual type sealing device, the holding jig 10 may move vertically. In the case of moving the holding jig 10 vertically in the sealing device 300 as well as in Modification 5 of the second embodiment, the power source of the holding jig 10 may be a physical force different from electricity or may be electricity or the like, similarly to the presser 310. In the example of FIG. 16, the coupling member 330 is connected to the standing wall portion 320B of the support 320, but this is an example, and as illustrated in FIGS. 23 to 27 and the like, the coupling member 330 may be connected to the base portion 320A of the support.

### (Power Source of Vertical Movement Structure)

In the example of FIG. 16, the power source of the vertical movement structure 392 is physical force as non-power, and human power such as a force from the user's hand can be exemplified as the physical force. In this case, the sealing device 300 is a so-called manual type sealing device.

### (Vertical Movement Structure)

The vertical movement structure 392 includes a lever 390 and a movement control structure 391. The movement control structure 391 is connected to the lever 390 and the presser 310 and is configured to move the presser 310 in the direction of arrow F in accordance with the movement of the lever 390 in the direction of arrow Q. The movement control structure 391 can be configured by a combination structure of various gears or the like. The lever 390 is configured to be rotatable in the Q direction with a fulcrum 390A as the axis of rotation. The movement control structure 391 can be exemplified by, for example, a mechanism (gear structure) including a gear 393 and a rack 394 that meshes with the gear 393 as illustrated in FIGS. 28A and 28B. FIGS. 28A and 28B are views illustrating main parts in one example of the movement control structure 391. The gear 393 is connected to a support shaft 389 serving as the axis of rotation of the gear 393, and the support shaft 389 is connected to the fulcrum 390A of the lever 390. The rack 394 is connected to the presser 310. In the example of FIGS. 28A and 28B, the rack 394 functions as a support member 385. However, this does not prohibit the rack 394 from being a different member from the support member 385 that supports the presser 310. In the example of FIG. 16, the presser 310 is connected to the side portion of the rack 394 as illustrated in FIG. 28B, but this is an example, and the presser 310 may be connected to the lower end portion of the rack 394 as illustrated in FIG. 28A. The presser 310 to be described later with reference to FIGS. 23 to 27 and the like is connected to the lower end portion of the rack 394. Further, as illustrated in FIG. 28B, the rack 394 and the presser 310 may be directly connected to each other (may be joined to each other), or as illustrated in FIG. 28A, the rack 394 and the presser 310 may be connected to each other via a coupling member 388. The material of the coupling member 388 may be the similar to that of the coupling member 330 described above. In FIGS. 28A and 28B, the lever 390 is indicated by a broken line for convenience of description. When the lever 390 is rotated in the Q direction, the gear 393 is rotated in the QG direction, and the rack 394 is displaced in the F direction. For example, in the example of FIG. 28, when the gear 393 rotates in the −QG direction, the rack 394 moves in the −F direction, and the presser 310 is displaced in the −F direction. When the rotation direction of the gear 393 becomes the +QC direction, the presser 310 is displaced in the +F direction.

The vertical movement structure 392 is preferably configured to bring a state where the lever has been moved in the +Q direction into a non-pressing state using an elastic material such as a spring. The non-pressing state indicates a state where the presser 310 is not pressing the holding target. As a result, when the user pushes down the lever 390 (displaces the lever in the −Q direction), the presser 310 moves downward (in the −F direction) in conjunction, and when the user releases the lever 390, the lever 390 is displaced in the +Q direction, and the presser 310 can easily move upward (in the +F direction) in conjunction with the displacement.

### (Sealing Function)

The sealing device 300 can realize a sealing function as described below. Similarly to FIG. 11, the sealing function will be described with reference to FIG. 17 by taking a case where the holding target M is the container 200 as an example.

The body 210 of the container 200 is placed in the through hole 16 of the holding jig 10. The container 200 is pushed until the holding jig 10 reaches a position (position N2 in FIG. 11) in contact with the flange 240 of the container 200. At this time, when the size of the through hole 16 is smaller than the size of the container 200 (the size of the cross section of the outer circumferential surface), the size of the through hole 16 is widened in accordance with the size of the container 200.

In the container 200, the lid 290 is placed on the container 200 to cover the opening 260 (and the space 230) on the upper surface of the body 210 and the flange 240.

In the sealing device, the container 200 and the lid 290 are interposed between the presser 310 and the holding jig 10 with the lid 290 placed on the container 200 to cover the opening 260 on the upper side of the body 210 and the flange 240, and the lever 390 is lowered downward (in the −Q direction), causing the presser 310 to be displaced in the −F direction. Then, between the presser 310 and the holding jig 10, the lid 290 and the container 200 are pressed at the position of the flange 240 of the container 200. At this time, the lid and the container 200 are heated as necessary. The lid 290 and the container 200 are thus joined. The lever 390 is raised in the +Q direction, and the presser 310 is displaced upward (in the +F direction) accordingly. Then, the container 200 to which the lid 290 is joined is taken out.

In Modification 5 illustrated in FIG. 16, the presser has been disposed laterally (in FIG. 16, the +X direction side) to the vertical movement structure, but where the vertical movement structure or the presser is disposed is not limited thereto. As illustrated in FIG. 20, the presser may be disposed on the lower side of the vertical movement structure.

### (Modification 6)

In Modification 5 of the second embodiment, as illustrated in FIG. 23, the presser 310 may be configured to be movable not only in the vertical direction (the direction of arrow F in FIG. 23) but also in the front-rear direction (the direction of arrow J in FIG. 23). Such an embodiment in Modification 5 will be referred to as Modification 6 of the second embodiment. FIG. 23 is a view illustrating one example of the sealing device according to Modification 6 of the second embodiment.

### (Front-Rear Direction Movement Structure)

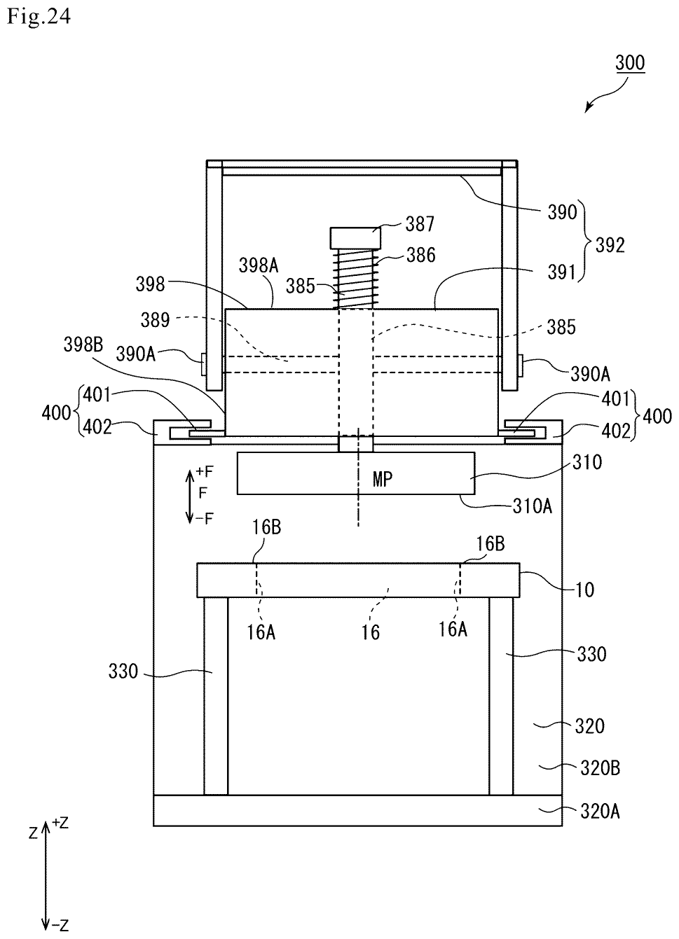

The sealing device 300 according to Modification 6 of the second embodiment includes a front-rear direction movement structure 400. In the example of FIG. 23, the front-rear direction movement structure 400 is configured by a combination of a slide member 401 and a rail 402 as illustrated in FIG. 24. FIG. 24 is a front view of the sealing device 300 illustrated in the example of FIG. 23. The slide member 401 is attached to a side surface 398B of a housing 398, which serves as the exterior portion of the movement control structure 391 of the vertical movement structure 392, and is fitted to the rail 402.

### (Displacement of Presser)

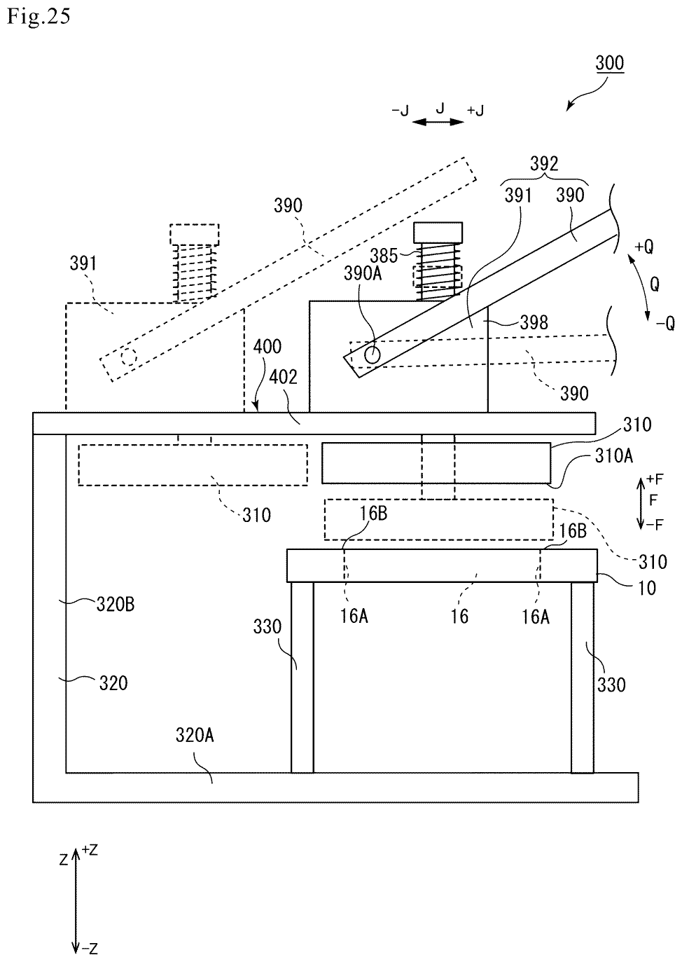

In the sealing device 300 illustrated in the example of FIG. 23, as illustrated in FIG. 25, the presser 310 can be displaced (moved) in the front-rear direction (the direction of arrow J) and the vertical direction (the direction of arrow F). FIG. 25 is a view for explaining the displacement of the presser 310 in the sealing device 300 illustrated in FIG. 23. In FIG. 25, a state where the vertical movement structure 392 has been moved in the +J direction (a state where the presser 310 is located immediately above the through hole 16) (front-side placement state) is indicated by a solid line, and a state where the vertical movement structure 392 has been moved in the −J direction (rear-side placement state) is indicated by a broken line. A state where the presser 310 has been moved in the +F direction is also indicated by a broken line.

As illustrated in FIG. 25, when the user grips the lever 390 and applies a force in the direction of arrow J, the slide member 401 is displaced in the direction of arrow J along the rail 402. Accordingly, the vertical movement structure 392 moves in the +J direction along the direction of arrow J from the position on the −J direction side. As the vertical movement structure 392 moves, the presser 310 also moves. At this time, the presser 310 is movable to a position immediately above the through hole 16 of the holding jig 10. This can be realized by adjusting the length and position of the rail 402 in the example of FIG. 23.

In the example of FIG. 25, in the front-rear direction movement structure 400, the presser 310 moves in the −F direction by rotating the lever 390 in the direction of arrow Q with the presser 310 reaching directly above the through hole 16. As a result, as described in the example of FIG. 11, the holding target M held in the through hole 16 can be pressed by the presser 310 (not illustrated in FIG. 25).

### Effects

According to the sealing device 300 in Modification 6 of the second embodiment, the presser 310 is configured to be movable in the front-rear direction, so that the presser 310 does not exist immediately above the through hole 16 in the rear-side placement state, thereby facilitating the setting of the holding target M such as the container 200 of the through hole 16. In particular, it is possible to reduce the necessity of providing a structure for increasing the distance between the presser 310 and the through hole 16 in the vertical direction in order to set the holding target M such as the container 200 of the through hole 16. Therefore, according to the sealing device 300 in Modification 6 of the second embodiment, the vertical size can be reduced.

Since the presser 310 is configured to be movable in the front-rear direction, it is possible to effectively reduce the possibility that the user's hand contacts the presser 310 when the user sets the holding target M such as the container 200 of the through hole 16 with the hand.

### Different Example 1 of Modification 6

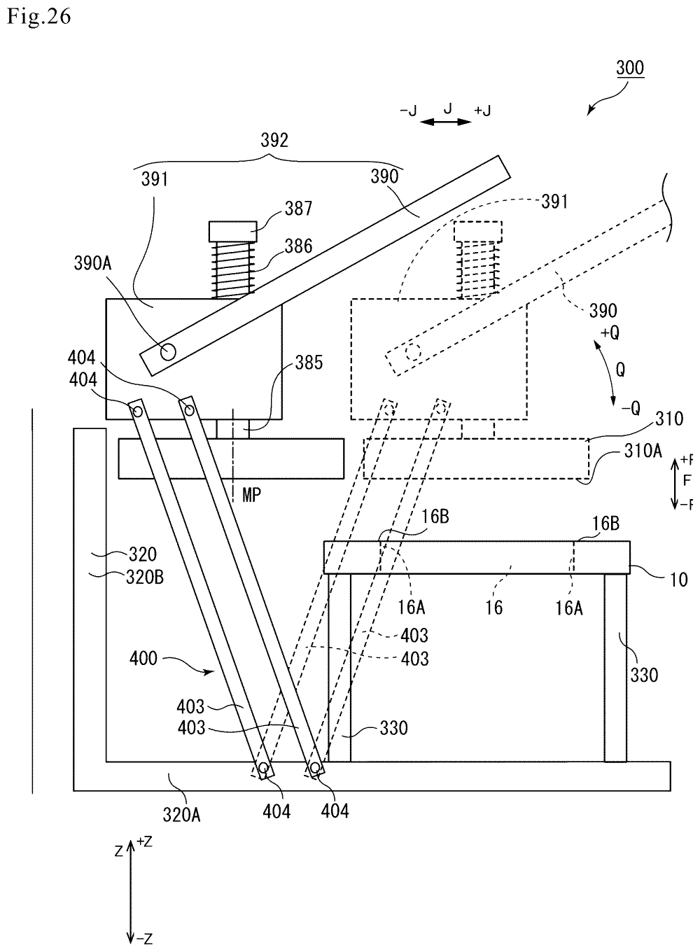

In the example illustrated in FIG. 23, the movement in the front-rear direction is the movement along the slide member and the rail, but this is an example, and the configuration of the front-rear direction movement structure 400 is not particularly limited as long as the movement in the front-rear direction can be realized. For example, the front-rear direction movement structure 400 may be configured as illustrated in FIG. 26. FIG. 26 is a view illustrating another one example (Different Example 1) of the sealing device according to Modification 6 of the second embodiment.

In the sealing device 300 illustrated in FIG. 26, the front-rear direction movement structure 400 is configured by a combination of a rotating column body 403 and a fixing member 404 that fixes the rotating column body in a rotatable state. The rotating column body 403 has a lower end fixed to the base portion 320A with the fixing member 404 and is configured to be rotatable about the fixing member 404 attached to the base portion 320A. The upper end of the rotating column body 403 is fixed to the side surface 398B of the housing 398, which serves as the exterior portion of the movement control structure 391, with the fixing member 404. The rotating column body 403 is configured to be rotatable about the fixing member 404 attached to the side surface 398B. In the example of FIG. 26, a plurality of rotating column bodies 403 are provided, and the rotating column bodies 403 are positioned to be simultaneously rotatable.

In the example of the sealing device 300 illustrated in FIG. 26, the vertical movement structure 392 is displaced in the direction of arrow J as the rotating column body 403 rotates. At this time, the vertical movement structure 392 may also be displaced in the direction of arrow F. In the example of FIG. 26, the vertical movement structure 392 is displaced in the direction of arrow +F to a predetermined position while being displaced in the direction of arrow J from the position on the −J direction side as a starting point toward the position on the +J direction side, and is further displaced in the direction of arrow +F as being displaced in the direction of arrow J toward the position on the +J direction side. The presser 310 also moves in accordance with the movement of the vertical movement structure 392. Then, in the front-rear direction movement structure 400, the presser 310 moves in the −F direction by rotating the lever 390 in the direction of arrow Q with the presser 310 reaching directly above the through hole 16.

### Different Example 2 of Modification 6

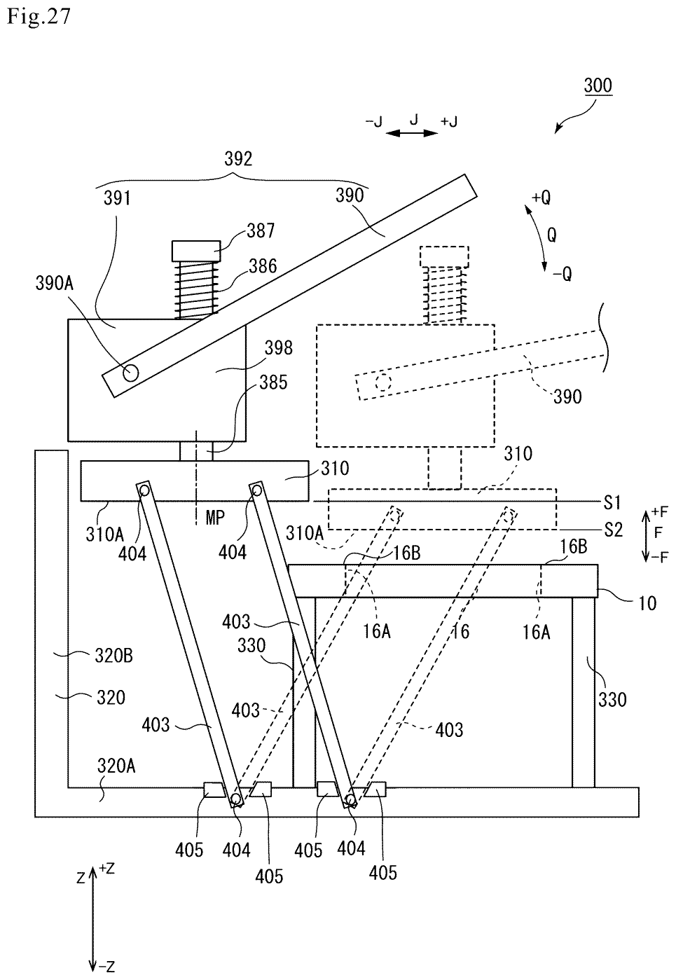

In the sealing device 300 according to Different Example 1 of Modification 6 of the second embodiment, as illustrated in FIG. 27, the front-rear direction movement structure 400 may be configured so that the pressing surface 310A of the presser 310 is located below the starting point position (position S1 in FIG. 27) with the presser 310 reaching just above the through hole 16 along with the movement of the vertical movement structure 392 and the presser 310 in the front-rear direction (the direction of arrow J). FIG. 27 is a view illustrating another one example (Different Example 2) of the sealing device according to Modification 6 of the second embodiment. Note that the starting point position indicates the position of the pressing surface 310A of the presser 310 in a state where the vertical movement structure 392 is disposed at the position on the −J direction side (referred to as a rear-side placement state). In the example of FIG. 27, a state where the presser 310 has reached directly above the through hole 16 is a state where the vertical movement structure 392 and the presser 310 have been moved in the +J direction by the front-rear direction movement structure 400, and this state is referred to as a front-side placement state. The position of the pressing surface 310A in the front-side placement state is illustrated using position S2 in FIG. 27.

The front-rear direction movement structure 400 as shown in the sealing device 300 of Different Example 2 can be configured to include a rotating column body 403 and a fixing member 404 as in Different Example 1. In the example of FIG. 27, a regulating member 405 that regulates the rotation range of the rotating column body 403 is provided.

In the example of the sealing device 300 illustrated in FIG. 27, the vertical movement structure 392 is displaced in the direction of arrow J as the rotating column body 403 rotates. At this time, the vertical movement structure 392 is also displaced in the −F direction. In the example of FIG. 26, as the placement state shifts from the rear-side placement state to the front-side placement state, the vertical movement structure 392 is displaced in the direction of arrow −F while moving in the direction of arrow J. Accordingly, the presser 310 can also be displaced in the direction of arrow −F while moving in the direction of arrow J. In the sealing device 300 according to Different Example 2, the front-rear direction movement structure 400 is configured to simultaneously realize the movement of the presser 310 in the front-rear direction and the movement in the vertical direction. In the front-rear direction movement structure 400, the presser 310 moves in the −F direction by rotating the lever 390 in the direction of arrow Q with the presser 310 reaching directly above the through hole 16.

When the vertical movement structure 392 is a combination structure of the gear 393 and the rack 394 as illustrated in FIG. 28A, the lever 390 is preferably applied with a downward force when the placement state shifts from the rear-side placement state to the front-side placement state. As a result, in the front-side placement state, the position of the presser 310 can be further lowered (brought close to the holding jig 10). In this case, in the front-rear direction movement structure 400, the pressing surface 310A of the presser 310 may be located in the vicinity of the upper surface of the holding jig 10 with the presser 310 reaching directly above the through hole 16.

Note that the front-rear direction movement structure 400 illustrated in Modification 6 is not limited to the case of being mounted on the sealing device 300 according to Modification 5. For example, the front-rear direction movement structure may be applied to the second embodiment described above with reference to FIG. 10 and the like, Modifications 1 to 4 of the second embodiment, and the like.

### (Elastic Member)

As illustrated in the example of FIGS. 23 to 27, in the vertical movement structure 392, as illustrated in the example of FIG. 23, a state where the lever has been moved in the +Q direction using an elastic member 386 such as a spring is preferably set to a non-pressing state. The non-pressing state indicates a state where the presser 310 is not pressing the holding target. As a result, when the user pushes down the lever 390 (displaces the lever in the −Q direction), the presser 310 moves downward (in the −F direction) in conjunction, and when the user releases the lever 390, the lever 390 is displaced in the +Q direction, and the presser 310 can easily move upward (in the +F direction) in conjunction with the displacement. In the example of FIG. 23, the upper end side of the support member 385 to which the presser 310 is joined extends above the upper surface 398A of the housing 398 of the vertical movement structure 392, and a stopper 387 is provided on the upper end side of the support member 385. The elastic member 386 is disposed between the stopper 387 and the housing 398. In FIG. 23, a coil spring is employed as the elastic member 386 and is disposed to surround the outer circumferential surface of the support member 385. In the example of FIG. 23, when the elastic member 386 is compressed by the user pushing down the lever 390, the presser 310 is displaced in the −F direction. When the user releases the lever 390, the restoring force of the elastic member 386 acts, and the presser 310 is displaced in the +F direction. However, what has been described here is an example and does not limit the placement, material, or the like of the elastic member 386.

### (Modification 7)

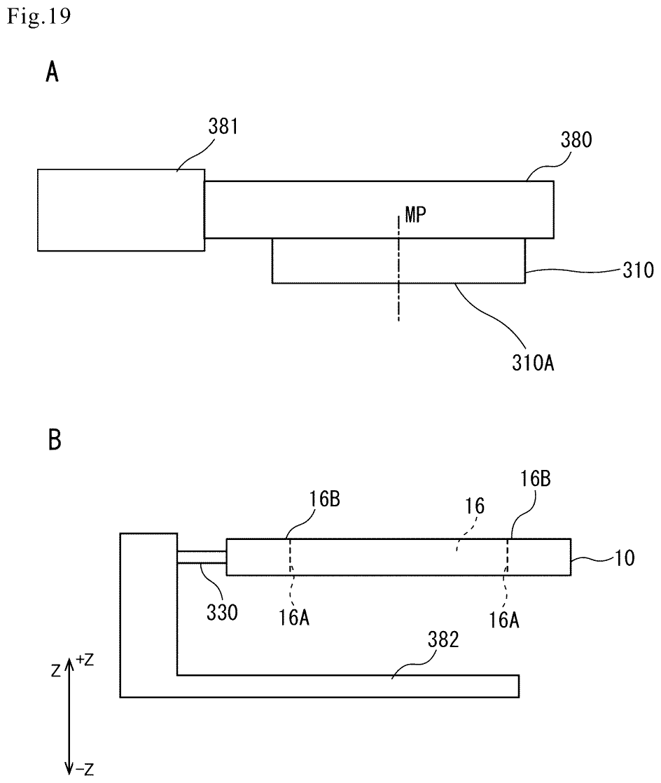

The sealing device 300 according to the second embodiment is not limited to the case where the presser 310 and the holding jig 10 are fixed to the support 320. As illustrated in FIGS. 19A and 19B, the sealing device 300 may be configured by a combination of a pressing device including the presser 310 and a holding device including a holding jig. The present embodiment is referred to as Modification 6 of the second embodiment. FIG. 19A is a view illustrating one example of the pressing device in the sealing device according to Modification 6 of the second embodiment. FIG. 19B is a view illustrating one example of the holding device in the sealing device according to Modification 6 of the second embodiment. In FIG. 19B, for convenience of description, the displacement element 14, the base plate 12, and the like are omitted.

### (Pressing Device)

In the example of FIG. 19A, the pressing device includes the presser 310, a support handle 380 to which the presser 310 is attached, and a grip 381 connected to the support handle 380.

### (Holding Device)

In the example of FIG. 19B, the holding device includes a holding jig 10, a fixing base 382, and a coupling member 330. The holding jig 10 is connected to the coupling member 330, and the coupling member 330 is fixed to the fixing base 382. As a result, the holding jig 10 is fixed to the fixing base 382.

### (Modification 8)

In the sealing device 300 according to the second embodiment, as illustrated in FIG. 18, a fluoroplastic sheet 395 may be provided between the pressing surface 310A of the presser 310 and the holding jig. The present embodiment is referred to as Modification 7 of the second embodiment. FIG. 18 is a view illustrating one example of the sealing device according to Modification 7 of the second embodiment.

### (Fluoroplastic Sheet)

The fluoroplastic sheet 395 is a sheet molded from a resin material containing a fluorine atom. Examples of the resin material containing a fluorine atom include polytetrafluoroethylene (PTFE), perfluoroalkoxy alkane (PFA), and the like.

The fluoroplastic sheet 374 is preferably disposed to cover the front surface of the pressing surface 310A of the presser 310. In this case, dust or the like hardly adheres to the pressing surface 310A of the presser 310. In addition, dust or the like hardly adheres to the fluoroplastic sheet 374, thereby reducing the possibility that dust moves to the holding target M. A gap 396 is preferably formed between the pressing surface 310A and the fluoroplastic sheet 395. In this case, when the heating mechanism is provided in the presser 310, even if dust adheres to the fluoroplastic sheet 395 by any chance, the possibility that dust burns, the dust combustion product adheres to the fluoroplastic sheet 395, and the dust combustion product transfers to the holding target M is also reduced.

### (Sheet Feeding Mechanism)

In the sealing device 300 according to Modification 7 of the second embodiment, as illustrated in the example of FIG. 18, a sheet feeding mechanism that feeds the fluoroplastic sheet 374 is preferably provided. In the example of FIG. 18, the sheet feeding mechanism includes a first roller 397A and a second roller 397B. An unused fluoroplastic sheet 374 is wound around the first roller, and the fluoroplastic sheet 374 is fed in the direction of arrow U as necessary. The second roller is a roller around which the used fluoroplastic sheet 374 is wound. Note that the unused fluoroplastic sheet 374 indicates a sheet that has not been placed on the front surface side of the pressing surface 310A of the presser 310. The used fluoroplastic sheet 374 indicates a sheet placed on the front surface side of the pressing surface 310A of the presser 310.

With the sheet feeding mechanism being provided, the fluoroplastic sheet 374 placed on the front surface side of the pressing surface 310A can be made into an unused fluoroplastic sheet 374 as necessary.

Note that FIG. 18 illustrates a case where the fluoroplastic sheet 395 is provided in the sealing device 300 illustrated in FIG. 10, but this is an example. For example, the fluoroplastic sheet 395 may be provided as illustrated in FIG. 18 for Modification 5 or Modification 6 of the second embodiment.

### (Modification 9)

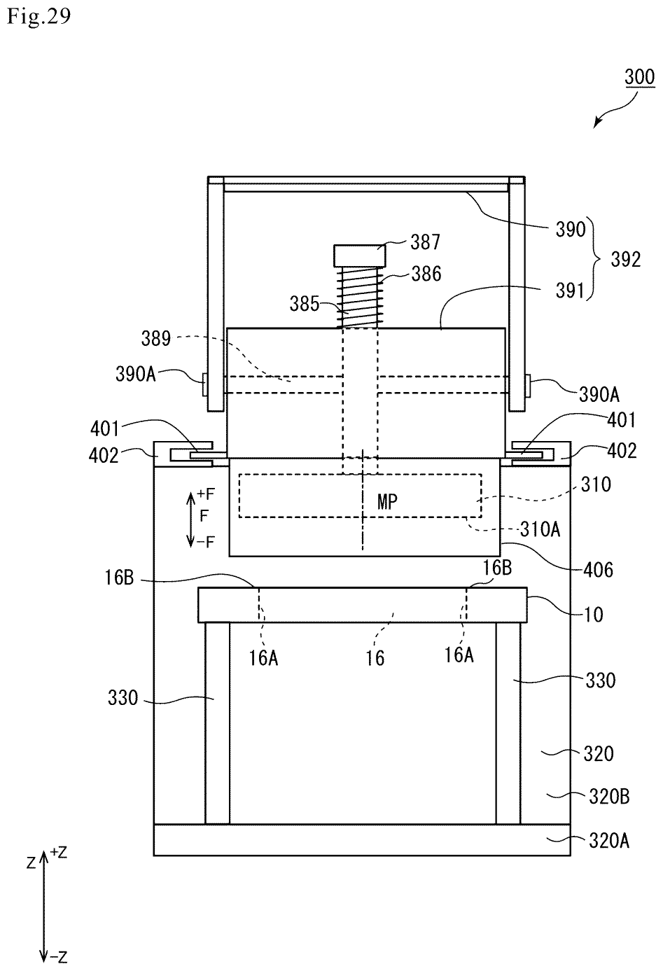

In the sealing device 300 according to the second embodiment, as illustrated in FIG. 29, a cover body 406 that covers the circumference of the presser 310 may be provided. The present embodiment is referred to as Modification 9 of the second embodiment. FIG. 29 is a front view illustrating one example of the sealing device according to Modification 9 of the second embodiment.

Note that FIG. 29 illustrates a case where the cover body 406 is provided as an example of the sealing device 300 according to Different Example 1 of Modification 6 of the second embodiment, but this is an example. The cover body 406 is provided to cover at least a portion of the presser 310 visible to the user when the cover body 406 is not provided. In the example of FIG. 30, the cover body 406 is disposed to hide at least the front side of the sealing device 300 in the presser 310. The material of the cover body 406 is not particularly limited but is preferably a material having rigidity such as metal.

### (Modification 10)

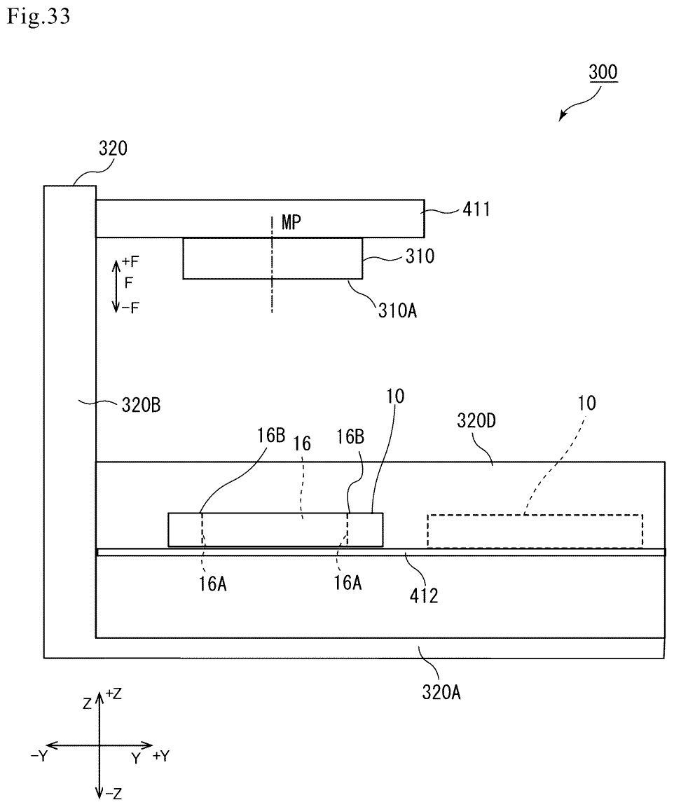

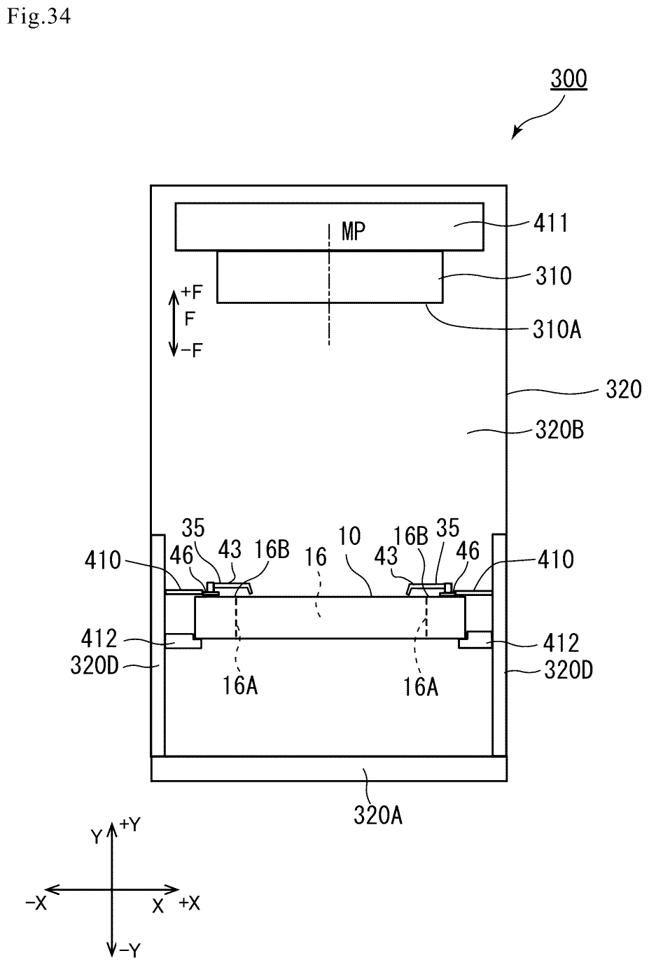

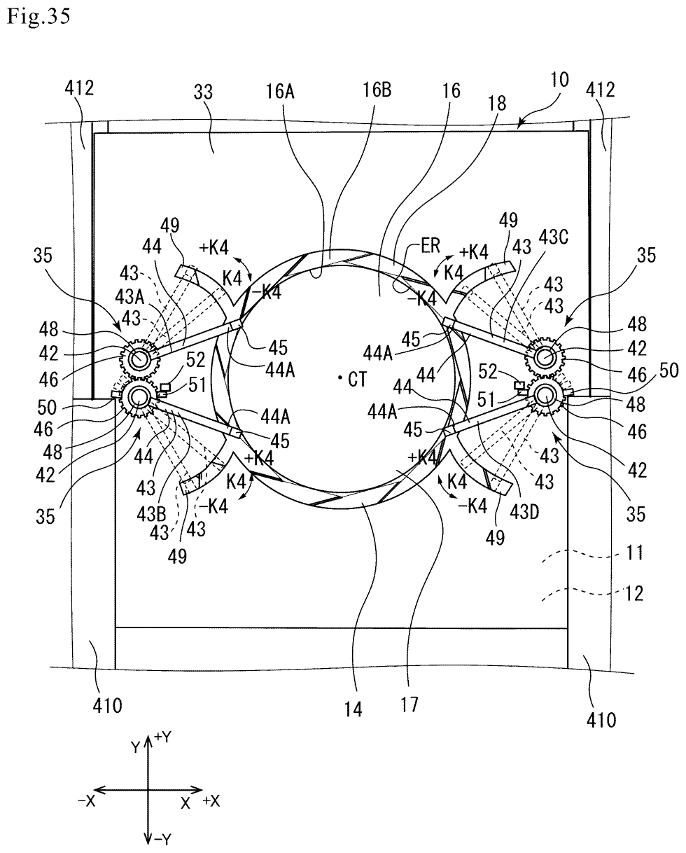

In the sealing device 300 according to the second embodiment, as illustrated in FIGS. 33 to 35, when the holding jig 10 has the positioning structure 35, and the positioning structure 35 has the structure illustrated in Another Example 3 of Modification 8 of the first embodiment, and further has the first extension 50 (a case where the positioning structure 35 has the structure exemplified in FIGS. 32A, 32B, and the like), the sealing device may have a protruding member 410 that contacts the first extension 50 of the positioning structure 35. FIGS. 33 to 35 are views for explaining one example of the sealing device 300 when the positioning structure 35 has the structure illustrated in Another Example 3 of Modification 8 in the first embodiment (the structures illustrated in FIGS. 32A and 32B). FIG. 33 is a side view for schematically illustrating a state where the sealing device 300 according to Modification 10 of the second embodiment is viewed from the side surface. However, in FIG. 33, the descriptions of a side wall portion 320D on the +X direction side and the positioning structure 35 are omitted for convenience of description. In FIG. 33, the holding jig 10 is indicated by a solid line in a state where the holding jig 10 has been moved to the rear position, and the holding jig 10 is indicated by a broken line in a state where the holding jig 10 has been moved to the front position. FIG. 34 is a front view schematically illustrating a state where the sealing device 300 according to Modification 10 of the second embodiment is viewed from the side surface. FIG. 35 is a partial plan view schematically illustrating a state where the holding jig 10 moves along the guide rail 412 when the direction from the upper side to the lower side of the sealing device 300 according to Modification 10 of the second embodiment is a line-of-sight direction.

In the sealing device 300 illustrated in the example of FIGS. 33 to 35, the presser 310 is configured to be movable in the vertical direction (the direction of arrow F) as described in Modification 1 of the second embodiment. The sealing device 300 includes the support 320. The support 320 illustrated in FIG. 30 includes the base portion 320A and the standing wall portion 320B rising upward from the base portion 320A. Note that reference numeral 411 in FIGS. 33 and 34 denotes a support member that supports presser 310. The sealing device 300 is provided with, for example, a vertical movement mechanism (not illustrated) as described in Modification 1 of the second embodiment, and the support member 411 is connected to the vertical movement structure, whereby the vertical movement of the presser 310 can be realized.

In the example of FIG. 31, two side wall portions 320D, 320D are provided forward (+Y direction) from the standing wall portion 320B, and the side wall portions 320D, 320D face each other. A guide rail 412 is provided on the inner surface side) of the side wall portion 320D (the surface sides facing each other among the surfaces of the side wall portions 320D, 320D. The guide rail 412 extends in the front-rear direction. In the example of FIG. 31, the holding jig 10 is disposed on the guide rail 412. The holding jig 10 is configured to be movable in the front-rear direction (the Y direction in the example of FIGS. 33 and 35) along the extending direction of the guide rail 412. The side wall portion 320D is provided with a protruding member 410 on the upper side of the guide rail 412. The vertical position of the protruding member 410 is set to a position slightly above the upper surface of the holding jig 10. The protruding length of the protruding member 410 (a distance extending inward from the side wall portion 310D (a length along the X-axis direction in FIG. 34)) is a length with which the protruding member 410 can contact the first extension 50 provided on the gear 46 of the positioning structure 35. As illustrated in FIG. 35, when the holding jig 10 moves from the front position to the rear position (when the holding jig 10 moves from the +Y direction side to the −Y direction side), the position of the protruding member 410 in the front-rear direction is such a position that the protruding member 410 and the first extension 50 contact each other.

With the protruding member 410 being provided in this manner, as illustrated in FIG. 35, when the holding jig 10 is pulled out in the forward direction, the contact between the protruding member 410 and the first extension 50 is released, and the tip portion 44A (and the pin 45) of the arm 44 of the rotating member 43 can rotate in the direction approaching the center CT. That is, in the example of FIG. 35, the rotating members 43B, 43D can rotate in the +K4 direction, and the rotating members 43A, 43C can rotate in the −K4 direction. Then, when the first holding target and the second holding target are set on the holding jig 10, and the holding jig 10 is moved in the backward direction, the protruding member 410 and the first extension 50 contact each other, and the tip portion 44A (and the pin 45) of the arm 44 of the rotating member 43 rotates in a direction away from the center CT. That is, in the example of FIG. 35, the rotating members 43B, 43D rotate in the −K4 direction, and the rotating members 43A, 43C rotate in the +K4 direction. At this time, even when the second holding target is placed at a position slightly floating relative to the first holding target at the time of setting the first holding target and the second holding target on the holding jig 10, a state where the second holding target is in contact with the first holding target can be formed more reliably. When the presser 310 moves downward with the holding jig 10 moved in the backward direction, it is also possible to reduce the contact of the rotating member 43 with the presser 310.

In the sealing device 300 illustrated in the example of FIGS. 33 to 35, the movement of the presser 310 in the front-rear direction is regulated, and the holding jig 10 moves in the front-rear direction, but this is an example. In the sealing device 300 of the Modification 10 of the second embodiment, as long as the first extension 50 and the protruding member 410 are provided, both the presser 310 and the holding jig 10 may be movable in the front-rear direction, or the presser 310 may be configured to be movable in the front-rear direction, and the movement of the holding jig 10 in the front-rear direction may be regulated. In Modification 10 according to the second embodiment, when the presser 310 moves in the front-rear direction, the protruding member 410 is preferably configured to move with the movement of the presser 310. This can be realized, for example, by the protruding member 410 being provided to droop from the circumferential surface of the presser 310. With such a configuration, when the protruding member 410 moves with the movement of the presser 310 and contacts the first extension 50 of the holding jig 10, the tip portion 44A (and the pin 45) of the arm 44 of the rotating member 43 rotates in the direction away from the center CT as described above.

Next, a third embodiment will be described. A third embodiment is a method for manufacturing a container with a lid using the holding jig 10 described in the first embodiment.

### 3. Third Embodiment

The method for manufacturing a container with a lid using the holding jig 10 has the following sealing method.

### (Sealing Method)

In the method for manufacturing a container with a lid, the container 200 is set in the sealing device 300 (the sealing device 300 provided with the holding jig 10) described in the second embodiment. Before or at the same time as the sealing step is applied, a lid is interposed between the presser and the holding jig on the upper side of the container.

### (Sealing Step)

In the sealing step, the lid is joined to the container at the position of the flange of the container with the container and the lid interposed between the presser and the holding jig. This can be realized by the sealing device 300 performing the sealing function as described above.

Although the holding jig, the sealing device, and the sealing method according to the present invention have been described in detail above, the above description merely exemplifies the holding jig, the sealing device, and the sealing method according to the present invention, and the present invention is not limited thereto. Therefore, the present invention includes those appropriately modified without departing from the gist of the present invention. The various aspects described above can be applied and used separately, and the configurations in the respective aspects can be appropriately combined and used.

The present invention includes the following technical ideas.

(A1) A holding jig including a holder having a through hole formed in a vertical direction, through which a holding target is to be inserted, the holder being formed to bring the holding target into contact with an upper end edge portion of the through hole, wherein the holder includes a plurality of displacement elements forming at least a part of the through hole, in at least some of the displacement elements, an exposed region of each of the displacement elements exposed on a circumferential surface portion of the through hole varies as the displacement element is displaced in a displacement direction defined for the displacement element, and when the displacement element moves to make the exposed region larger, stress is applied to the displacement element for positioning the displacement element at a position to at which the exposed region is smaller.

(A2) The holding jig according to (A1) above, in which the displacement elements being adjacent to each other slide against each other along the displacement direction defined for each of the displacement elements.

(A3) The holding jig according to (A1) or (A2) above, in which the plurality of displacement elements form the through hole.

(A4) The holding jig according to any one of (A1) to (A3), in which the plurality of displacement elements are arranged in an annular shape.

(A5) The holding jig according to any one of (A1) to (A4), in which the holder includes a regulating structure that regulates the displacement direction of each of at least some of the displacement elements, the regulating structure includes a guide that is provided corresponding to each of the displacement elements for guiding the displacement elements in a predetermined direction, and the displacement direction of the displacement element is a direction along the guide corresponding to the displacement element.

(A6) The holding jig according to (A5) above, in which when one of the displacement elements adjacent to each other moves along the guide corresponding to the one of the displacement elements, a pressing force is applied to the other of the displacement elements, and the other of the displacement elements moves along the guide corresponding to the other of the displacement elements based on the pressing force.

(A7) The holding jig according to any one of (A1) to (A6), in which the holder includes a regulating wall portion that regulates a displacement distance of at least one of the displacement elements, and the regulating wall portion contacts the displacement element when the displacement element is displaced to a predetermined position.

(A8) The holding jig according to (A7) above, in which the holder has a first groove portion in the regulating wall portion, a second groove portion is formed at a position corresponding to the first groove portion in the displacement element in contact with the regulating wall portion, and the holing jig is provided with a regulating rod that is common to the first groove portion and the second groove portion and is embedded in the first groove portion and the second groove portion.

(A9) The holding jig according to any one of (A1) to (A8), in which the displacement elements adjacent to each other are in contact with each other on side surfaces of the displacement elements.

(A10) The holding jig according to any one of (A1) to (A9), in which the displacement elements adjacent to each other are prevented from overlapping each other in the vertical direction.

(A11) The holding jig according to any one of (A1) to (A10), in which positions of upper surfaces of the displacement elements adjacent to each other are aligned at the upper end edge portion of the through hole.

(A12) The holding jig according to any one of (A1) to (A11), further including a base plate, in which the displacement elements are disposed on a plate upper surface of the base plate, and the displacement elements move and rub on the plate upper surface of the base plate.

(A13) The holding jig according to any one of (A1) to (A12), in which an extension extending along the circumferential surface portion of the through hole is formed on a lower surface of the displacement element.

(A14) The holding jig according to any one of (A1) to (A13), in which at least a portion of the displacement element corresponding to the exposed region forms an inclined surface that is inclined downward toward an inside of the through hole as it goes downward from the upper end edge portion of the through hole.

(A15) The holding jig according to any one of (A1) to (A14), further including a protective plate, in which the protective plate covers at least a part of the displacement element.

(A16) The holding jig according to (A15) above, in which a fixing member for fixing a position of the protective plate is removably attached to the protective plate, and the protective plate is configured to be displaceable in a planar direction normal to a thickness direction of the protective plate when the fixing member is removed.

(A17) The holding jig according to any one of (A1) to (A16), in which the holding target includes a first holding target to be in contact with the through hole and a second holding target mounted on the first holding target, and wherein a plane direction of a plane normal to the vertical direction is a planar direction, a positioning structure that defines at least a position of the second holding target in the planar direction relative to the first holding target is provided on an upper surface side of the holder.

(A18) The holding jig according to (A17) above, in which the positioning structure includes a plurality of pins erected on the upper surface side of the holder, and the plurality of pins define the position of the second holding target in the planar direction, and each of the pins is configured to be displaceable in the vertical direction.

(A19) The holding jig according to any one of (A1) to (A18), in which the holding target includes at least a container having a body and a flange extending outward from an upper end of the body, and the flange is configured to contact the upper end edge portion of the through hole.

(A20) The holding jig according to any one of (A1) to (A19), in which the holder includes an elastic member that biases at least one of the displacement elements, and in a state where the displacement element has moved to make the exposed region larger, the elastic member applies stress to the displacement element for positioning the displacement element at a position at which the exposed region is smaller.

(A21) The holding jig according to any one of (A1) to (A20), further including an outer peripheral portion, in which a covering material with cushioning properties is provided to surround the outer peripheral portion.

(A22) The holding jig according to any one of (A1) to (A21), in which a displacement guide structure that regulates the displacement direction of the displacement element is provided on a lower surface side of the displacement element.

(A23) The holding jig according to any one of (A1) to (A22), in which a groove is formed on an upper surface of the displacement element.

(A24) The holding jig according to (A23) above, in which the groove on the upper surface of the displacement element extends along the displacement direction of the displacement element.

(A25) The holding jig according to any one of (A1) to (A24), in which a groove is formed in at least one of side surfaces of the displacement element excluding a surface that forms the through hole.

(A26) The holding jig according to any one of (A1) to (A25), in which a step is formed on an upper surface of the displacement element.

(A27) A sealing device including: the holding jig according to any one of (A1) to (A26) above; and a presser for applying a pressing force to the holding target from an upper side of the holding target, wherein in a case where the pressing force is applied to the holding target while the holding target is placed on the holding jig, at least one of the presser and the holding jig moves from an initial position where the presser and the holding jig are separated by a predetermined distance to a position where the holding target is pressed, the presser exists above the holding target, and the pressing force is applied to the holding target from an upper side of the holding target.

(A28) The sealing device according to (A27) above, in which the holding jig moves toward the presser.

(A29) The sealing device according to (A27) or (A28) above, in which the presser moves toward the holding jig.

(A30) The sealing device according to any one of (A27) to (A29) above, in which the presser has a pressing surface, and the pressing surface is an uneven surface.

(A31) The sealing device according to any one of (A27) to (A30) above, further including a heating mechanism capable of heating the presser.

(A32) The sealing device according to any one of (A27) to (A31) above, in which a fluoroplastic sheet is provided between the presser and the holding jig.

(A33) The sealing device according to any one of (A27) to (A32) above, in which the holding target includes at least a container having a body with an opening formed on an upper side and a flange extending outward at an upper end of the body.

(A34) The sealing device according to (A33) above, which joins a lid to the container at a position of the flange of the container in a state where the lid is disposed on the container to cover the opening on the upper side of the body and the flange and the container and the lid are interposed between the presser and the holding jig.

(A35) A sealing method using the sealing device according to (A33) above, the sealing method including joining a lid to the container at a position of the flange of the container in a state where the container and the lid are interposed between the presser and the holding jig.

The present invention may also be interpreted to include the following technical ideas.

(B1) A holding jig including a holder having a through hole formed in a vertical direction, through which a holding target is to be inserted, the holder being formed to bring the holding target into contact with an upper end edge portion of the through hole, wherein the holder includes a plurality of displacement elements forming at least a part of the through hole and an elastic member that biases at least one of the displacement elements, in at least some of the displacement elements, an exposed region of each of the displacement elements exposed on a circumferential surface portion of the through hole varies as the displacement element is displaced in a displacement direction defined for the displacement element, and the elastic member biases the displacement element for positioning the displacement element at a position at which the exposed region is smaller.

(B2) The holding jig according to (B1) above, in which the displacement elements being adjacent to each other slide against each other along the displacement direction defined for each of the displacement elements.

(B3) The holding jig according to (B1) or (B2) above, in which the plurality of displacement elements form the through hole.

(B4) The holding jig according to any one of (B1) to (B3), in which the plurality of displacement elements are arranged in an annular shape.

(B5) The holding jig according to any one of (B1) to (B4), in which the holder includes a regulating structure that regulates the displacement direction of each of at least some of the displacement elements, the regulating structure includes a guide that is provided corresponding to each of the displacement elements for guiding the displacement elements in a predetermined direction, and the displacement direction of the displacement element is a direction along the guide corresponding to the displacement element.

(B6) The holding jig according to (B5) above, in which when one of the displacement elements adjacent to each other moves along the guide corresponding to the one of the displacement elements, a pressing force is applied to the other of the displacement elements, and the other of the displacement elements moves along the guide corresponding to the other of the displacement elements based on the pressing force.

(B7) The holding jig according to any one of (B1) to (B6), in which the holder includes a regulating wall portion that regulates a displacement distance of at least one of the displacement elements, and the regulating wall portion contacts the displacement element when the displacement element is displaced to a predetermined position.

(B8) The holding jig according to (B7) above, in which the holder has a first groove portion in the regulating wall portion, a second groove portion is formed at a position corresponding to the first groove portion in the displacement element in contact with the regulating wall portion, and the holing jig is provided with a regulating rod that is common to the first groove portion and the second groove portion and is embedded in the first groove portion and the second groove portion.

(B9) The holding jig according to any one of (B1) to (B8), in which the displacement elements adjacent to each other are in contact with each other on side surfaces of the displacement elements.

(B10) The holding jig according to any one of (B1) to (B9), in which the displacement elements adjacent to each other are prevented from overlapping each other in the vertical direction.

(B11) The holding jig according to any one of (B1) to (B10), in which positions of upper surfaces of the displacement elements adjacent to each other are aligned at the upper end edge portion of the through hole.

(B12) The holding jig according to any one of (B1) to (B11), further including a base plate, in which the displacement elements are disposed on a plate upper surface of the base plate, and the displacement elements move and rub on the plate upper surface of the base plate.

(B13) The holding jig according to any one of (B1) to (B12), in which an extension extending along the circumferential surface portion of the through hole is formed on a lower surface of the displacement element.

(B14) The holding jig according to any one of (B1) to (B13), in which at least a portion of the displacement element corresponding to the exposed region forms an inclined surface that is inclined downward toward an inside of the through hole as it goes downward from the upper end edge portion of the through hole.

(B15) The holding jig according to any one of (B1) to (B14), further including a protective plate, in which the protective plate covers at least a part of the displacement element.

(B16) The holding jig according to (B15) above, in which a fixing member for fixing a position of the protective plate is removably attached to the protective plate, and the protective plate is configured to be displaceable in a planar direction normal to a thickness direction of the protective plate when the fixing member is removed.

(B17) The holding jig according to any one of (B1) to (B16), in which the holding target includes a first holding target to be in contact with the through hole and a second holding target mounted on the first holding target, and wherein a plane direction of a plane normal to the vertical direction is a planar direction, a positioning structure that defines at least a position of the second holding target in the planar direction relative to the first holding target is provided on an upper surface side of the holder.

(B18) The holding jig according to (B17) above, in which the positioning structure includes a plurality of pins erected on the upper surface side of the holder, and the plurality of pins define the position of the second holding target in the planar direction, and each of the pins is configured to be displaceable in the vertical direction.

(B19) The holding jig according to any one of (B1) to (B18), in which the holding target includes at least a container having a body and a flange extending outward from an upper end of the body, and the flange is configured to contact the upper end edge portion of the through hole.

(B20) The holding jig according to any one of (B1) to (B19), in which the holder includes an elastic member that biases at least one of the displacement elements, and in a state where the displacement element has moved to make the exposed region larger, the elastic member applies stress to the displacement element for positioning the displacement element at a position at which the exposed region is smaller.

(B21) The holding jig according to any one of (B1) to (B20), further including an outer peripheral portion, in which a covering material with cushioning properties is provided to surround the outer peripheral portion.

(B22) The holding jig according to any one of (B1) to (B21), in which a displacement guide structure that regulates the displacement direction of the displacement element is provided on a lower surface side of the displacement element.

(B23) The holding jig according to any one of (B1) to (B22), in which a groove is formed on an upper surface of the displacement element.

(B24) The holding jig according to (B23) above, in which the groove on the upper surface of the displacement element extends along the displacement direction of the displacement element.

(B25) The holding jig according to any one of (B1) to (B24), in which a groove is formed in at least one of side surfaces of the displacement element excluding a surface that forms the through hole.

(B26) The holding jig according to any one of (B1) to (B25), in which a step is formed on an upper surface of the displacement element.

(B27) A sealing device including: the holding jig according to any one of (B1) to (B26) above; and a presser for applying a pressing force to the holding target from an upper side of the holding target, whereinin a case where the pressing force is applied to the holding target while the holding target is placed on the holding jig, at least one of the presser and the holding jig moves from an initial position where the presser and the holding jig are separated by a predetermined distance to a position where the holding target is pressed, the presser exists above the holding target, and the pressing force is applied to the holding target from an upper side of the holding target.

(B28) The sealing device according to (B27) above, in which the holding jig moves toward the presser.

(B29) The sealing device according to (B27) or (B28) above, in which the presser moves toward the holding jig.

(B30) The sealing device according to any one of (B27) to (B29) above, in which the presser has a pressing surface, and the pressing surface is an uneven surface.

(B31) The sealing device according to any one of (B27) to (B30) above, further including a heating mechanism capable of heating the presser.

(B32) The sealing device according to any one of (B27) to (B31) above, in which a fluoroplastic sheet is provided between the presser and the holding jig.

(B33) The sealing device according to any one of (B27) to (B32) above, in which the holding target includes at least a container having a body with an opening formed on an upper side and a flange extending outward at an upper end of the body.

(B34) The sealing device according to (B33) above, which joins a lid to the container at a position of the flange of the container in a state where the lid disposed on the container to cover the opening on the upper side of the body and the flange and the container and the lid are interposed between the presser and the holding jig.

(B35) A sealing method using the sealing device according to (B33) above, the sealing method including joining a lid to the container at a position of the flange of the container in a state where the container and the lid are interposed between the presser and the holding jig.

Furthermore, the present invention can be interpreted to include the following technical idea.

(C1) A holding jig including a holder having a through hole formed in a vertical direction, through which a holding target is to be inserted, the holder being formed to bring the holding target into contact with an upper end edge portion of the through hole, wherein the holder includes a plurality of displacement elements forming at least a part of the through hole and the plurality of displacement elements are arranged in an annular shape, in at least some of the displacement elements, an exposed region of each of the displacement elements exposed on a circumferential surface portion of the through hole varies as the displacement element is displaced in a displacement direction defined for the displacement element in accordance with a size of the holding target and the through hole is configured to be expandable by the holding target.

(C2) The holding jig according to (C1) above, in which the displacement elements being adjacent to each other slide against each other along the displacement direction defined for each of the displacement elements.

(C3) The holding jig according to (C1) or (C2) above, in which the plurality of displacement elements form the through hole.

(C4) The holding jig according to any one of (C1) to (C3), in which the holder includes a regulating structure that regulates the displacement direction of each of at least some of the displacement elements, the regulating structure includes a guide that is provided corresponding to each of the displacement elements and for guiding the displacement elements in a predetermined direction, and the displacement direction of the displacement element is a direction along the guide corresponding to the displacement element.

(C5) The holding jig according to (C4) above, in which when one of the displacement elements adjacent to each other moves along the guide corresponding to the one of the displacement elements, a pressing force is applied to the other of the displacement elements, and the other of the displacement elements moves along the guide corresponding to the other of the displacement elements based on the pressing force.

(C6) The holding jig according to any one of (C1) to (C5), in which the holder includes a regulating wall portion that regulates a displacement distance of at least one of the displacement elements, and the regulating wall portion contacts the displacement element when the displacement element is displaced to a predetermined position.

(C7) The holding jig according to (C6) above, in which the holder has a first groove portion in the regulating wall portion, a second groove portion is formed at a position corresponding to the first groove portion in the displacement element in contact with the regulating wall portion, and the holing jig is provided with a regulating rod that is common to the first groove portion and the second groove portion and is embedded in the first groove portion and the second groove portion.

(C8) The holding jig according to any one of (C1) to (C7), in which the displacement elements adjacent to each other are in contact with each other on side surfaces of the displacement elements.

(C9) The holding jig according to any one of (C1) to (C8), in which the displacement elements adjacent to each other are prevented from overlapping each other in the vertical direction.

(C10) The holding jig according to any one of (C1) to (C9), in which positions of upper surfaces of the displacement elements adjacent to each other are aligned at the upper end edge portion of the through hole.

(C11) The holding jig according to any one of (C1) to (C10), further including a base plate, in which the displacement elements are disposed on a plate upper surface of the base plate, and the displacement elements move and rub on the plate upper surface of the base plate.

(C12) The holding jig according to any one of (C1) to (C11), in which an extension extending along the circumferential surface portion of the through hole is formed on a lower surface of the displacement element.

(C13) The holding jig according to any one of (C1) to (C12), in which at least a portion of the displacement element corresponding to the exposed region forms an inclined surface that is inclined downward toward an inside of the through hole as it goes downward from the upper end edge portion of the through hole.

(C14) The holding jig according to any one of (C1) to (C13), further including a protective plate, in which the protective plate covers at least a part of the displacement element.

(C15) The holding jig according to (C14) above, in which a fixing member for fixing a position of the protective plate is removably attached to the protective plate, and the protective plate is configured to be displaceable in a planar direction normal to a thickness direction of the protective plate when the fixing member is removed.

(C16) The holding jig according to any one of (C1) to (C15), in which the holding target includes a first holding target to be in contact with the through hole and a second holding target mounted on the first holding target, and wherein a plane direction of a plane normal to the vertical direction is a planar direction, a positioning structure that defines at least a position of the second holding target in the planar direction relative to the first holding target is provided on an upper surface side of the holder.

(C17) The holding jig according to (C16) above, in which the positioning structure includes a plurality of pins erected on the upper surface side of the holder, and the plurality of pins define the position of the second holding target in the planar direction, and each of the pins is configured to be displaceable in the vertical direction.

(C18) The holding jig according to any one of (C1) to (C17), in which the holding target includes at least a container having a body and a flange extending outward from an upper end of the body, and the flange is configured to contact the upper end edge portion of the through hole.

(C19) The holding jig according to any one of (C1) to (C18), in which the holder includes an elastic member that biases at least one of the displacement elements, and in a state where the displacement element has moved to make the exposed region larger, the elastic member applies stress to the displacement element for positioning the displacement element at a position at which the exposed region is smaller.

(C20) The holding jig according to any one of (C1) to (C19), further including an outer peripheral portion, in which a covering material with cushioning properties is provided to surround the outer peripheral portion.

(C21) The holding jig according to any one of (C1) to (C20), in which a displacement guide structure that regulates the displacement direction of the displacement element is provided on a lower surface side of the displacement element.

(C22) The holding jig according to any one of (C1) to (C21), in which a groove is formed on an upper surface of the displacement element.

(C23) The holding jig according to (C22) above, in which the groove on the upper surface of the displacement element extends along the displacement direction of the displacement element.

(C24) The holding jig according to any one of (C1) to (C23), in which a groove is formed in at least one of side surfaces of the displacement element excluding a surface that forms the through hole.

(C25) The holding jig according to any one of (C1) to (C24), in which a step is formed on an upper surface of the displacement element.

(C26) A sealing device including: the holding jig according to any one of (C1) to (C25) above; and a presser for applying a pressing force to the holding target from an upper side of the holding target, wherein in a case where the pressing force is applied to the holding target while the holding target is placed on the holding jig, at least one of the presser and the holding jig moves from an initial position where the presser and the holding jig are separated by a predetermined distance to a position where the holding target is pressed, the presser exists above the holding target, and the pressing force is applied to the holding target from an upper side of the holding target.

(C27) The sealing device according to (C26) above, in which the holding jig moves toward the presser.

(C28) The sealing device according to (C26) or (C27) above, in which the presser moves toward the holding jig.

(C29) The sealing device according to any one of (C26) to (C28) above, in which the presser has a pressing surface, and the pressing surface is an uneven surface.

(C30) The sealing device according to any one of (C26) to (C29) above, further including a heating mechanism capable of heating the presser.

(C31) The sealing device according to any one of (C26) to (C30) above, in which a fluoroplastic sheet is provided between the presser and the holding jig.

(C32) The sealing device according to any one of (C26) to (C31) above, in which the holding target includes at least a container having a body with an opening formed on an upper side and a flange extending outward at an upper end of the body.

(C33) The sealing device according to (C32) above, which joins a lid to the container at a position of the flange of the container in a state where the lid disposed on the container to cover the opening on the upper side of the body and the flange and the container and the lid are interposed between the presser and the holding jig.

(C34) A sealing method using the sealing device according to (C32) above, the sealing method including joining a lid to the container at a position of the flange of the container in a state where the container and the lid are interposed between the presser and the holding jig.

### REFERENCE SIGNS LIST

10 holding jig
10A outer peripheral portion
11 holder
11A outer circumferential surface
11B upper surface
12 base plate
12A upper surface
12B lower surface
13 receiving material
13A outer circumferential surface
13B inner circumferential surface
13C upper surface
14 displacement element
14A side surface
14A1 first side surface
14A2 second side surface
14B upper surface
14C lower surface
14TRP displacement element
15 annular structural body
15A outer circumferential surface
16 through hole
16A circumferential surface portion
16B upper end edge portion
17 auxiliary hole
17A edge portion
18 auxiliary hole
18B upper edge portion
19 regulating structure
20 guide
21 regulating wall portion
21A wall surface
22 elastic member
23 guide wall portion
24 wall portion
25 curved wall surface portion
26 hole portion
27 first groove portion
27A groove bottom
28 second groove portion
28A groove bottom
29 regulating rod
30 inclined surface
31 protrusion
32 extension
33 protective plate
33A upper surface
33B lower surface
33C inner surface
34 projecting piece
35 positioning structure
36 slide member
36A lower end portion
36B inner end surface portion
36C upper end portion
37 rail
38 fixing member
38A first fixing member
38B second fixing member
39 elastic member
40 biasing structure
41 drooping portion
42 support shaft
42A tip
43 rotating member
43A rotating member
43B rotating member
43C rotating member
43D rotating member
44 arm
44A tip portion
45 pin
45A tip
46 gear
47 head
48 bearing
48A hole portion
49 escape
50 first extension
51 second extension
52 rotation regulating member
53 wall portion
55 pin
55A upper end
55B lower end
56 elastic member
57 in-out port
58 attachment hole
59 fixing member
60 receiving member
61 space
62 opening
63 pin biasing structure
64 bottom surface
65 flange
66 eaves portion
67 upper movement regulating structure
68 first in-out through hole
69 second in-out through hole
70 eaves portion
72 elastic member
73 hooking member
73A head
73B body portion
74A annular portion
74B annular portion
75 hooking member
77 step
78 lower portion
79 upper portion
80 boss
80A upper surface
81 boss hole
82 fixing member
83 hole portion
85 displacement guide structure
86 long hole portion
87 leg
88 leg member
88A flange
88B body portion
89 ring member
90 covering material
92 groove
93 first groove
94 second groove
95 convex mountainous portion
140 base
141 vertex
200 container
210 body
210A outer circumferential surface
220 bottom
230 space
240 flange
250 upper edge portion
260 opening
290 lid
300 sealing device
310 presser
310A pressing surface
310D side wall portion
311 thick portion
320 support
320A base portion
320B standing wall portion
320C upper surface portion
320D side wall portion
330 coupling member
350 outer circumferential end
360 convex portion
361 concave portion
370 suction cup
370A suction surface
371 long hole
372 valve
374 fluoroplastic sheet
380 support pattern
381 grip
382 fixing base
385 support member
386 elastic member
387 stopper
388 coupling member
389 support shaft
390 lever
390A fulcrum
391 movement control structure
392 vertical movement structure
393 gear
394 rack
395 fluoroplastic sheet
396 gap
397A first roller
397B second roller
398 housing
398A upper surface
398B side surface
400 direction movement structure
401 slide member
402 rail
403 rotating column body
404 fixing member
405 regulating member
406 cover body
410 protruding member
411 support member
412 guide rail
AR1 region
AR2 region
BCT center
CR covering region
CT center
ER exposed region
F arrow
FD arrow
FH arrow
J arrow
K1 arrow
K2 arrow
K3 arrow
K4 rotation direction
M holding target
MP center
P arrow
Q arrow
SL arrow
T displacement direction
U arrow
α Inclination angle

1. A holding jig comprising
a holder having a through hole formed in a vertical direction, through which a holding target is to be inserted, the holder being formed to bring the holding target into contact with an upper end edge portion of the through hole, wherein
the holder includes a plurality of displacement elements forming at least a part of the through hole,
in at least some of the displacement elements, an exposed region of each of the displacement elements exposed on a circumferential surface portion of the through hole varies as the displacement element is displaced in a displacement direction defined for the displacement element, and
when the displacement element moves to make the exposed region larger, stress is applied to the displacement element for positioning the displacement element at a position at which the exposed region is smaller.

2. The holding jig according to claim 1, wherein
the displacement elements being adjacent to each other slide against each other along the displacement direction defined for each of the displacement elements.

3. The holding jig according to claim 1, wherein
the plurality of displacement elements form the through hole.

4. The holding jig according to claim 1, wherein
the plurality of displacement elements are arranged in an annular shape.

5. The holding jig according to claim 1, wherein
the holder includes a regulating structure that regulates the displacement direction of each of at least some of the displacement elements,
the regulating structure includes a guide that is provided corresponding to each of the displacement elements for guiding the displacement element in a predetermined direction, and
the displacement direction of the displacement element is a direction along the guide corresponding to the displacement element.

6. The holding jig according to claim 5, wherein
when one of the displacement elements adjacent to each other moves along the guide corresponding to the one of the displacement elements, a pressing force is applied to the other of the displacement elements, and the other of the displacement elements moves along the guide corresponding to the other of the displacement elements based on the pressing force.

7. The holding jig according to claim 1, wherein
the holder includes a regulating wall portion that regulates a displacement distance of at least one of the displacement elements, and
the regulating wall portion contacts the displacement element when the displacement element is displaced to a predetermined position.

8. The holding jig according to claim 7, wherein
the holder has a first groove portion in the regulating wall portion,
a second groove portion is formed at a position corresponding to the first groove portion in the displacement element in contact with the regulating wall portion, and
the holing jig is provided with a regulating rod that is common to the first groove portion and the second groove portion and is embedded in the first groove portion and the second groove portion.

9. The holding jig according to claim 1, wherein
the displacement elements adjacent to each other are in contact with each other on side surfaces of the displacement elements.

10. The holding jig according to claim 1, wherein
the displacement elements adjacent to each other are prevented from overlapping each other in the vertical direction.

11. The holding jig according to claim 1, wherein
positions of upper surfaces of the displacement elements adjacent to each other are aligned at the upper end edge portion of the through hole.

12. The holding jig according to claim 1, further comprising a base plate, wherein
the displacement elements are disposed on a plate upper surface of the base plate, and
the displacement elements move and rub on the plate upper surface of the base plate.

13. The holding jig according to claim 1, wherein
an extension extending along the circumferential surface portion of the through hole is formed on a lower surface of the displacement element.

14. The holding jig according to claim 1, wherein
at least a portion of the displacement element corresponding to the exposed region forms an inclined surface that is inclined downward toward an inside of the through hole as going downward from the upper end edge portion of the through hole.

15. The holding jig according to claim 1, further comprising a protective plate, wherein
the protective plate covers at least a part of the displacement element.

16. The holding jig according to claim 15, wherein
a fixing member for fixing a position of the protective plate is removably attached to the protective plate, and
wherein the protective plate is configured to be displaceable in a planar direction normal to a thickness direction of the protective plate when the fixing member removed.

17. The holding jig according to claim 1, wherein
the holding target includes a first holding target to be in contact with the through hole and a second holding target to be mounted on the first holding target, and
wherein a plane direction of a plane normal to the vertical direction is a planar direction, a positioning structure that defines at least a position of the second holding target in the planar direction relative to the first holding target is provided on an upper surface side of the holder.

18. The holding jig according to claim 17, wherein
the positioning structure includes a plurality of pins erected on the upper surface side of the holder, and the plurality of pins define the position of the second holding target in the planar direction, and
each of the pins is configured to be displaceable in the vertical direction.

19. The holding jig according to claim 1, wherein
the holding target includes at least a container having a body and a flange extending outward from an upper end of the body, and the flange is configured to contact the upper end edge portion of the through hole.

20. The holding jig according to claim 1, wherein
the holder includes an elastic member that biases at least one of the displacement elements, and
in a state where the displacement element has moved to make the exposed region larger, the elastic member applies stress to the displacement element for positioning the displacement element at a position at which the exposed region is smaller.

21. The holding jig according to claim 1, further comprising an outer peripheral portion, wherein
a covering material with cushioning properties is provided to surround the outer peripheral portion.

22. The holding jig according to claim 1, wherein
a displacement guide structure that regulates the displacement direction of the displacement element is provided on a lower surface side of the displacement element.

23. The holding jig according to claim 1, wherein
a groove is formed on an upper surface of the displacement element.

24. The holding jig according to claim 23, wherein
the groove on the upper surface of the displacement element extends along the displacement direction of the displacement element.

25. The holding jig according to claim 1, wherein
a groove is formed in at least one of side surfaces of the displacement element excluding a surface that forms the through hole.

26. The holding jig according to claim 1, wherein
a step is formed on an upper surface of the displacement element.

27. A sealing device comprising:
the holding jig according to claim 1; and a presser for applying a pressing force to the holding target from an upper side of the holding target, wherein
in a case where the pressing force is applied to the holding target while the holding target is placed on the holding jig, at least one of the presser and the holding jig moves from an initial position where the presser and the holding jig are separated by a predetermined distance to a position where the holding target is pressed, the presser exists above the holding target, and the pressing force is applied to the holding target from an upper side of the holding target.

28. The sealing device according to claim 27, wherein
the holding jig moves toward the presser.

29. The sealing device according to claim 27, wherein
the presser moves toward the holding jig.

30. The sealing device according to claim 27, wherein
the presser has a pressing surface, and
the pressing surface is an uneven surface.

31. The sealing device according to claim 27, further comprising
a heating mechanism capable of heating the presser.

32. The sealing device according to claim 27, wherein
a fluoroplastic sheet is provided between the presser and the holding jig.

33. The sealing device according to claim 27, wherein
the holding target includes at least a container having a body with an opening formed on an upper side and a flange extending outward at an upper end of the body.

34. The sealing device according to claim 33, which joins a lid to the container at a position of the flange of the container in a state where the lid is disposed on the container to cover the opening on the upper side of the body and the flange and the container and the lid are interposed between the presser and the holding jig.

35. A sealing method using the scaling device according to claim 33, the sealing method comprising
joining a lid to the container at a position of the flange of the container in a state where the container and the lid are interposed between the presser and the holding jig.
